(19) United States
(12) Patent Application Publication
(10) Pub. No.: US 2021/0156759 A1
(43) Pub. Date: May 27, 2021

(54) STRUCTURAL HEALTH MONITORING SYSTEM AND METHOD

(71) Applicant: THE TRUSTEES OF THE STEVENS INSTITUTE OF TECHNOLOGY, HOBOKEN, NJ (US)

(72) Inventors: Dimitri Donskoy, Fair Haven, NJ (US); Majid Ramezani Goldyani, West Windsor, NJ (US); Dong Liu, Hoboken, NJ (US)

(21) Appl. No.: 17/105,414

(22) Filed: Nov. 25, 2020

Related U.S. Application Data
(60) Provisional application No. 62/941,501, filed on Nov. 27, 2019.
(60) Provisional application No. 63/116,701, filed on Nov. 20, 2020.

(51) Int. Cl. G01M 5/00; B23K 31/12

(52) U.S. Cl. CPC G01M 5/0033; B23K 31/125; G01M 5/0066

(57) ABSTRACT

The present invention relates to nonlinear Vibro-Acoustic Modulation (VAM), one of the prevailing nonlinear methods for material characterization and structural damage evaluation. An algorithm of AM/FM separation is presented specifically for VAM method. While the commonly used Hilbert transform (HT) separation may not work for a typical VAM scenario, the developed IQHS and SPHS algorithms address HT shortcomings. They have been tested both numerically and experimentally (for fatigue cracks evolution) showing FM dominance at the initial micro-crack growth stages and transition to AM during macro-crack formation. In addition, the SPHS algorithm is capable of detecting fatigue crack via monitoring of modulation phase.

### CROSS-REFERENCE TO RELATED APPLICATIONS

This application claims priority to U.S. Provisional Patent Application Ser. No. 62/941,501, filed Nov. 27, 2019, and U.S. Provisional Patent Application Ser. No. 63/116,701, filed Nov. 20, 2020, the entire disclosures of both of which applications are incorporated herein by reference.

### FIELD OF THE INVENTION

This invention relates to systems and processes for measuring and monitoring the structural health status of a building or other structure.

### BACKGROUND OF THE INVENTION

Metal bonding challenges have a significant impact on achieving production goals and maintaining efficiency. The methods of assembly of parts into a mechanical structure presents a range of options for engineers to consider, all of which have tradeoffs between manufacturing and maintenance. Mechanical joining and welding are two widely used approaches in civil structures. The most common structural joining technique is mechanical joining in which parts are put together with rivets, bolts and screws. Welding is also a very flexible joining method that is common across many industries where parts are joined by fusion.

Mechanical joining and welding are two widely used approaches in structures. Parts are put together with bolts, clamps, etc. in mechanical joining and are joined by fusion in welding. The joint parts are always problematic due to changes in the material properties which lead to destroying integrity of structure in the joint zone. These undesirable abrupt changes cause problems in usage and maintenance of manufactured parts. Notably, bolted and screwed connections could perform as sources of nonlinearities which may contribute to reducing the sensitivity of acoustic structural health monitoring methods to detect and characterize defect growth.

Parts with joints are always problematic due to changes in the material properties which lead to the reduction of integrity of structure in the joint zone. These undesirable abrupt changes can cause problems in usage and maintenance of manufactured parts. For example, changing material properties in the weld zone of layered nanocomposites destroys the functionality of structure and enhanced material properties. For example, the biggest limitation of welding is the heat-affected zone (HAZ). The effect of welding can be detrimental to the surrounding material. Depending on the material and the heat input by the welding process, the heat-affected zone can be of varying size and significance. Further, bolted and screwed connections can act as sources of nonlinearities which may contribute to reducing the sensitivity of acoustic structural health monitoring methods to detect and characterize defect growth.

Metal bonding challenges have a significant impact on achieving production goals and maintaining efficiency. The methods of assembly of parts into a mechanical structure presents a range of options for engineers to consider, all of which have tradeoffs between manufacturing and maintenance. Mechanical joining and welding are two widely used approaches in civil structures. The most common structural joining technique is mechanical joining in which parts are put together with rivets, bolts and screws. Welding is also a very flexible joining method that is common across many industries. The biggest limitation of welding is the heat-affected zone (HAZ). The effect of welding can be detrimental to the surrounding material. Depending on the material and the heat input by the welding process, the heat-affected zone can be of varying size and significance. The joint parts are always problematic due to changes in the material properties which lead to destroying integrity of structure in the joint zone. These changes are not desirable in usage and maintenance of manufactured parts. Moreover, contact-type connections (e.g., rivets, bolts and screws) could perform as sources of nonlinearities which may contribute to reducing the sensitivity of ultrasonic non-destructive evaluation (NDE) techniques to detect cracks and flaws.

Fatigue failure is one of the most common failure modes of structural components. Fatigue crack, which arises from cycling loads that are well below the yield stress, causes up to 90% failures of in-service metallic structures. Therefore, integrity of a structure depends on the detection of fatigue crack in early stages, and inability to detect fatigue cracks in appropriate time results in a brittle-like failure which can be sudden with delayed or no damage warning. The fatigue life of a component can be stated as the number of stress cycles that can be applied to a structure prior to failure. Fatigue failure occurs in three stages—crack initiation; incremental crack propagation; and rapid fracture. Thus, continuous monitoring of fatigue crack growth and predication of remaining life-cycle are vital to prevent rapid rupture of the structural component.

To prevent a possible brittle, unexpected failure of a structure, inspections of their components play a key role in identifying and assessing their condition. Being aware of the presence of micro-cracks would allow the timely maintenance of the structure and provide input data for estimation of its remaining life. To that end, many non-destructive evaluation (NDE) methods have been implemented in the past to allow the inspections to be as accurate and efficient as possible. Unfortunately, few NDE techniques can practically monitor the damage accumulation at the micro-scale.

The main reason for the failure of metallic structures is a crack propagation. Up to 90 percent of failures of in-service metallic structures happen due to fatigue cracks. A fatigue crack is initiated from a damage precursor at an imperceivable level (e.g., dislocation or micro crack in materials) when the material is subjected to repeated loading. The precursor can often continue to grow to a critical point at an alarming rate without sufficient warning, leading to catastrophic consequences.

Continuous monitoring of structures and large sensing level of ultrasonic techniques, among other nondestructive testing (NDT) and structural health monitoring (SHM) techniques, facilitate the online monitoring of fatigue cracks. Traditional active acoustic/ultrasonic methods are not sensitive enough to fatigue cracks until they become completely visible since these techniques use the linear properties of scattering, transmission, reflection and attenuation of the elastic waves to detect damages. These methods have inherent limitations. One of the major limitations includes relation between damage size to the wavelength of transmitted waves. Traditional ultrasonic techniques are not capable of detecting initial damages of a size smaller than wavelength of the transmitted wave. Another disadvantage is distinguishing between the actual damage and structural features of comparable or greater size, such as notches, holes, borders, and other structural features. Reflections of these structural features mask the signal relating to the damage. One possible approach to tackle these limitations is to explore the nonlinear nature of the material damage by utilizing nonlinear acoustic methods for damage detection.

Several non-destructive testing (NDT) methods have been used to detect crack formation such as acoustic emission (AE), Eddy Current (EC) and ultrasonic (UT) techniques. Acoustic emission technique monitors elastic stress waves generated by crack initiation and propagation in the material. This technique has been used for detecting and localizing fatigue cracks. The main drawback of this technique is that the recorded signals may be contaminated with high level of environmental noise which makes it impossible to distinguish between structural and ambient noise waves. Eddy current technique is also used to detect fatigue cracks specifically for surface or near-surface cracks. Eddy Current should be used on conductive materials and is not suitable for large area monitoring since it works on nearby conductive surfaces and needs to scan all the surface which takes a long time. Linear ultrasonic techniques utilize the linear effects of reflection and attenuation of the elastic waves by structural inhomogeneities to detect a fatigue crack. While the linear ultrasonic techniques are effective in the detection of macro cracks, they cannot be used to identify micro-cracks because micro-cracks are significantly smaller in size than the wavelength used by such methods. In contrast, the non-linear response of inspected materials is quite sensitive to micro-cracks and can be used to identify small imperfections. The nonlinear ultrasonic techniques are based on various material and structural nonlinear behavior, e.g. generation of harmonics of ultrasonic wave and modulation of high-frequency (HF) ultrasound by low-frequency (LF) vibration. These effects are mainly caused by the local vibration of micro-cracks, which produces clapping motion and frictional contact between damage surfaces.

Among the nonlinear acoustic NDE methods, a cost-effective and practical method to measure material nonlinearities is the Vibro-Modulation Technique (VMT) which does not need the expensive hardware components required for the conventional non-linear methods. Specifically, the Vibro-Acoustic Modulation (VAM) method is used to overcome the deficiencies of other non-linear methods. VAM method demonstrated high sensitivity to various flaws such as fatigue and stress-corrosion cracks, disbonds, etc. This technique makes use of the dependence of level of nonlinearity to the density or severity of the defect and effectively distinguishes intact and damaged samples. This approach detects material defects by monitoring the modulation components generated by the interaction between probing (high-frequency ultrasound, w) and pumping (low-frequency vibration, Ω) signal in the presence of crack which reveals itself in the nonlinear behavior of material. Nonlinear behavior of material is present as the modulation components in sidebands of probing frequency (carrier frequency) as opposed to linear system response of intact system without indication of any sidebands.

The Vibro-Acoustic Modulation (VAM) method was proposed twenty years ago, as a better alternative to the nonlinear harmonic testing to detect structural defects by nonlinear acoustic effects in solids. The Vibro-Acoustic Modulation (VAM) method has been shown to be sensitive to various defects. It utilizes nonlinear interaction (modulation) of a high frequency ultrasonic wave (carrier signal) having frequency ω and a low frequency sound wave (modulating vibration) with frequency.

Most research on VAM has been carried out in Fourier analysis of the investigated structure. Using this approach, researchers have been able to define Modulation Index, MI, as the relative amplitude of sideband spectral components at frequencies w±Ω to the amplitude of carrier frequency ω. MI increases in presence of structural nonlinearity such as crack compared to linear behavior of flawless structure. The modulation is taking place in the presence of various flaws such as fatigue and stress-corrosion cracks, disbonds, etc. Such interpretations are unsatisfactory because they do not consider phase of sidebands; therefore, new methods capable of analyzing non-linear signals considering the phase effect of sidebands have to be employed. To achieve this goal, modulation type separation could be done to explore the nature of modulated signal and distinguish between amplitude and frequency modulated, AM and FM, signals. The most common cause of the nonlinear behavior in flaws is the contact-type interfaces within these defects. There have been numerous follow up studies of the method applied to a variety of structural and material defects. All of these studies have demonstrated high sensitivity of VAM as well as its other advantageous features. For example, a recent review cited over 70 VAM research papers originated in USA, Russia, Germany, China, France, Italy, UK, Poland, Netherlands, Singapore, and Australia. Another dozen new VAM related research papers have been published since then.

Nonlinear vibro-acoustic modulation (VAM) is one of the prevailing nonlinear methods for material characterization and structural damage evaluation. The physical principle is described in U.S. Pat. No. 6,301,967 “Method and Apparatus for Acoustic Detection and Location of Defects in Structures or Ice on Structures”. The VAM method utilizes nonlinear interaction (modulation) of a high frequency ultrasonic wave (carrier signal) having frequency ω and a low frequency sound wave (modulating vibration). Most research on VAM has been carried out using Fourier spectrum analysis of resulting modulated signal, yielding a so-called modulation index, “MI”, defined as a ratio of the amplitudes of the sideband spectral components at the frequencies w±Ω to the amplitude of the carrier signal having frequency ω. The MI increases in presence of damage (such as fatigue or stress-corrosion cracks, disbonds, etc.) due to damage-related local nonlinearity of the material or structure. The most common cause of the damage nonlinear behavior is the contact-type interface within the damage. There have been numerous studies of VAM applied to a variety of structural and material defects. All of these studies have demonstrated high sensitivity of VAM as well as its other advantageous features. For example, a recent review (see L. Pieczonka, A. Klepka, A. Martowicz, and W. J. Staszewski, “Nonlinear vibroacoustic wave modulations for structural damage detection: an overview,” Optical Engineering, vol. 55, no. 1, 2015, Art no. 011005) cited many VAM research papers originated in various countries including the USA, Russia, Germany, China, and many others.

However, most of the aforementioned research endeavors are still primarily laboratory experimentation with a few examples of real-world implementation. The major reason is that real structures have many contact-type structural nonlinearities that may produce a much higher level of modulation as compared to the damage-related nonlinearities. Some examples of real structures with varieties of contact nonlinearities are rivets, bolts, screws, lap joints, welds, various moving parts, paint peelings, etc. The approach does not differentiate between various types of modulations including amplitude modulation (“AM”) or frequency modulation (“FM”) contributing to the modulation index. Thus, new algorithms of AM/FM separation specifically for VAM methods are needed.

### SUMMARY

Some embodiments of the present invention include a system comprising at least one processor configured to be coupled to a non-transitory computer-readable storage medium storing thereon a program logic for execution by the at least one processor. The program logic includes a logic module executable by the at least one processor for receiving at least one data stream from a structure, and performing at least one calculation using modulated phase homodyne demodulation to calculate a measure of structural health of the structure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. For a more complete understanding of the present invention, reference is made to the following detailed description of various exemplary embodiments of the invention considered in conjunction with the accompanying drawings, in which:

FIG. 1 illustrates a flow chart of MPHD signals' generation, acquisition, and processing in accordance with some embodiments of the invention;

FIG. 2 illustrates a schematic of a power spectrum of an acquired modulated signal in accordance with some embodiments of the invention;

FIG. 3 illustrates modulation index (MI) and modulation phase (MP) during fatigue lifetime of a steel bar, and an image of a stress-fatigued steel bar with attached bolt/lap joint connection in accordance with some embodiments of the invention;

FIG. 4 illustrates a non-limiting block diagram of a system capable of implementing any one or more of the methods or processes disclosed herein in accordance with some embodiments of the invention;

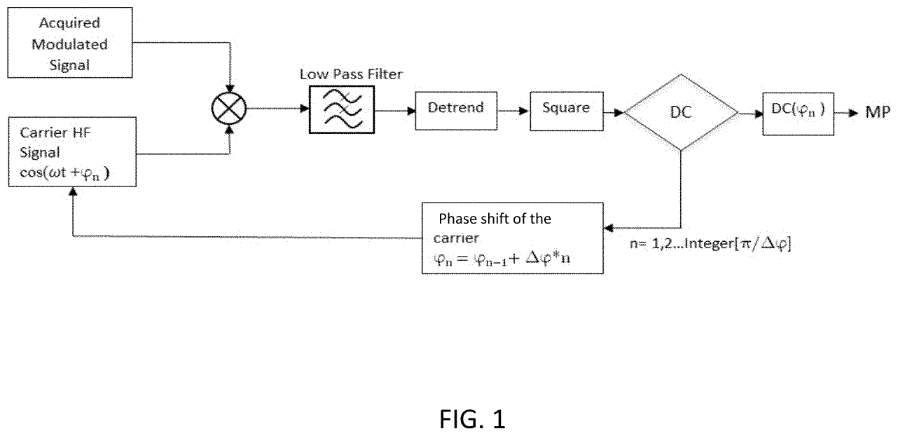

FIG. 1.3 depicts examples of structural contact nonlinearities, such as rivets, bolts, screws, lap joints, welds, various moving parts, detached paint and cracks, in (a) bridges, (b) airframe, and (c) ships;

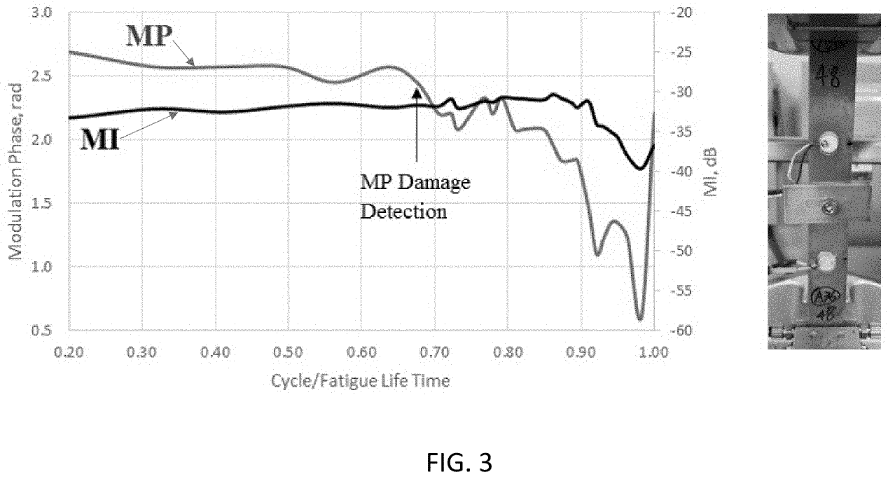

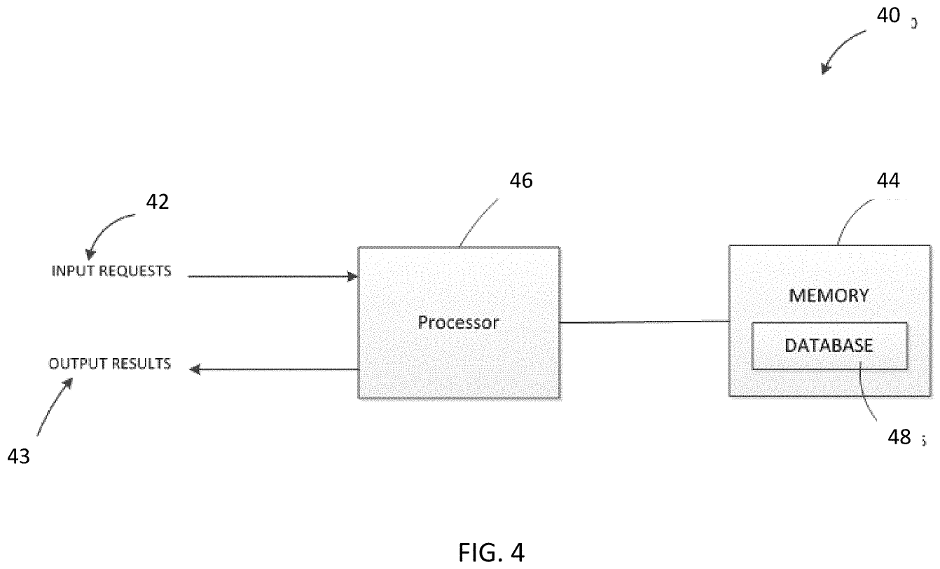

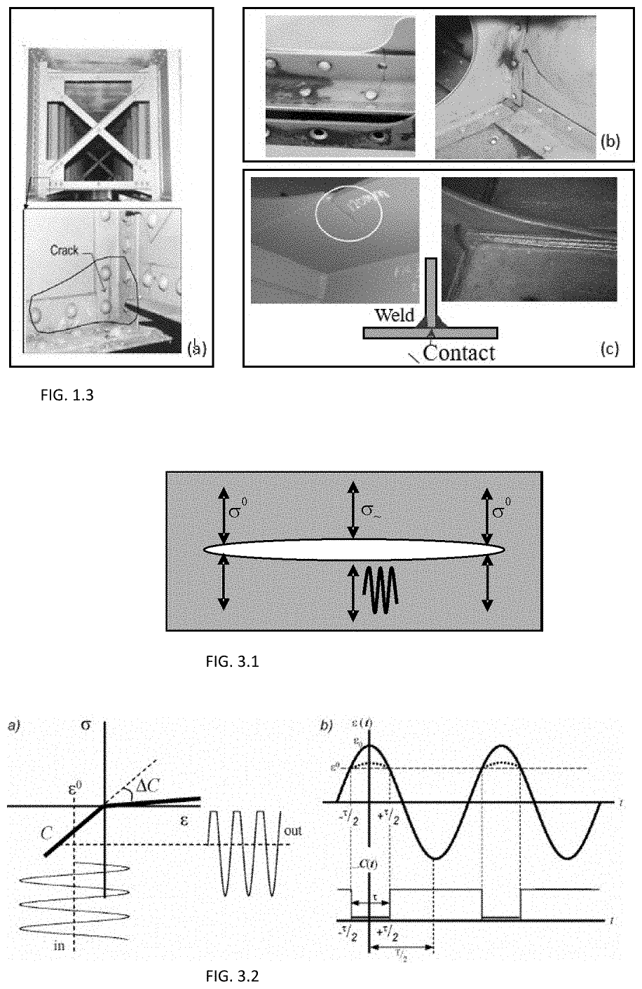

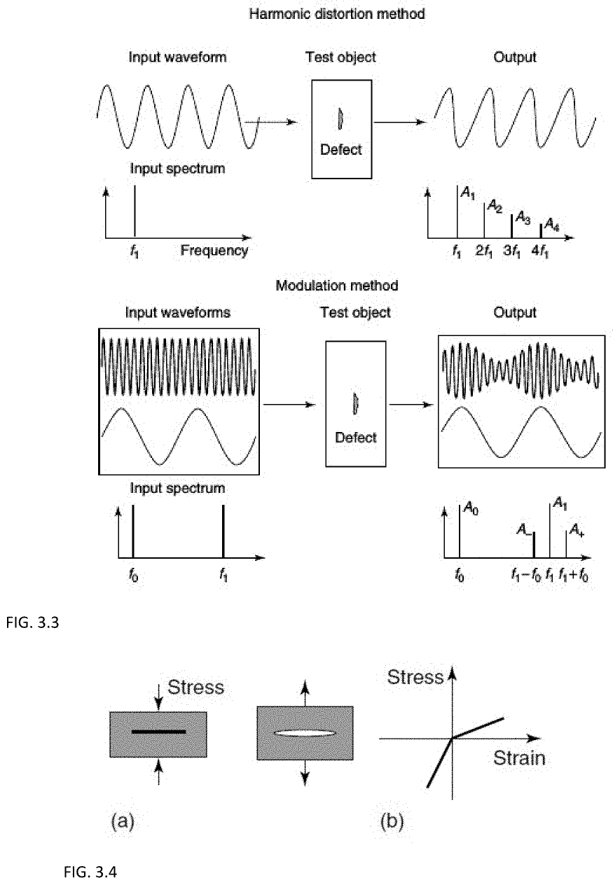

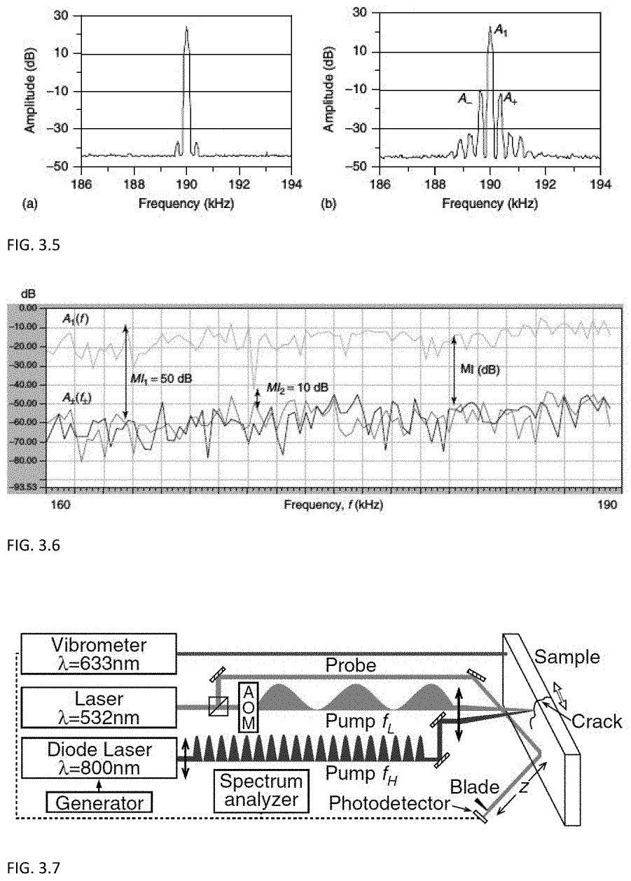

FIG. 3.1 shows a model of a clapping crack;

FIG. 3.2 shows (a) Mechanical diode model; (b) stiffness modulation and waveform distortion;

FIG. 3.3 shows illustrative diagrams of the harmonic distortion and modulation methods;

FIG. 3.4 shows (a) Clapping defect and (b) stress-strain bilinear dependence;

FIG. 3.5 shows spectra of a high-frequency ultrasonic signal modulated by a low frequency vibration: (a) undamaged section of the steel pipe and (b) the same pipe section with stress-corrosion cracks;

FIG. 3.6 shows s Frequency response (A1(f) upper curve, in decibels) of 0.5-m-long steel beam for the high-frequency ultrasonic signal f1 swept the 160-190 kHz frequency range. The lower two curves are the corresponding frequency responses of the sidebands A±(f±) (also in decibel scale) at the frequencies f±=11±250 Hz recorded as f1 is swept. MI is the modulation index (in decibels). It is graphically defined as a difference between the linearly averaged value of two lower curves and the upper curve. As can be seen, MI could vary as much 40 dB (MI1-MI2) because of resonances and antiresonances of the frequency response;

FIG. 3.7 shows an experimental test setup for all-optical monitoring of the nonlinear acoustic of a crack;

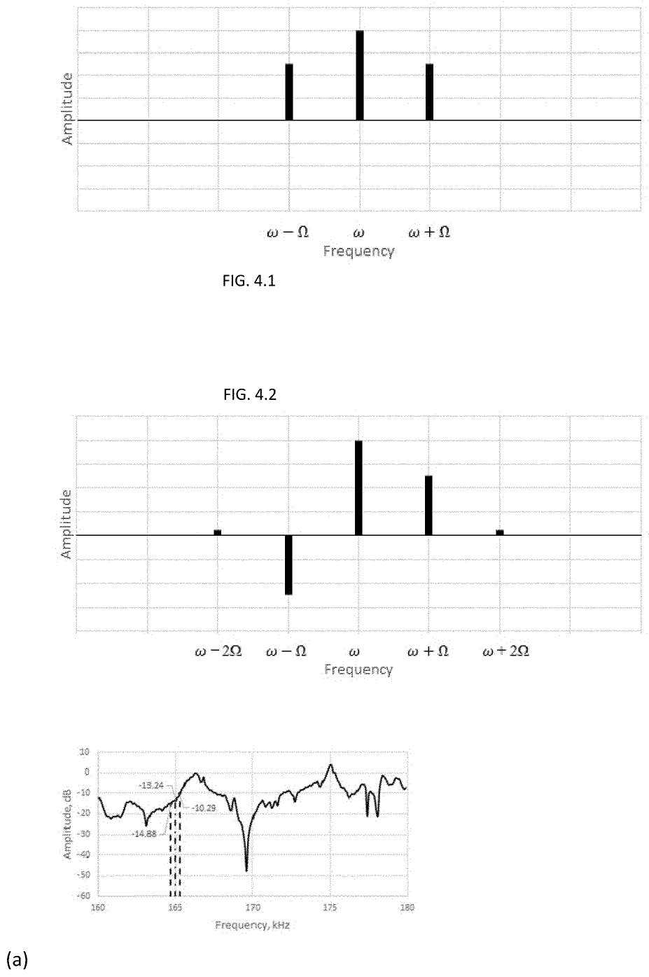

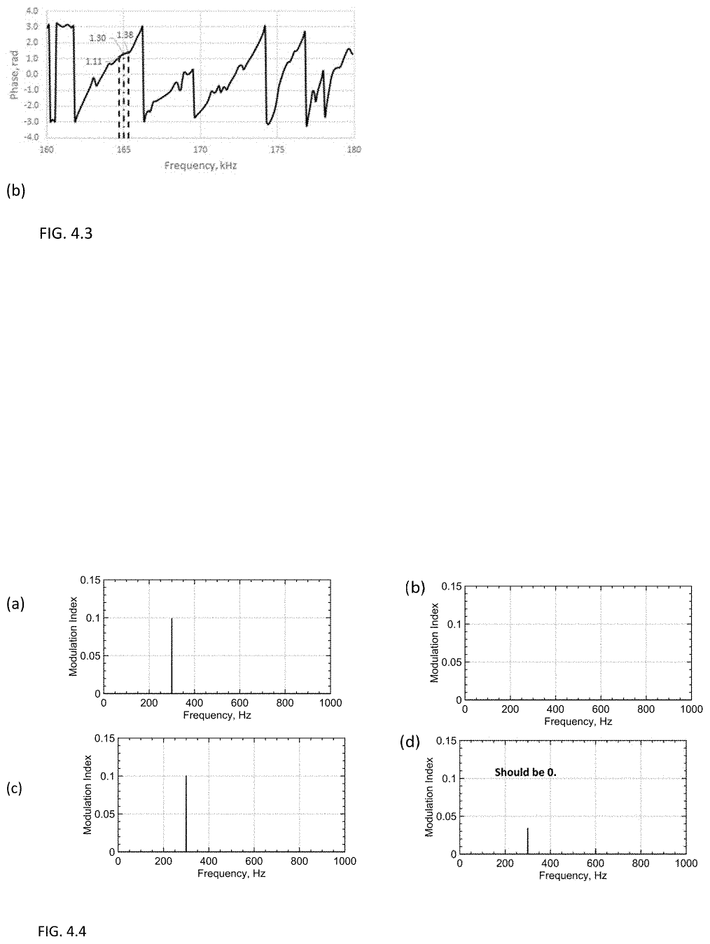

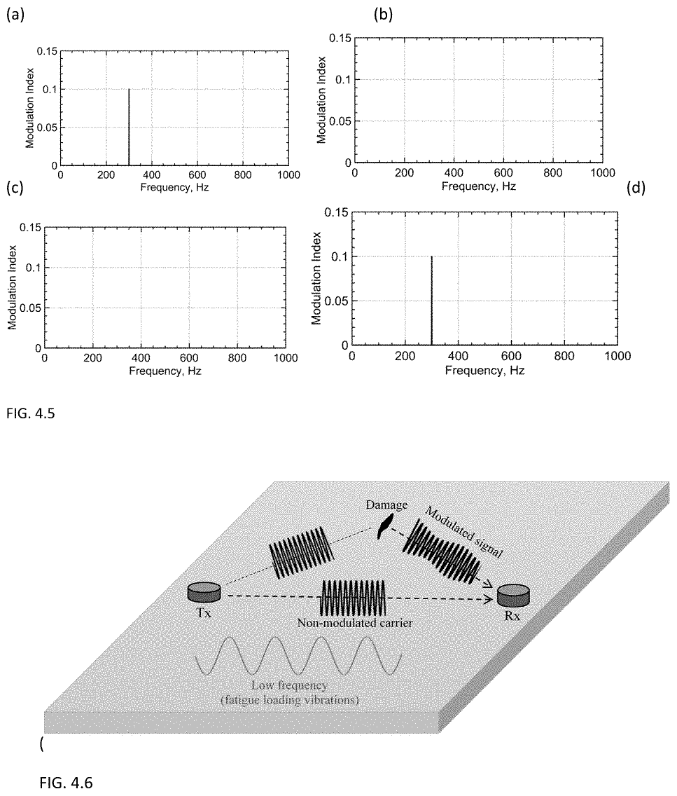

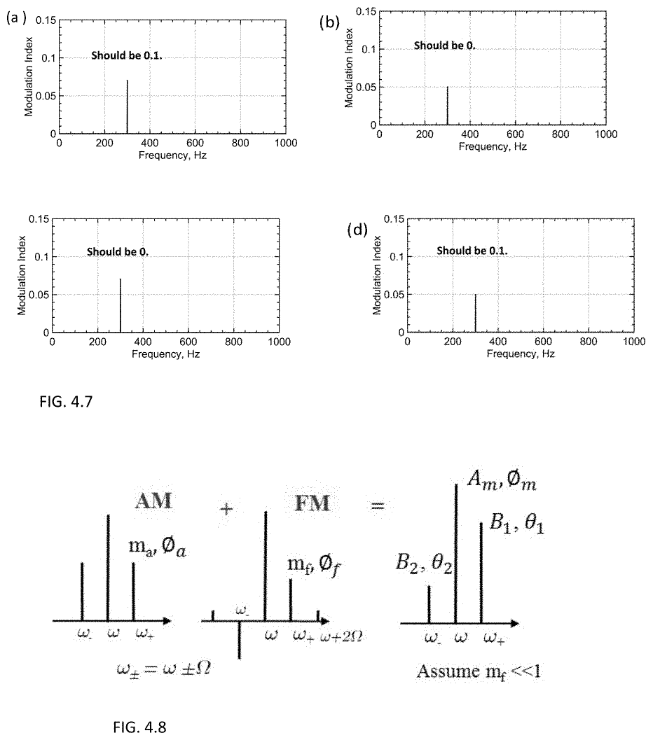

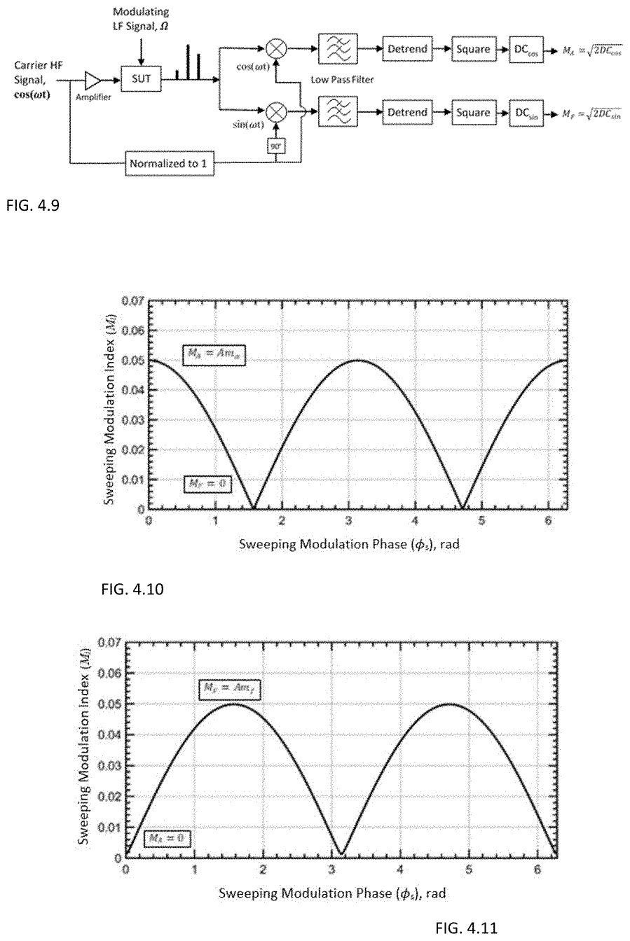

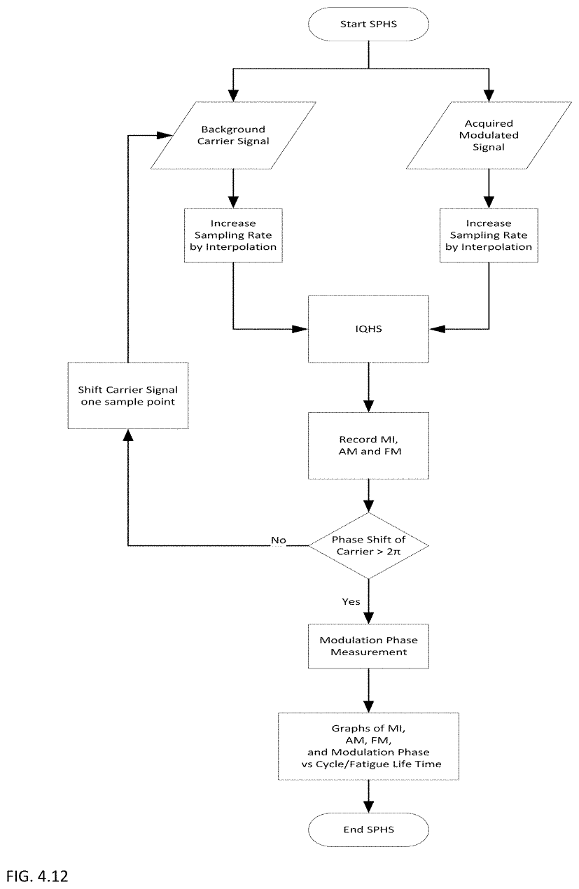

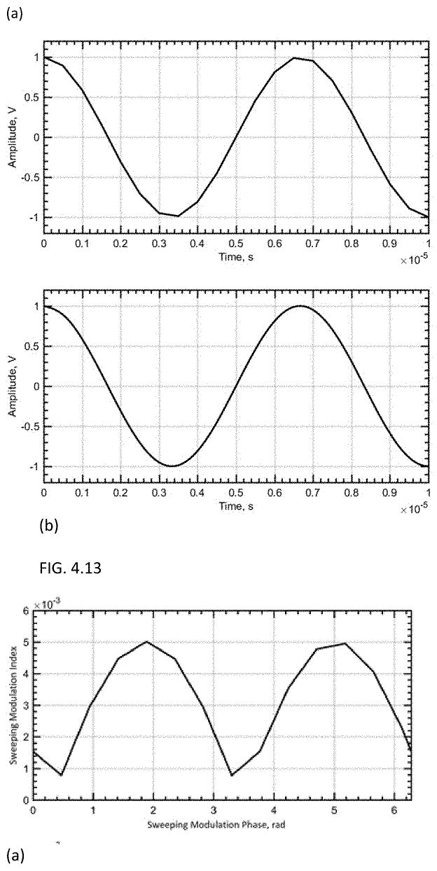

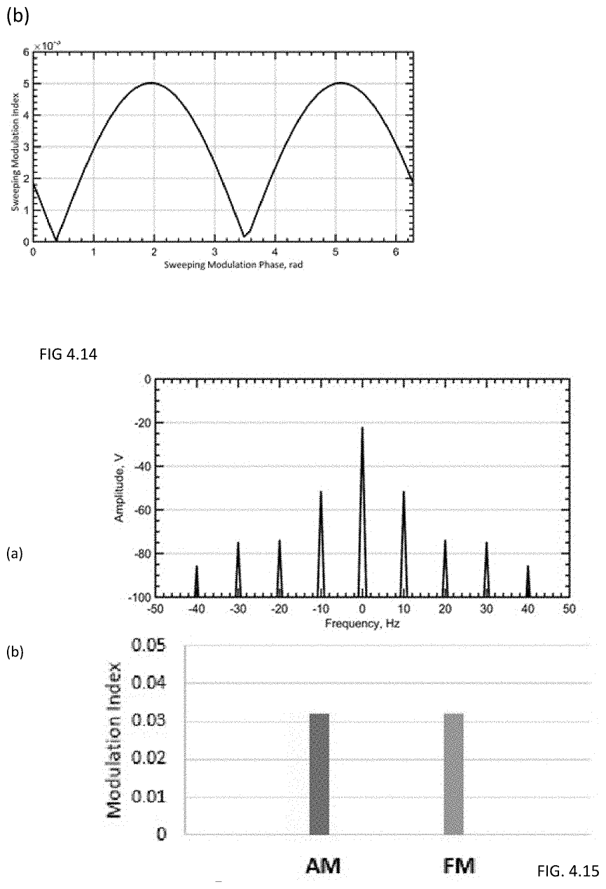

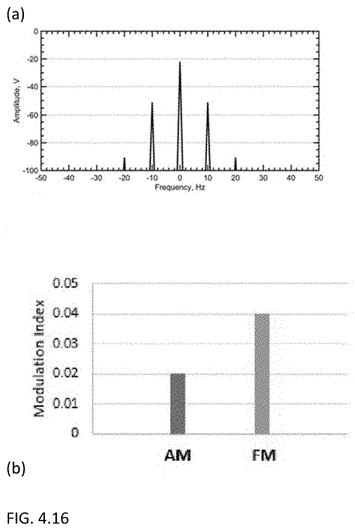

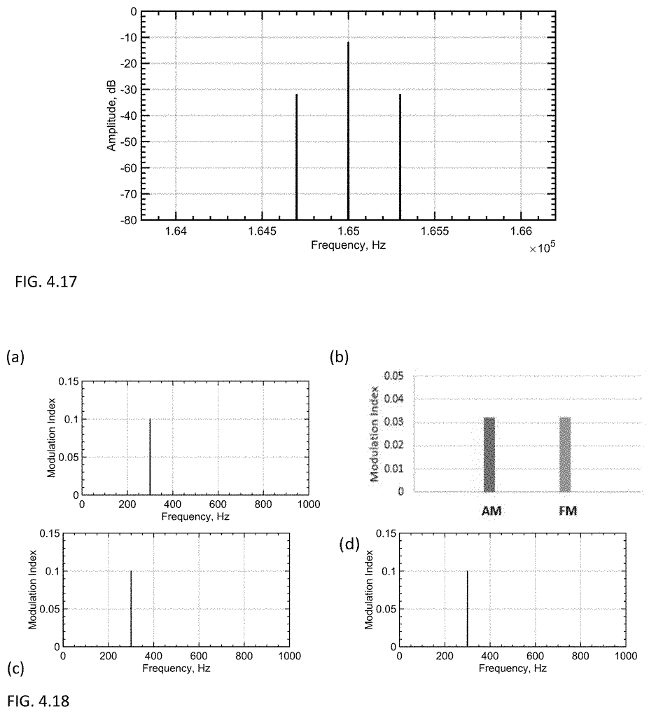

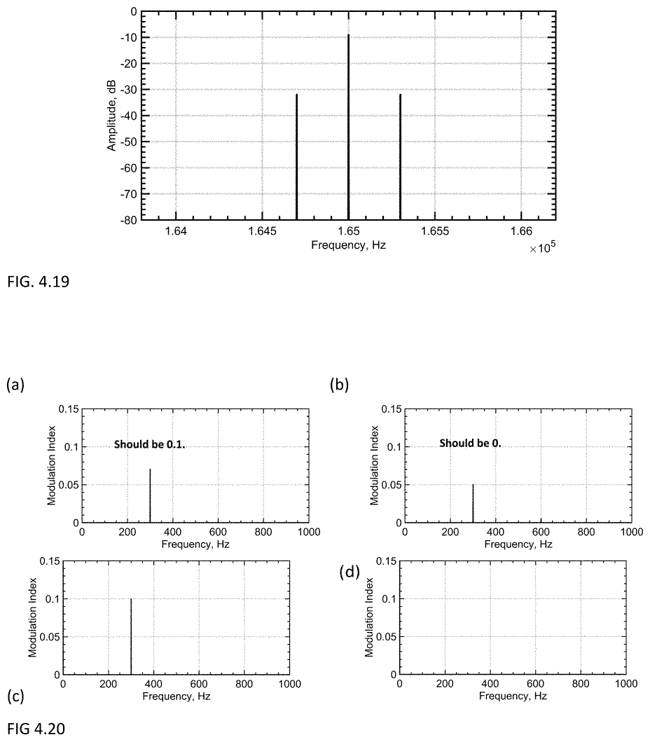

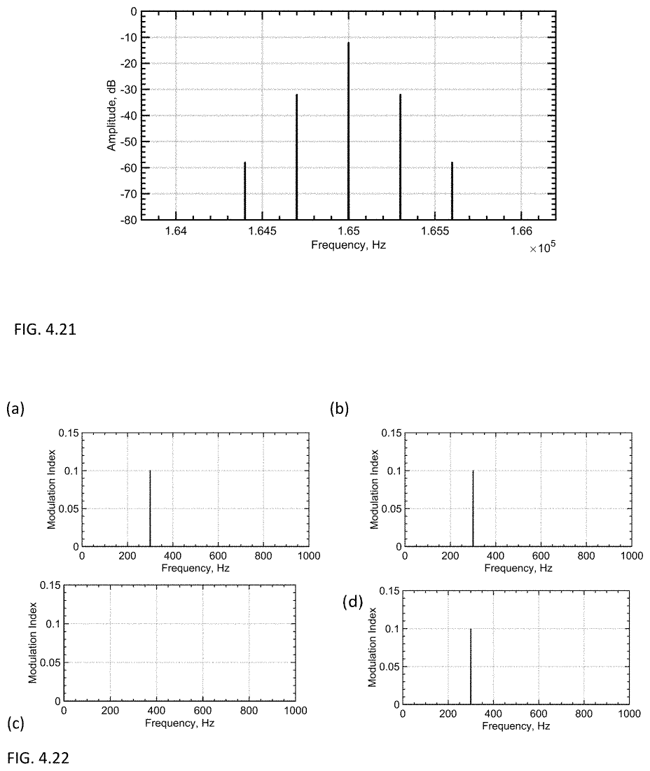

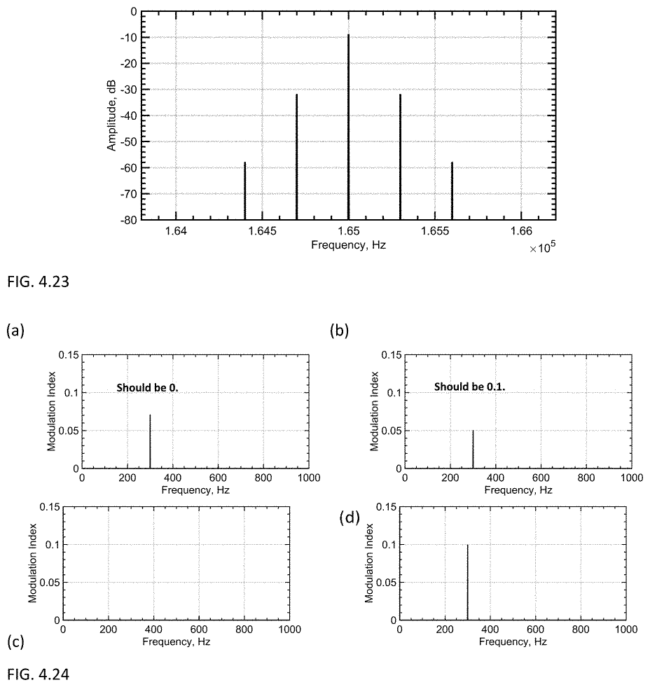

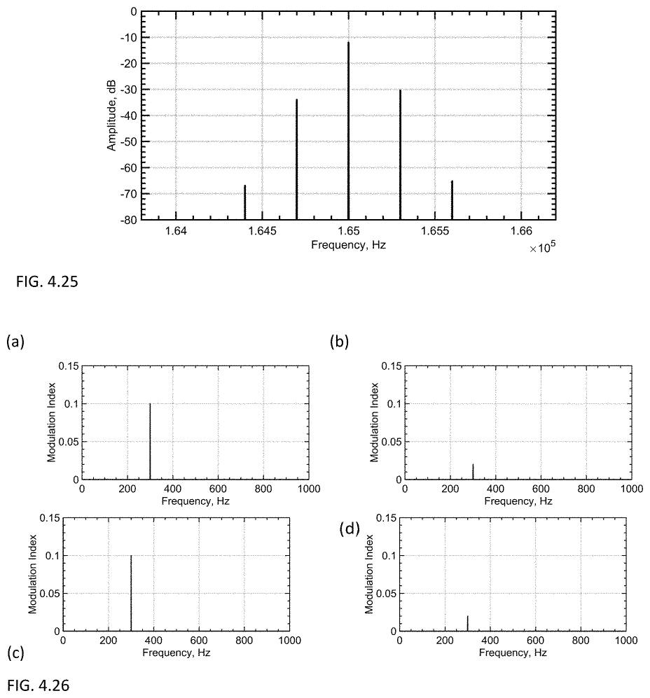

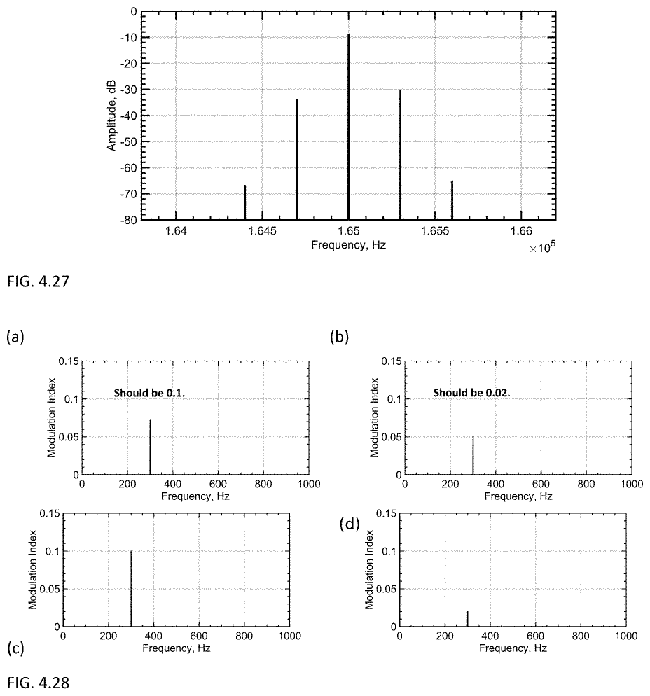

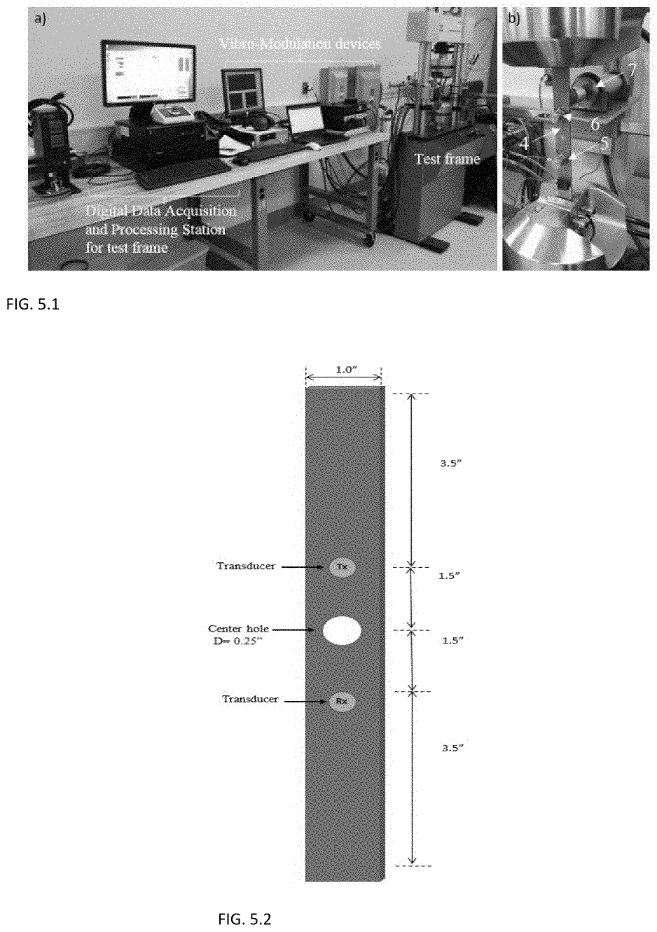

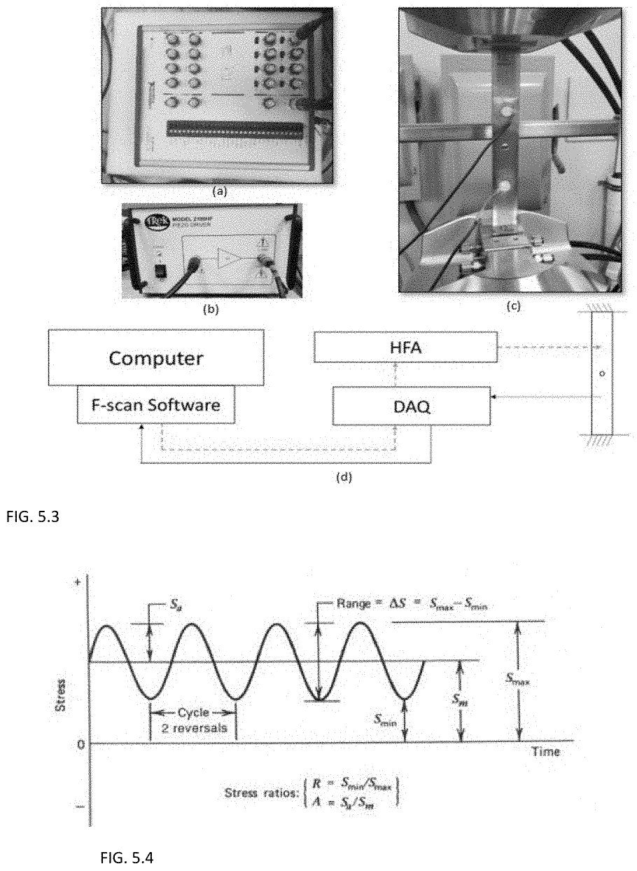

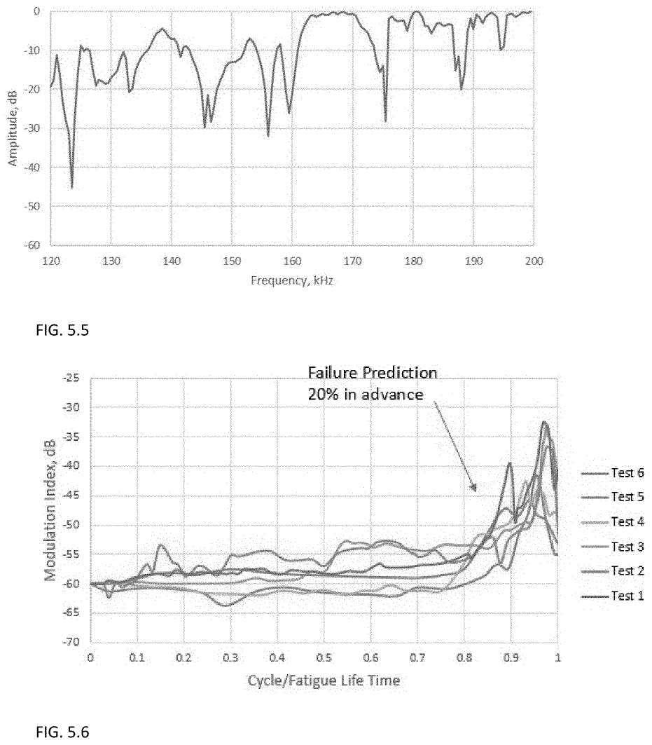

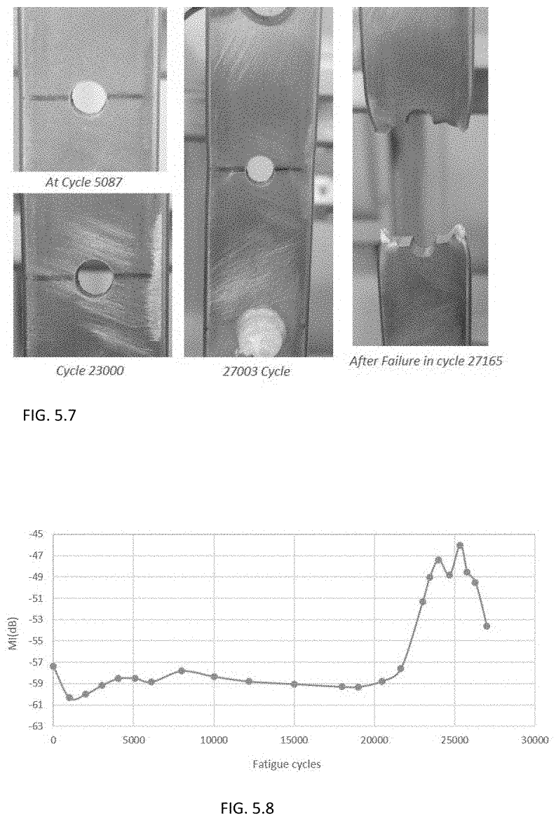

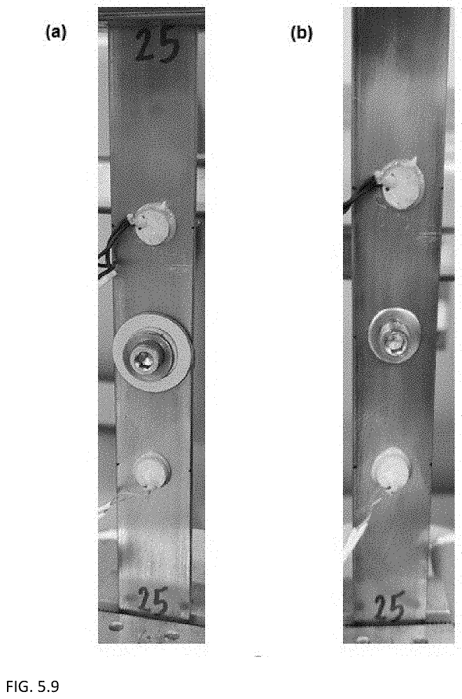

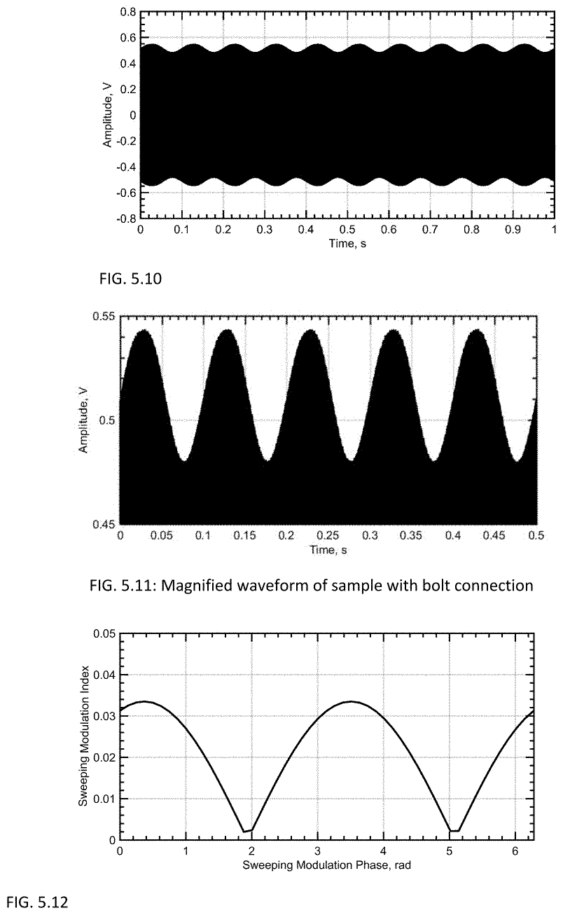

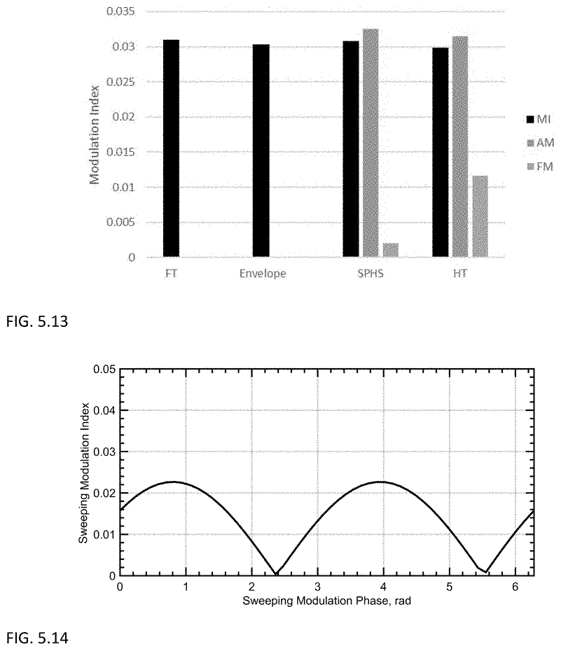

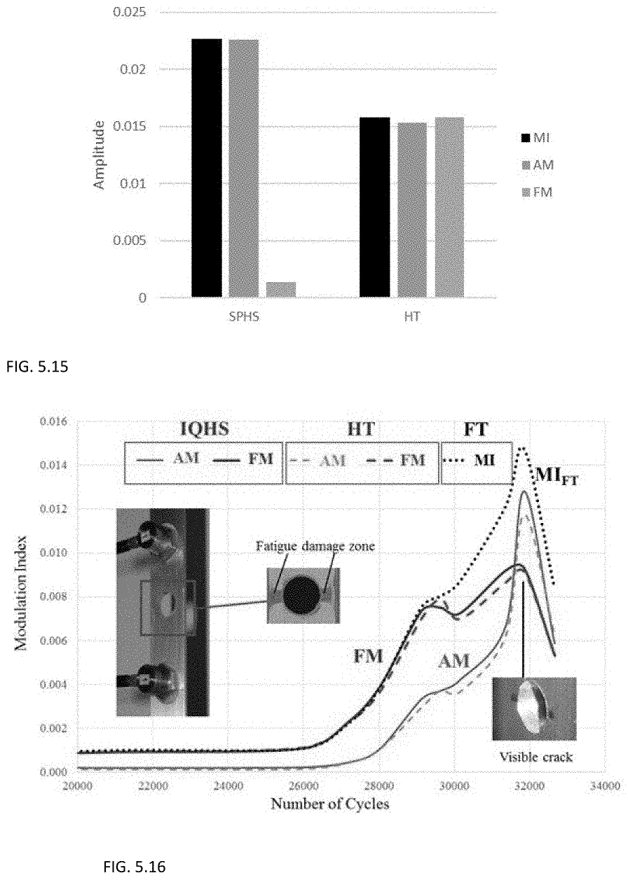

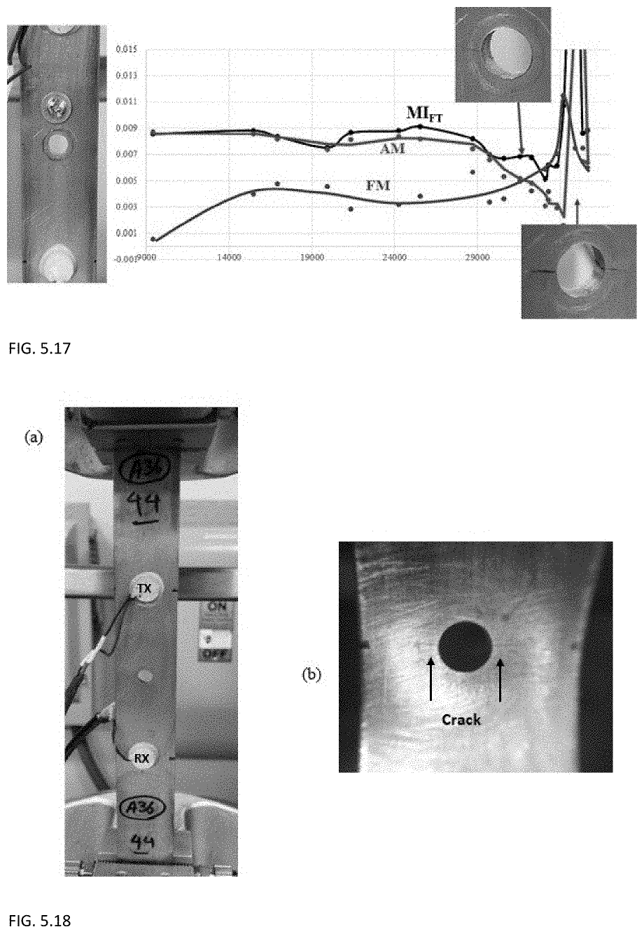

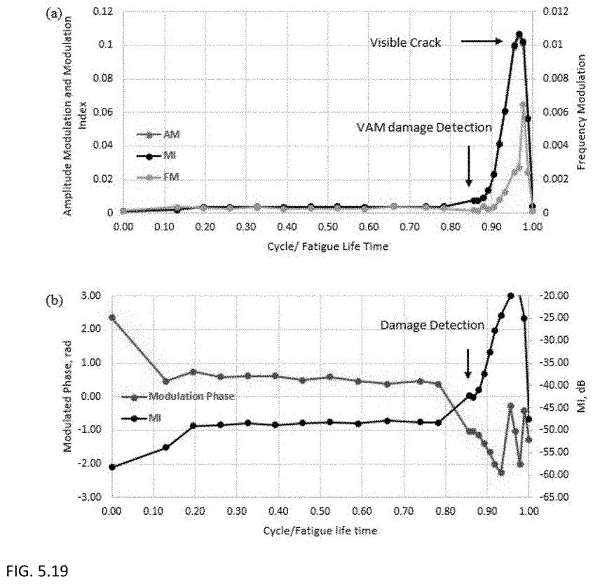

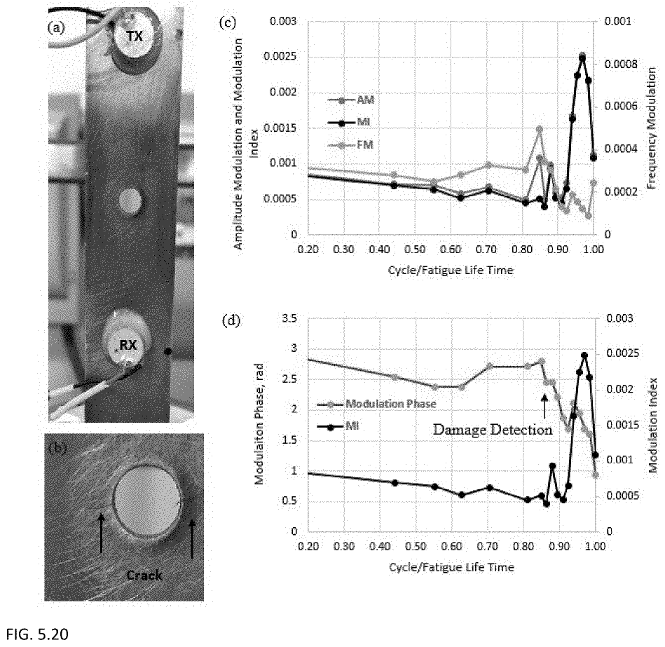

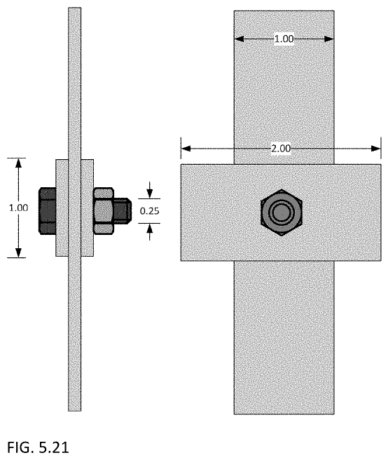

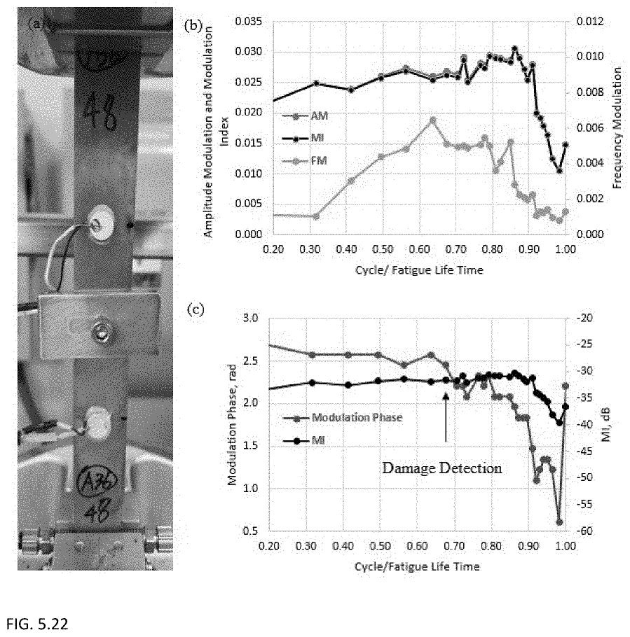

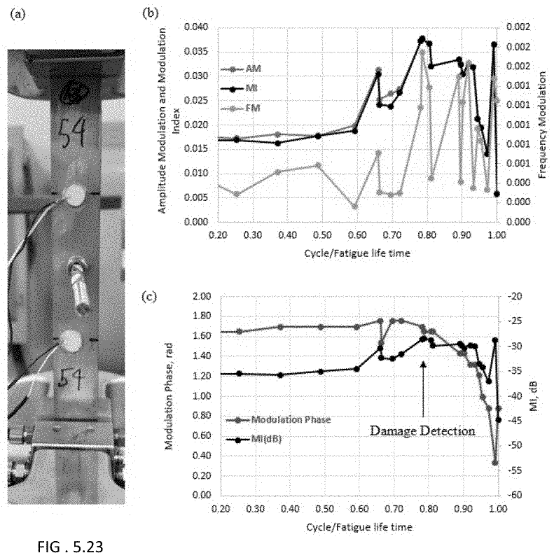

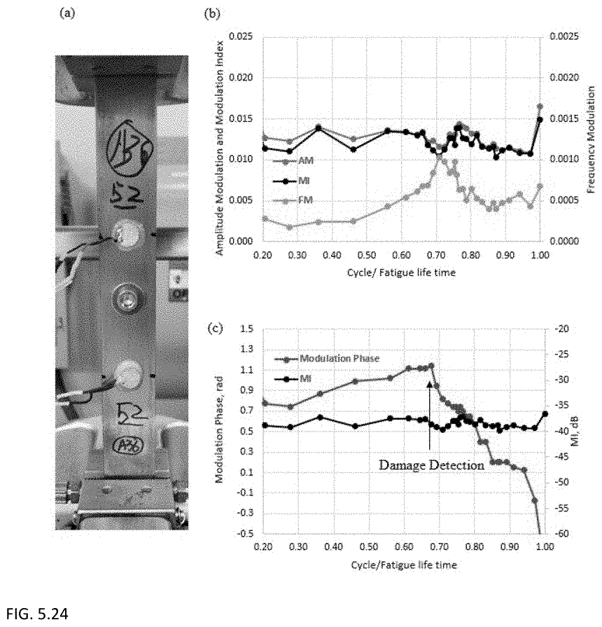

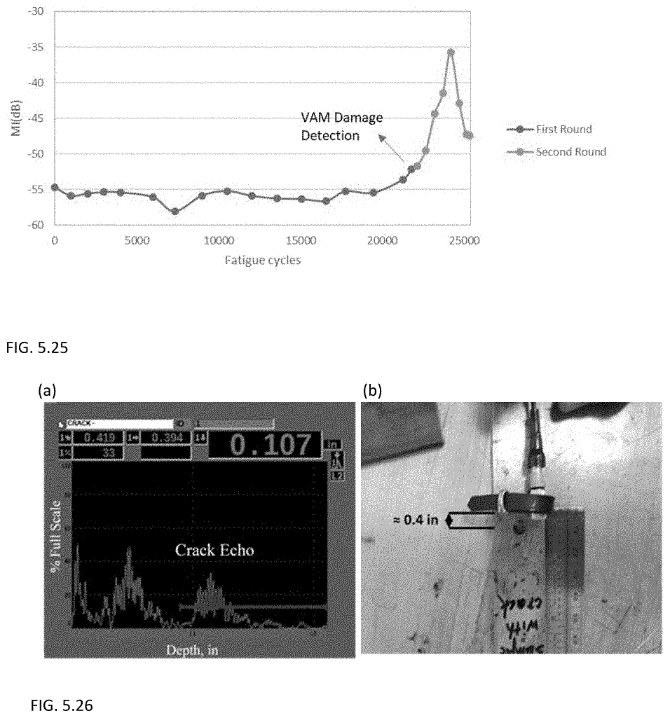

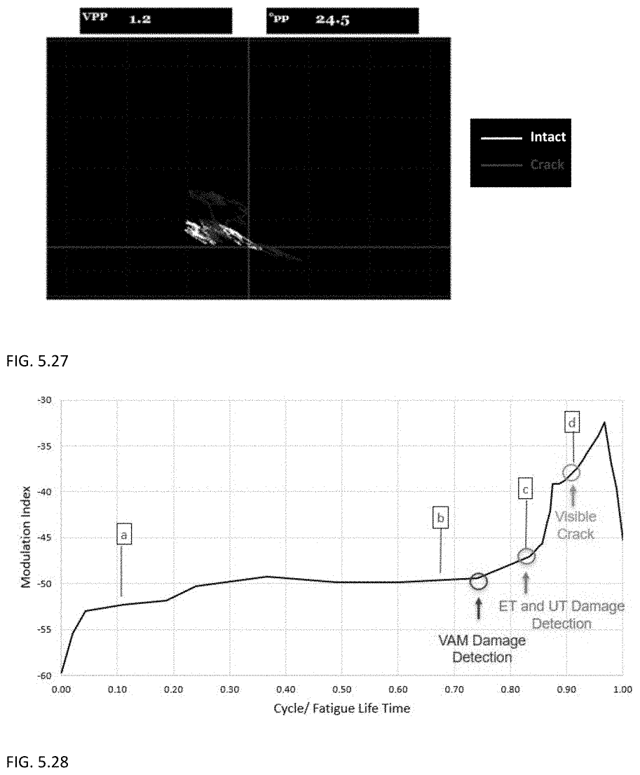

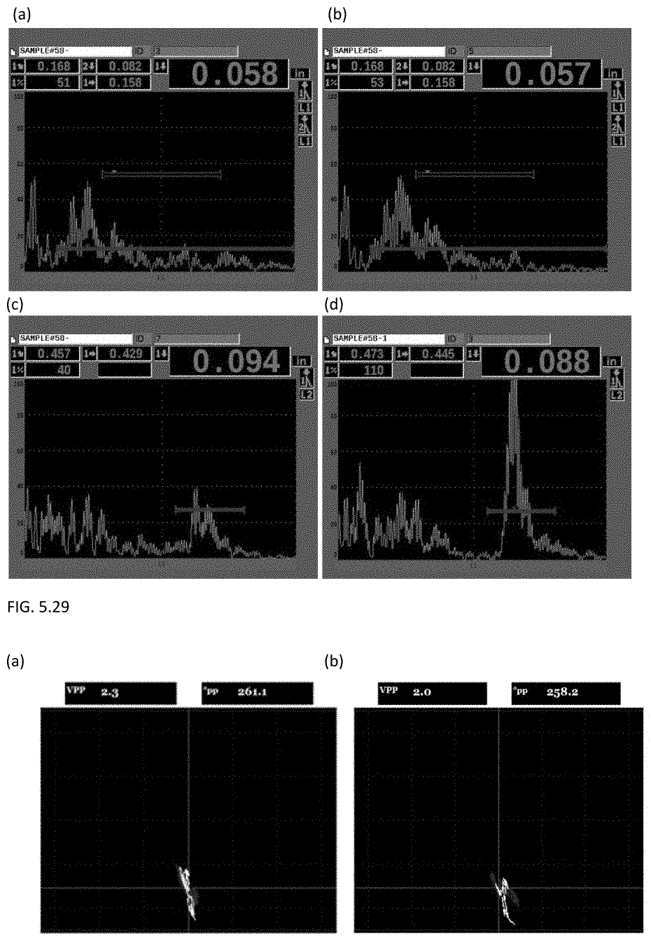

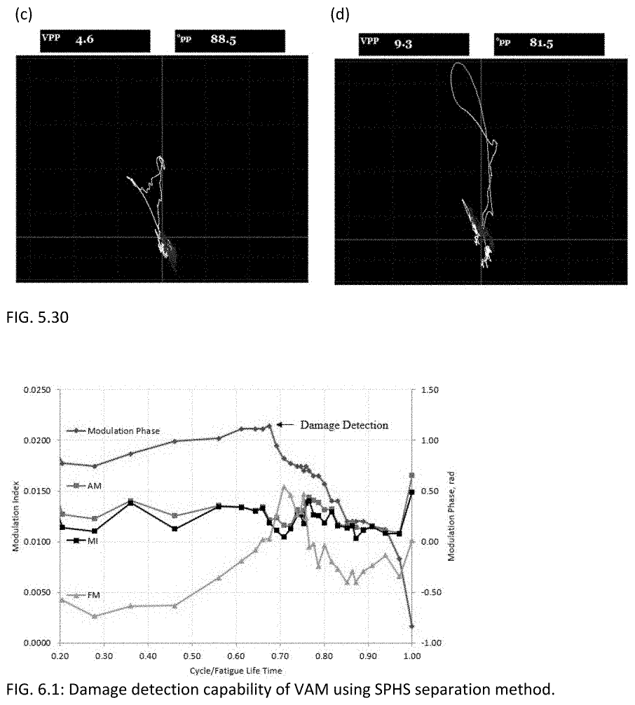

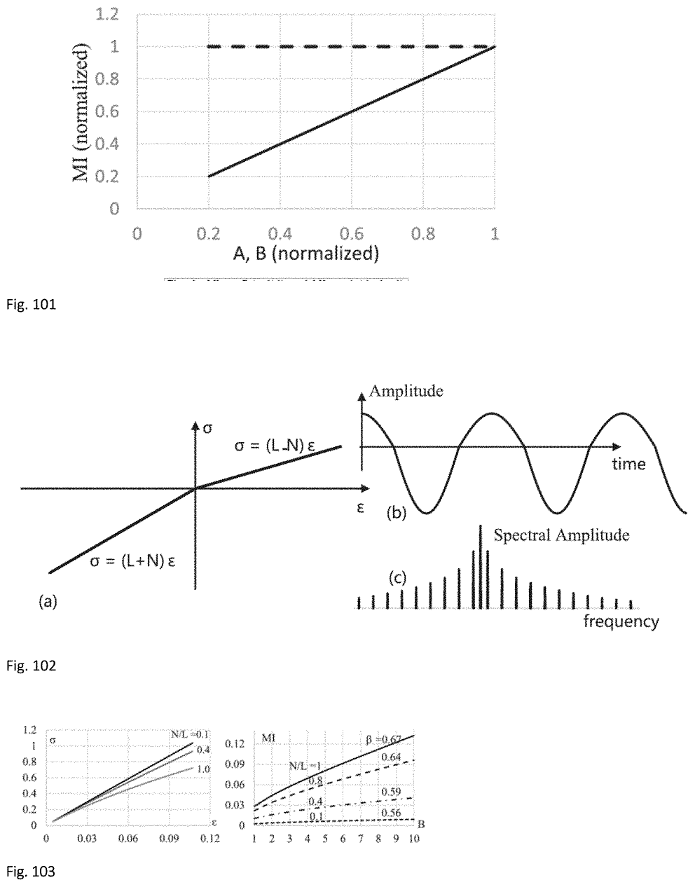

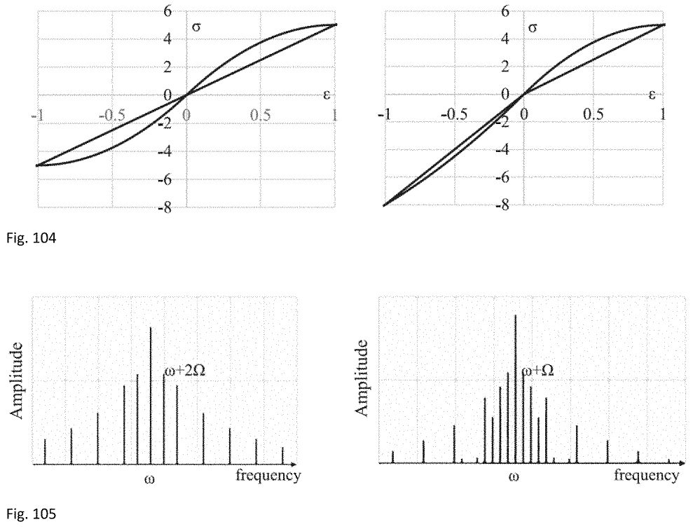

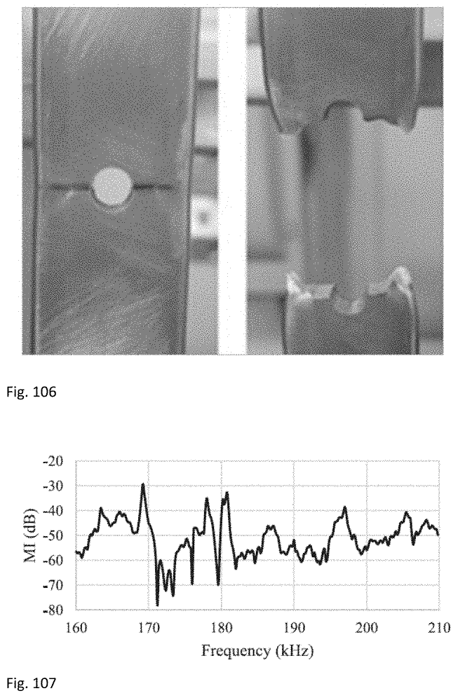

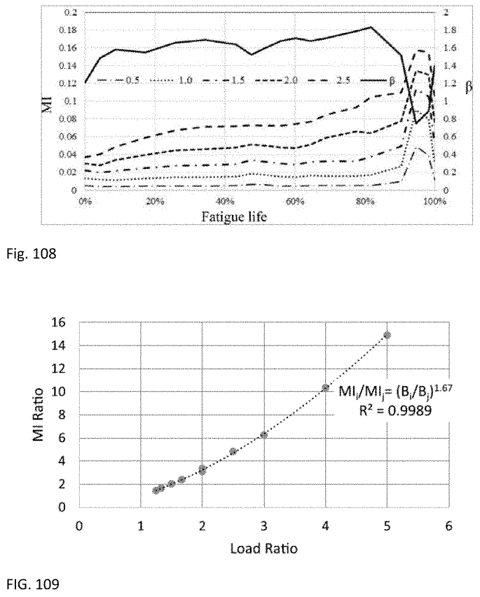

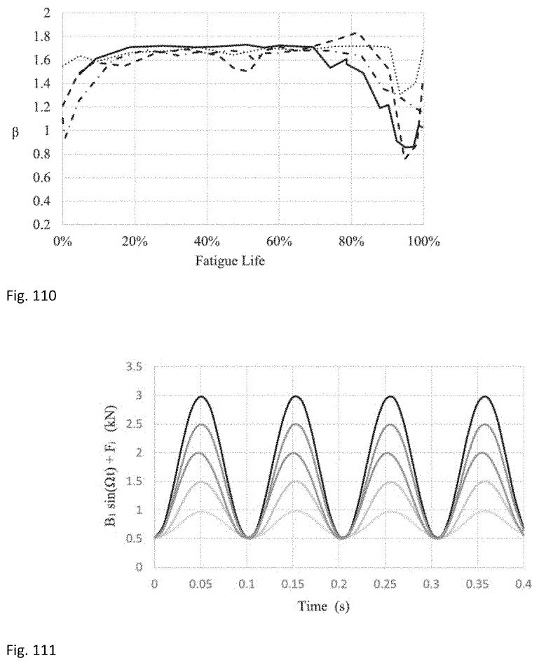

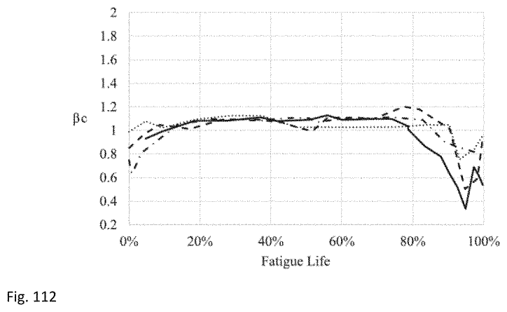

FIG. 4.1 shows the spectrum of an AM signal;

FIG. 4.2 shows the spectrum of an FM signal;

FIG. 4.3 depicts (a) Amplitude and (b) phase frequency responses of the system under test for frequency range of 160 kHz to 180 kHz;

FIG. 4.4 shows spectrum of (a) instantaneous amplitude and (b) instantaneous frequency for pure amplitude modulated signal, spectrum of (c) instantaneous amplitude and (d) instantaneous frequency for pure amplitude modulated signal with amplitude and phase frequency response distortions;

FIG. 4.5 shows the spectrum of (a) instantaneous amplitude and (b) instantaneous frequency for pure amplitude modulated signal and Spectrum of (c) instantaneous amplitude and (d) instantaneous frequency for pure frequency modulated signal;

FIG. 4.6 shows the presence of a non-modulated carrier in addition to the modulated signal in the received signal;

FIG. 4.7 shows spectrum of (a) instantaneous amplitude and (b) instantaneous frequency for pure amplitude modulated signal with additional nonmodulated carrier, spectrum of (c) instantaneous amplitude and (d) instantaneous frequency for pure frequency modulated signal with additional non-modulated carrier;

FIG. 4.8 shows spectral amplitudes and phases of the modulated signal;

FIG. 4.9 depicts schematic steps of in-phase/quadrature homodyne separation (IQHS) algorithm;

FIG. 4.10 shows SPHS result for pure amplitude modulated signal;

FIG. 4.11 shows SPHS result for pure frequency modulated signal;

FIG. 4.12 shows a flowchart of Sweeping-Phase Homodyne Separation (SPHS) algorithm;

FIG. 4.13 shows acquired signal with (a) 2 MHz sampling rate and (b) 10 MHz sampling rate;

FIG. 4.14 shows the SPHS result with (a) 2 MHz sampled signals and (b) 10 MHz resampled signals;

FIG. 4.15 shows (a) power spectrum of unfiltered signal and (b) AM and FM components of unfiltered signal obtained by SPHS;

FIG. 4.16 shows (a) Power spectrum of filtered signal and (b) AM and FM components of filtered signal obtained by SPHS;

FIG. 4.17 shows power spectrum of pure amplitude modulated signal with ma=0.1;

FIG. 4.18 shows (a) AM and (b) FM component of pure amplitude modulated signal (processed by HT), (c) AM and (d) FM component of pure amplitude modulated signal (processed by SPHS);

FIG. 4.19 shows power spectrum of amplitude modulated signal, ma=0.1, with additional non-modulated carrier;

FIG. 4.20 shows (a) AM and (b) FM component of amplitude modulated signal (processed by HT), (c) AM and (d) FM component of amplitude modulated signal with non-modulated carrier (processed by SPHS);

FIG. 4.21 shows power spectrum of pure frequency modulated signal with mf=0.1;

FIG. 4.22 shows (a) AM and (b) FM component of pure frequency modulated signal (processed by HT), (c) AM and (d) FM component of pure frequency modulated signal (processed by SPHS);

FIG. 4.23 shows power spectrum of frequency modulated signal, mf=0.1, with additional non-modulated carrier;

FIG. 4.24 shows (a) AM and (b) FM component of frequency modulated signal with non-modulated carrier (processed by HT), (c) AM and (d) FM component of frequency modulated signal with non-modulated carrier (processed by SPHS);

FIG. 4.25 shows power spectrum of AM×FM signal with ma=0.1 and mf=0.02;

FIG. 4.26 shows (a) AM and (b) FM component of pure frequency modulated signal (processed by HT), (c) AM and (d) FM component of pure frequency modulated signal (processed by SPHS);

FIG. 4.27 shows power spectrum of AM×FM signal, ma=0.1 and mf=0.02, with additional non-modulated carrier;

FIG. 4.28 shows (a) AM and (b) FM component of AM×FM signal with non-modulated carrier (processed by HT), (c) AM and (d) FM component of AM×FM signal with non-modulated carrier (processed by SPHS);

FIG. 5.1 shows (a) Test setup and (b) a specimen mounted in fatigue testing machine;

FIG. 5.2 shows sample geometry of a test material in accordance with an embodiment of the present invention;

FIG. 5.3 shows a VAM equipment setup for fatigue tests: (a) data acquisition board (DAQ), (b) high frequency amplifier (HFA), (c) specimen installed in MTS 810 machine for tension only fatigue test and (d) simple connection diagram;

FIG. 5.4 displays cycling loading parameters in fatigue experiments;

FIG. 5.5 illustrates the frequency response of a sample for frequencies between 120 KHz and 200 KHz with 500 Hz steps;

FIG. 5.6 shows the modulation Index (Normalized to initial MI=−60 dB vs Number of fatigue cycles) of a sample;

FIG. 5.7 depicts a sample with ¼-in thickness at different fatigue cycles;

FIG. 5.8 depicts modulation Index vs Number of Fatigue cycles for Sample with ¼ in thickness;

FIG. 5.9 depicts bolt connections with (a) 1-inch and (b) ½-inch washers;

FIG. 5.10 shows received signal from sample with bolt connection;

FIG. 5.11 shows a magnified waveform of a sample with bolt connection;

FIG. 5.12 shows the SPHS result of bolt connection with 1-inch washer with respect to sweeping-phase reference signal;

FIG. 5.13 shows the modulation index measured by (a) Fourier Transform, (b) direct envelope measurement, (c) SPHS and (d) Hilbert Transform for a sample with 1-inch washer;

FIG. 5.14 shows modulation index results of bolt connection with 1-inch washer with respect to sweeping-phase reference signal;

FIG. 5.15 shows modulation index and AM/FM components measured by (a) SPHS, (b) Hilbert Transform;

FIG. 5.16 is a graph that shows AM and FM growth during fatigue accumulation;

FIG. 5.17 is a graph that shows damage detection (FM) in the presence of a strong AM signal from structural nonlinearity (bolted connection);

FIG. 5.18 shows (a) Sample without connection under fatigue test with 20 KN tension only cycling loading and (b) visible crack at the 44057 cycle (95% of fatigue life time);

FIG. 5.19 is a graph that shows (a) AM/FM separation of the sample without connection and (b) modulation phase detection;

FIG. 5.20 shows (a) Simple sample under fatigue test with 26 KN tension only cycling loading, (b) visible crack at the 12773 cycle (93% of fatigue life time), and graphs showing (c) AM/FM Separation of frequency 198.5 kHz and (d) Modulation phase detection of frequency 198.5 kHz;

FIG. 5.21 is a schematic of the connection with generated contact perpendicular to the vibration direction;

FIG. 5.22 shows (a) sample with designed connection (contact parallel to vibration) by initial high level of nonlinearity under 20 KN tension only cycling loading, (b) AM/FM Separation of 195 kHz frequency, and (c) Modulation phase detection of 195 kHz frequency;

FIG. 5.23 shows (a) a sample with screw only (contact perpendicular to vibration) direction showing an initial high level of nonlinearity under 20 KN tension only cycling loading, (b) AM/FM separation of 175 kHz frequency, and (c) modulation phase detection;

FIG. 5.24 shows (a) a sample with screw and nut connection (contact is both parallel and perpendicular to vibration) showing an initial high level of nonlinearity under 20 KN tension only cycling loading, (b) AM/FM separation of 188 kHz frequency, and (c) modulation phase detection of 188 kHz frequency;

FIG. 5.25 depicts Modulation Index vs Number of Fatigue cycles (tested with EC and UT);

FIG. 5.26 shows (a) UT result and (b) UT sensor position;

FIG. 5.27 shows an impedance plane graph of ET inspection at cycle 45921 (91% of fatigue life time);

FIG. 5.28 shows the sample inspected by ET and UT at (a) 11%, (b) 68%, (c) 83%, and (d) 95% of its fatigue life time;

FIG. 5.29 shows echo-pulse graphs of Ultrasonic testing inspection at cycle: (a) 5573 (11% of fatigue life time), (b) 34675 (68% of fatigue life time), (c) 41637 (83% of fatigue life time, earliest increase in impedance), and (d) 47755 (95% of fatigue life time, visible crack;

FIG. 5.30 shows ET impedance plane graphs at cycle: (a) 5573 (11% of fatigue life time), (b) 34675 (68% of fatigue life time), (c) 41637 (83% of fatigue life time, earliest increase in impedance), and (d) 47755 (95% of fatigue life time, visible crack);

FIG. 6.1 is a graph illustrating the damage detection capability of VAM using SPHS separation method.

FIG. 101 is a graph of Modulation Index (MI) vs. B (solid) and MI vs. A (dashed);

FIG. 102 is a graphical illustration of the case of bi-linear stiffness: (a)—stress-strain, (b)—LF output waveform, (c)—HF modulated spectrum;

FIG. 103 is a graphical illustration of Stress-strain dependence (a) and a plot of MI vs. B for various N/L ratios (b), all units being arbitrary normalized;

FIGS. 104a and 104b are graphical illustrations of hysteresis, including symmetrical N1/N2=1 (a) and asymmetrical N1/N2=2.5 (b), all units being arbitrary normalized;

FIG. 105 shows modulation spectra for symmetrical (a) and asymmetrical (b) hysteretic dependences of FIG. 104;

FIG. 106 is a photograph showing a test bar and its stress area before (a) and after (b);

FIG. 107 is a graph of MI against frequency;

FIG. 108 is a graph showing averaged MI for five LF modulating amplitudes (Bi=0.5, 1.0 . . . 2.5 kN) vs % of fatigue life, the top solid line being the calculated power coefficient β based on the five MI dependences;

FIG. 109 is an example of MI Ratio vs Load Ratio with fitted power trendline (dashed) showing β=1.67 determined with high reliability (the coefficient of determination, R2=0.9989);

FIG. 110 is a graph depicting Power Coefficient β vs. Fatigue life for four identical A108 steel samples;

FIG. 111 depicts Waveforms of the applied 10 Hz vibrations with amplitudes Bi and corresponded static force Fi; and

FIG. 112 is a graph, corrected for the static stress power damage coefficient, of βc vs fatigue life for four A108 steel bars.

### DETAILED DESCRIPTION OF EMBODIMENTS

Before any embodiments of the present invention are explained in detail, it is to be understood that the present invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the present invention. Various modifications to the illustrated embodiments will be readily apparent to those skilled in the art, and the generic principles herein can be applied to other embodiments and applications without departing from embodiments of the present invention. Thus, embodiments of the present invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the present invention. Skilled artisans will recognize the examples provided herein have many useful alternatives and fall within the scope of embodiments of the present invention.

Embodiments of the present invention herein generally describe non-conventional approaches to systems and methods to data processing and management that are not well-known, and further, are not taught or suggested by any known conventional methods or systems. Moreover, the specific functional features are a significant technological improvement over conventional methods and systems, including at least the operation and functioning of a computing system that are technological improvements. These technological improvements include one or more aspects of the systems and methods described herein that describe the specifics of how a machine operates, which is the essence of statutory subject matter.

One or more of the embodiments described herein include functional limitations that cooperate in an ordered combination to transform the operation of a data repository in a way that improves the problem of data storage and updating of databases that previously existed. In particular, some embodiments described herein include systems and methods for managing structural health-related content data items across disparate sources or applications that create a problem for users of such systems and services, and where maintaining reliable control over distributed information is difficult or impossible.

The description herein further describes some embodiments that provide novel features that improve the performance of communication and software, systems and servers by providing automated functionality that effectively and more efficiently manages resources and asset data structural health data analysis for a user in a way that cannot effectively be done manually. Therefore, the person of ordinary skill can easily recognize that these functions provide the automated functionality, as described herein, in a manner that is not well-known, and certainly not conventional. As such, the embodiments of the present invention described herein are not directed to an abstract idea, and further provide significantly more tangible innovation. Moreover, the functionalities described herein were not imaginable in previously-existing computing systems, and did not exist until some embodiments of the present invention solved the technical problem described earlier.

Some embodiments of the present invention include a method and algorithm to detect and monitor damage evolution in materials and structures such as bridges, airframes, ship hulls, storage tanks, pipes, etc. The present invention includes a higher sensitivity and versatility as compared to conventional technologies. The invention overcame this problem by detecting small changes associated with damage evolution even in the presence of much higher nonlinear signal background due to structural interfaces. This is achieved by new methods and procedures as described below.

Some embodiments include a method that utilizes two or more ultrasonic sensors attached or embedded into the structure to be monitored, a low frequency accelerometer, signal conditioning, data acquisition and processing electronics, electronic storage and communications devices. In some embodiments, at least one of the ultrasonic sensors is a transmitter, and others are receivers.

In some embodiments of the present invention, a first step of the method consists of measuring structure amplitude and phase frequency responses within the operating range of the ultrasonic sensors to determine a set of fixed ultrasonic frequencies to be used in following damage testing and monitoring. The procedure sets several criteria for the selection of frequencies. This step also includes ambient vibration data collection with the accelerometer to determine a set of low frequencies to be used as modulating frequencies in the following up steps. The ultrasonic and vibration frequencies are determined, and the second step involves a series of procedures enabling modulated phase homodyne demodulation (MPHD) algorithm depicted in FIG. 1, showing a flow chart of MPHD signals generation, acquisition, and processing. In this instance, “DC” is the “Direct Current”, i.e., a non-oscillating component of the homodyned, filtered, de-trended, and squared modulated signal carrying information about damage; Δφ is the phase shift step of the carrier signal; MP is the modulation phase which equals to the phase φₙ at which DC (φₙ) reaches a maximum value. In some embodiments, MP is observed and recorded (monitored) during a life interval of the tested structure, and any changes in the MP value (e.g., over time) indicates damage development. A detailed description of the algorithm is described below followed by a successful implementation of the algorithm for damage evolution monitoring during fatigue experiments in presence of contact-type nonlinearities.

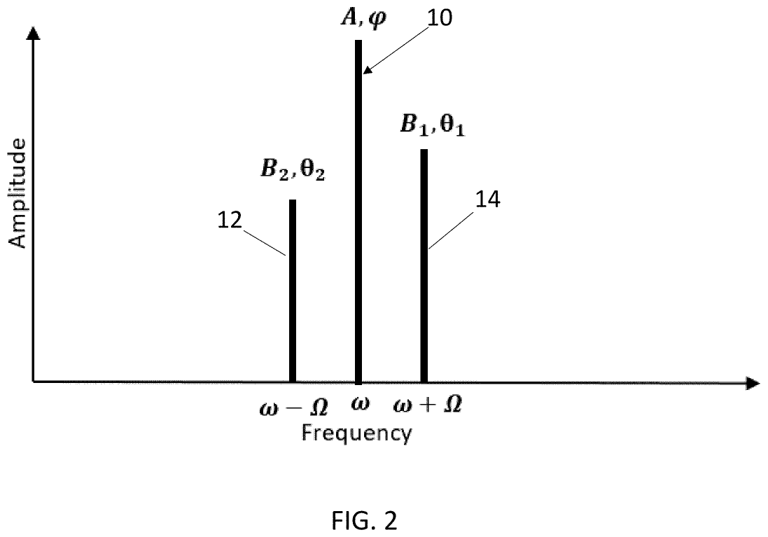

FIG. 2 illustrates a schematic of a power spectrum of an acquired modulated signal in accordance with some embodiments of the present invention. In some embodiments, an acquired modulated signal is used as the input of the algorithm that includes a carrier signal frequency 10, and two lower and upper sidebands 12, 14 in the power spectrum.

In some embodiments, to formulate the algorithm, unsymmetrical sidebands with random amplitudes, B₁ and B₂, and phases, θ₁ and θ₂, (Equations (1) and (2)) are assumed as well as a superposed carrier signal (Equation (3)), shown below:

B₁ cos((ω+Ω)t+θ₁) (1)

B₂ cos((ω−Ω)t+θ₂) (2)

A cos(ωt+φ) (3)

The superposed carrier signal consists of two parts: a) a modulated carrier, involved in the modulation process, and b) a non-modulated carrier, not involved in the modulation process and that only contributes to the amplitude, A, and phase, φ, of the superposed carrier (Equation (3)) and does not affect sidebands. The algorithm is capable of differentiating between the phases of the modulated and non-modulated carriers, and test results have demonstrated that MP, which is the phase of the modulation carrier, could be an indicator of structural damage evolution.

In some embodiments, the superposed carrier signal is deconstructed to its modulated and non-modulated parts as expressed in Equation (4) to observe the algorithm effect on the acquired signal. The non-modulated carrier appears in the acquired signal because the transmitted high frequency carrier signal also travels through intact parts of the sample in addition to its involvement in the modulation in defect areas.

A cos(ωt+φ)=Aₘ cos(ωt+φₘ)+Aₙₘ cos(ωt+φₙₘ) (4)

In Equation (4), Aₘ and φₘ are the modulated carrier's amplitude and phase, and Aₙₘ and φₙₘ are the non-modulated carrier's amplitude and phase, respectively. The algorithm's output would express φₘ as MP.

To detect MP, the acquired signal is multiplied by cos(ωt+φₙ) in which φₙ is swept over sampling points by π/Δφ as depicted in FIG. 1. As a result, the following components are obtained:

$$\frac{{B}_{1}}{2} cos ( ( 2 ω + Ω ) t + {θ}_{1} + {ϕ}_{n} ) + \frac{{B}_{1}}{2} cos ( Ω t + {θ}_{1} - {ϕ}_{n} ) + \frac{{B}_{2}}{2} cos ( ( 2 ω - Ω ) t + {θ}_{2} + {ϕ}_{n} ) + \frac{{B}_{2}}{2} cos ( Ω t - {θ}_{2} + {ϕ}_{n} ) + \frac{{A}_{m}}{2} cos ( 2 ωt + {ϕ}_{m} + {ϕ}_{n} ) + \frac{{A}_{m}}{2} cos ( {ϕ}_{m} - {ϕ}_{n} ) + \frac{{A}_{n m}}{2} cos ( 2 ωt + {ϕ}_{n m} + {ϕ}_{n} ) + \frac{{A}_{n m}}{2} cos ( {ϕ}_{n m} - {ϕ}_{n} ) \qquad ( 5 )$$

In some embodiments, the high frequency components of the signal could be filtered by a low-pass filter with the cut-off frequency above Ω. The remaining part is detrended (DC component is removed). Detrending is removing a trend from a time series, here the DC component. In some embodiments, when describing a periodic function in the time domain, the DC component is the mean amplitude of the waveform. The outcome of this low-pass filtering and detrending process is shown in Equation (6).

$$\frac{{B}_{1}}{2} cos ( Ω t + {θ}_{1} - {ϕ}_{n} ) + \frac{{B}_{2}}{2} cos ( Ω t - {θ}_{2} + {ϕ}_{n} ) \qquad ( 6 )$$

In continuation of the algorithm, the remaining signal, produced as a result of low-pass filtering and detrending, is squared and the DC component of this signal is measured as expressed in Equation (7) shown below:

$$D C ( {ϕ}_{n} ) = \frac{{B}_{1}^{2}}{8} + \frac{{B}_{2}^{2}}{8} + \frac{{B}_{1} {B}_{2}}{4} cos ( {θ}_{1} + {θ}_{2} - 2 {ϕ}_{n} ) \qquad ( 7 )$$

Experimental observations have shown that the maxima of the final measured DC component can correspond to the MP. Therefore, by getting a derivative of this formula, the MP had been found. Since the MP presents in the phases of upper and lower sidebands, θ₁ and θ₂, the value that maximizes DC(φₙ) is MP in the received modulated signals.

In some embodiments, the received modulated signal could be a combination of amplitude or angular (phase/frequency) modulation. Below are two examples of pure amplitude and pure frequency modulated signals which describe how the MP appears in the phases of sidebands (θ₁ and θ₂).

A pure amplitude modulated signal is assumed with additional non-modulated carrier as follow:

xₐ(t)=Aₘ(1+2mₐ cos(Ωt+θₐ)cos(ωt+φₘ)+Aₙₘ cos(ωt+φₙₘ) (8)

where 2mₐ is the amplitude modulation index.

Expanding the above Equation (8) gives:

xₐ(t)=Aₘmₐ cos((ω−Ω)t+φₘ−θₐ)+Aₘ cos(ωt+φₘ)+Aₘmₐ cos((ω+Ω)t+φₘ+θₐ)+Aₙₘ cos(ωt+φₙₘ) (9)

In this case, θ₁ and θ₂ equals to φₘ+θₐ and φₘ−θₐ, respectively. It is apparent that the MP contributes to both sidebands and therefore, the maxima of DC((pₙ) of MPHR as expressed in Equation (7) shows the MP.

In another example, a pure frequency modulated signal with additional non-modulated carrier could be assumed as stated in Equation (10).

x_{f}(t)=Aₘ cos(ωt+2m_{f} sin(Ωt+θ_{f})+φₘ)+Aₙₘ cos(ωt+φₙₘ) (10)

where 2m_{f} is the frequency modulation index. By expanding the above Equation (10) and considering only the first pair of sidebands:

x_{f}(t)=Aₘm_{f} cos((ω−Ω)t+φₘ−θ_{f})+Aₘ cos(ωt+φₘ)+Aₘm_{f} cos((ω+Ω)t+φₘ+θ_{f})+Aₙₘ Cos(ωt+φₙₘ) (11)

Again, in the stated pure frequency modulated signal, the MP appears in upper and lower sidebands, therefore, finding the maxima of Equation (7) reveals the MP.

In reality, a combination of amplitude and angular modulation can occur in the structure where the signal is mixed with the structural nonlinearity such as in bolts, rivets, and other conventional fastening assemblies or components. Experiments have shown that the MPHD algorithm can reveal the MP related to modulation in the damaged part, and its evolution could be an indicator of damage.

FIG. 3 MP shows damage evolution monitoring in the presence of strong contact nonlinearity, and demonstrates experimental implementation of the present invention clearly showing the damage evolution as changing MP value. Conversely, traditional MI does not show damage (no changes) because of high level of nonlinearity due to bolt and lap joint interfaces. The image on the right shows a stress-fatigued steel bar with attached bolt/lap joint connection. Graphs on the left show MI and MP during fatigue lifetime of the bar.

Any of the methods and operations described herein that form part of the present invention can be useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal, and that can electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes, without limitation, volatile and non-volatile, removable and non-removable storage media implemented in any method or technology for the tangible storage of information such as computer-readable instructions, data structures, program modules or other data.

FIG. 4 shows a non-limiting example embodiment of a block diagram of a computer system 40 including the capability to implement any one or more of the methods described herein. The computer system 40 includes a processor 42 connected with a memory 44, where the memory 44 is configured to store data. In some embodiments, the processor 46 is configured to interface or otherwise communicate with the memory 44, for example, via electrical signals propagated along a conductive trace or wire. In an alternative embodiment, the processor 46 can interface with the memory 44 via a wireless connection. In some embodiments, the memory 44 can include a database 48, and a plurality of data or entries stored in the database 48 of the memory 44.

As discussed in greater detail herein, in some embodiments, the processor 46 can be tasked with executing software or other logical instructions to perform one or more of the aforementioned methods, including, but not limited to, the methods embodied by the first and second logic modules. In some embodiments, input requests 42 can be received by the processor 46 (e.g., via signals transmitted from a user at a remote system or device, such as a handheld device like a smartphone or tablet, to the processor 46 via a network or internet connection). In an alternative embodiment, the input requests 42 can be received by the processor 46 via a user input device that is not at a geographically remote location (e.g., via a connected keyboard, mouse, etc. at a local computer terminal). In some embodiments, after performing tasks or instructions based upon the user input requests 42, for example, looking up information or data stored in the memory 44, the processor 46 can output results 43 back to the user that are based upon the input requests 42.

Although one or more of the method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

Other features, attributes and exemplary embodiments of the present invention will now be presented. An in-depth discussion of the nonlinear ultrasonic monitoring techniques specifically Vibro-Acoustic Modulation NDE method is provided in Section 3. Section 4 is allocated to the study of the challenges in detecting structural defects and the solutions to overcome them. The amplitude and frequency separation is introduced as one solution to distinguish nonlinearities from flaws and contact-type connections. The limitations of Hilbert Transform as the traditional method for signal demodulation is discussed. Two novel demodulation algorithms, In-phase/Quadrature Homodyne Separation (IQHS) and Sweeping Phase Homodyne Separation (SPHS), are presented to effectively separate AM and FM components. The experimental study of proposed algorithms and their damage detection efficiency in presence of contact-type nonlinearities is presented in Section 5. Moreover, the sensitivity of the Vibro-Acoustic Modulation technique to cracks during fatigue loading is investigated compared to linear Ultrasonic and Eddy Current testings. Section 6 mentions the main conclusions of this study regarding layered nanocomposite joining and AM/FM separation in Vibro-Acoustic Modulation and suggests future works in these areas.

The present invention relates to nonlinear Vibro-Acoustic Modulation (VAM), one of the prevailing nonlinear methods for material characterization and structural damage evaluation. This approach, however, does not differentiate between various type of modulations (amplitude, AM, or frequency, FM) contributing to the Modulation Index, MI. The present invention aims to develop an algorithm of AM/FM separation specifically for VAM method. It is shown that the commonly used Hilbert transform (HT) separation may not work for a typical VAM scenario. The developed IQHS and SPHS algorithms address HT shortcomings. They have been tested both numerically and experimentally (for fatigue cracks evolution) showing FM dominance at the initial micro-crack growth stages and transition to AM during macro-crack formation. In addition, SPHS algorithm is capable of detecting fatigue crack via monitoring of modulation phase.

In the present disclosure, two new algorithms, In-Phase/Quadrature Homodyne Separation (IQHS) and Sweeping-Phase Homodyne Separation (SPHS) are proposed for separating the amplitude and frequency modulated components of the received signal.

These algorithms are supported by numerical and experimental measurements of MI and recording of the real signals (for post-processing) from nonlinear sources such as bolt and screw connections. In this discussion, comprehensive experimental studies are carried out to investigate the modulation index dependence of different fatigue stress levels. In addition, the studies summarized herein investigated the AM and FM components pattern in fatigue crack evolution. This provides further understanding of modulation type in fatigue loading. Also, the modulation phase evolution during fatigue loading is investigated in detail.

### Section 3—Introduction to Nonlinear Vibro-Acoustic Modulation Method

### Section 3.1—Introduction

Numerous experimental and theoretical studies indicate nonlinear properties (nonlinear stress-strain relationship) of damaged materials because of micro/meso and macro defects. In damaged materials, the nonlinear response is provided by the Contact Acoustic Nonlinearity (CAN): strongly nonlinear local vibrations of defects due to mechanical constraint of their fragments, which efficiently generate multiple ultra-harmonics and support multi-wave interactions. Consider a pre-stressed crack (a static stress σ0 driven with longitudinal acoustic traction σ˜ (FIG. 3.1) which is strong enough to provide clapping of the crack interface.

The clapping nonlinearity is due to asymmetrical dynamics of the contact stiffness: the latter is, apparently, higher in a compression phase (due to clapping) than that for tensile stress when the crack is assumed to be supported only by edge stresses. The bi-modular pre-stressed contact driven by a harmonic acoustic strain ε(t)=ε0 cos νt is similar to a mechanical diode and results in a pulse-type modulation of its stiffness C(t) and a half-period rectified output as shown in FIG. 3.2. Contact interfaces such as cracks, delaminations, and disbonds show strong FIG. 3.2: (a) Mechanical diode model; (b) stiffness modulation and waveform distortion nonlinearities. This type of contact acoustic nonlinearity is explained by “clapping” and rubbing of the interfacial surfaces based on vibrations.

The “clapping” mechanism of alternate opening and closing is set up under cyclic compression and tension. Here the defect stiffness under compression is much higher than that under tension. Given the likelihood that such a defect will have an elliptical profile in the open position, there is the additional complexity that it might be excited by more than one frequency (or a range of frequencies) due to variable stiffness across the defect profile. These elliptical cracks are usually represented by one spring and one damper. Also, it should be considered that the dislocation, friction, stress concentration and temperature gradient at the crack area can also produce nonlinear modulation at a very low strain level without crack opening and closing.

Another type of material degradation associated with increased nonlinearity is micro- and mesoscopic fatigue damage accumulation due to dislocations, hysteresis, formation of slip planes, and microcrack development and clustering.

The sensitivity of the nonlinear acoustic techniques (NAT) to defects has been shown to be far better than that of the linear ones. Another important feature of the nonlinear techniques is their ability to detect flaws in highly inhomogeneous and complicated geometries/structures since structural inhomogeneities and features (holes, voids, channels, bonded laminations, boundaries, etc.) are linear and have no or little effect on the nonlinear readouts.

The NATs have also some limitations. One of the essential problems with their practical implementations for nondestructive testing and evaluation (NDT& E) is the need for a well-established reference. There are structural (flawless) sources of contact, instrument and measurement nonlinearities. Structural supports and connections, inserts, etc. and instrumentation and measurement nonlinearities contribute to the nonlinear response and the background nonlinear readouts respectively. The background nonlinearity must be recorded for a reference structure and particular measurement setup and then compared with the structure undergoing NDT& E. Identifying this background nonlinearity is one of the difficulties in utilization of nonlinear acoustic technique. This drawback is, perhaps, one of the primary reasons that the nonlinear methods most reported are still experimental and are not yet established as practical and reliable defect detection tools.

Among the number of different nonlinear methods, there are two methods viable and broadly used: harmonic distortion and modulation methods. A simplified graphical illustration of these two methods is presented in FIG. 3.3.

### Section 3.1.1—Harmonic Distortion Methods

Historically, one of the first methods to characterize the acoustic nonlinearity is to measure the degree of the nonlinear (harmonic) distortion of a sinusoidal acoustic (vibration) signal. This approach has been widely used for the characterization of nonlinearity in fluids, biological media, electromechanical systems, and material nonlinearity of solids. The essence of the method is illustrated in FIG. 3.3. An input signal is a sinusoidal waveform with frequency f1 and amplitude A1. The nonlinearity distorts the waveform so its spectrum contains additional harmonics. Typically, these are higher harmonics with frequencies 2f1, 3f1, and, respectively, diminishing amplitudes A1>A2>A3>. Because of this decrease in amplitude, most of the studies consider only the second harmonic for characterization of nonlinearity of defect. The second-harmonic approach has been used for evaluation of fatigue cracks, dislocations and other fatigue damages. The range of frequencies and type of acoustic/vibration waves vary significantly depending on the specific applications: type of material, size of structure, and type and size of flaws. Thus, the reported frequencies used for the nonlinear detection span from hundreds of hertz to tens of megahertz. Flexural and torsional vibrations, longitudinal, shear, surface and guided acoustic waves were utilized.

The stiffness of the elastic layer with the clapping disbond is modeled as a bilinear spring (FIG. 3.4(b)):

$$K ( ɛ ) = \{ \begin{matrix}κ S & if ɛ < 0 \\ •• κ ( S - S 0 ) & if ɛ \geq 0\end{matrix} . \qquad ( 3.1 )$$

where K is the stiffness per unit area of the elastic layer without the defect, S is the full area of the layer, S0 is the area of a disbond, and E is the local strain at the elastic layer: negative E corresponds to compression (full closure of the disbond) and positive E is for tension (opening of the disbond) as shown in FIG. 3.4(a).

The challenges in harmonic measurement method are system nonlinearities from electronic and electromechanical equipment, such as signal generators, amplifiers, and transducers. These signals generate a certain level of the harmonic distortion in the first place. This background level in the nonlinear signal limits the sensitivity of the method to defects with smaller nonlinearities.

### Section 3.1.2—Modulation Methods

The modulation methods utilize the effect of the nonlinear interaction of acoustic/vibration waves in the presence of the nonlinear defects. The instantaneous amplitude and phase were analyzed. It was observed prior that the intensity of amplitude modulation corresponds better with crack lengths than the intensity of frequency modulations. A similar result was later obtained displaying that elevated amplitude modulation effects are measured at the damaged area, whereas there is no direct relation between the frequency modulation and the location of the damage.

There are two modifications of the modulation method: vibromodulation (VM) and impact modulation (IM). The VM method uses two sinusoidal waves with the frequencies f0 and f1. The nonlinearity of the defect causes mixing of these two signals which leads to a new signal with the combination frequencies f1 Typically, the VM method exploits lower frequency modulating and higher frequency probing signals: f0<<f1. Applied lower frequency vibration changes the contact area within a defect or damaged area, effectively modulating the amplitude of the higher frequency probing wave passing through the changing contacts. In the frequency domain, this modulation manifests itself as the sideband spectral components, f1±f0, as shown in FIGS. 3.3 and 3.5. The defect or damage can be detected and characterized by the amplitude of the sideband components or, better, the modulation index (MI) (in decibel scale):

$$MI = 20 {log}_{10} ( \frac{{A}_{-} + {A}_{+}}{2 {A}_{1}} ) \\ = 20 {log}_{10} ( \frac{{A}_{-} + {A}_{+}}{2} ) - 20 {log}_{10} {A}_{1} \qquad ( 3.1 )$$

Strong defect nonlinearities may lead to the occurrence of numerous sideband components with the frequencies f1±mf0, where m=1, 2, as evident from FIG. 3.5(b) and other experimental observations. In practice, however, only the first sidebands (m=1) are used as a reliable indicator of the damage.

The main advantage of IM over the VM approach is the ease of excitation of the low-frequency signal: a simple hammer can be used instead of an electronically controlled low-frequency vibration/acoustic source; however, IM does not work for structures with low vibration damping since modulation does not happen due to damping of low-frequency signal.

The modulation methods could be implemented using a continuous wave (CW) or a sequence of burst ultrasonic signals. CW implementations of the VM (CW−VM) and IM (CW−IM) methods showed that the choice of the ultrasonic frequency, f1, may have a significant impact on the MI, often leading to the erroneous interpretation of the test result. As seen from the recorded structural frequency responses of the probing ultrasonic signal and its side-bands (FIG. 3.6), MI could vary as much as 40 dB depending on the choice of the primary frequency, f1. This variation is because of resonances and antiresonances of the structure. Theoretical studies and numerous tests with different structures and materials determined that reliable damage detection and characterization could be accomplished with frequency averaging as follows:

$$MI = 20 {log}_{10} ( \frac{1}{N} {\sum }_{n = 1}^{N} ( \frac{{A}_{+} ( {f}_{n} + {f}_{0} ) + {A}_{-} ( {f}_{n} - {f}_{0} )}{2 {A}_{1} ( {f}_{n} )} )$$

where fn=Fstart+n·ΔF is the fundamental ultrasonic frequency swept in steps n over the frequency range Fstart+N·ΔF, with Fstart being the starting frequency, ΔF the frequency step, and N the total number of steps.

The choice of ΔF is determined by the density of the resonances in the frequency response of the particular structure for the chosen frequency range. For proper averaging, ΔF should be less than the frequency separations between the resonances. The number of frequency steps should be at least 30, preferably 100. In the burst implementation of the vibromodulation method (B-VM), a sufficiently long sequence of bursts with the central frequency fn for each burst and the repetition frequency FR>2f0 could be used instead of a CW ultrasonic signal. The B-VM method is more complicated to implement, requiring elaborate signal collection and processing.

One of the problems using VM and, especially IM methods, for NDT&E screening for damage in multiple parts of the same kind is the calibration of the modulating vibration. On the other hand, VM techniques can utilize vibrations of the structure during its normal operation as a modulating signal. For example, VM monitoring of a bridge could utilize vibration due to traffic and wind, etc.

In addition, recent research have also been performed on broadening the capabilities of VAM to localize and assess the range of damage. This research include the use of noncontact ultrasonic transducers to localize simulated and impact damage in a thin-polystyrene plate or fatigue cracks in aluminum components. In both cases, the localization of damage can be achieved by scanning a certain area of the structure and mapping the intensity of modulation derived from the amplitudes of the sideband components. Similar methods are presented to localize damage detection using hybrid contact-noncontact transducers. An approach using the combination of contact and noncontact ultrasonic transducers has also been exhibited to detect delamination in a carbon fiber reinforced laminate. A photoacoustic excitation of an HF probe is explained in the associated literature. The test sample is excited with vibration signals generated using a fixed piezoelectric transducer and a moving intensity—modulated laser source. Signals for the mixed frequency components are acquired by a moving accelerometer.

An ultrasonic method providing for an efficient global detection of defects in complex media (multiple scattering or reverberating media) was previously introduced. Mixing of coda waves (stemming from multiple scattering) with lower frequency swept vibration waves has been used to detect the damage. Coda waves are correlated with effective nonlinear parameters of the medium. Nonlinear scatterers, such as cracks and delamination lead to this nonlinear mixing step; however, this mixing is not observable when the waves are scattered only by linear scatterers, as is the case in a complex but defect-free medium. By comparing results at two damage levels, the effective nonlinear parameters are shown to be correlated with crack presence in glass samples.

In another effort, an all-optical probing method for the study of the nonlinear acoustics of cracks in solids was reported. The absorption of radiation from a pair of laser beams intensity modulated at two different frequencies initiated nonlinear acoustic waves, FIG. 3.7. The detection of acoustic waves at mixed frequencies, absent in the frequency spectrum of the heating lasers, by optical interferometry or deflectometry gives obvious evidence of the elastic non-linearity of the crack. The highest acoustic nonlinearity is observed in the transitional state of the crack, which is intermediate between the open and the closed ones.

In summary, the sensitivity of linear ultrasonic testing (UT) significantly decreases as the damage size gets smaller. Being orders of magnitude more sensitive to micro- and mesoscopic damages, nonlinear acoustics offers a unique opportunity to monitor and characterize the damage accumulation at these scales.

To confirm that the nonlinear acoustic damage index is responsive to the micro- and mesoscale structural changes, a microscopic analysis of the fatigue samples using a scanning acoustic microscope (SAM) and a scanning electron microscope (SEM) can be conducted. Investigations of the nonlinear dynamics of materials with contact-type macrodefects (cracks, disbonds, delaminations) as well as fatigued materials with micro- and mesoscale damages show their unusually high acoustic nonlinearities, often orders of magnitude greater than found in undamaged materials.

Advantages of the Nonlinear Acoustic Testing (NAT) include much higher nonlinear response contrast between damaged/undamaged materials: studies report hundreds of percents change in the nonlinear response versus only a fraction of a percent in the linear response for the same damage. Being responsive to only nonlinear defects, the NAT can be used in structures with complicated geometries in which multiple reflections (reverberation) often preclude the use of the linear Ultrasonic Technique.

One of the difficulties in implementing NAT for many NDT&E applications is the requirement for a well-established “nonlinear background” reference for a particular structure. However, because SHM detects (monitors) changes in the materials/structure over time, the initial measurements could be used as a reference for the very same structure. This reference, correlated with the extremely high responsiveness to changes due to damage, makes the NAT highly suitable for Structural Health Monitoring (SHM) applications. Additionally, many applications of the NAT are perfectly suited for monitoring of large portions of a structure using just a few sensors in fixed locations not requiring sensor spatial scanning. These advantages are the primary reasons for selecting NAT over competing techniques in some SHM applications.

### Section 4—AM/FM Separation Challenges and Solutions

Despite extensive research on Vibro-Acoustic Modulation (VAM) most of these research endeavors are still primarily laboratory experimentation since real structures have many contact-type structural nonlinearities that may produce a much higher level of modulation as compared to the damage-related nonlinearities.

Most of the reported VAM studies correlate flaw presence and its growth with the increase in the Modulation Index (MI) defined in the spectral domain as the ratio of the side-band spectral components at frequencies ω±Ω to the amplitude of the carrier frequency, ω. Here Ω is the modulating frequency (pumping frequency, Ω<<ω). This approach, however, does not distinguish between two kinds of modulation: frequency and amplitude modulation, FM and AM, respectively. The Hilbert Transform and its modifications are routinely used to extract the instantaneous amplitude and phase/frequency as representative of amplitude and frequency modulation where dominant amplitude modulation for visible cracks is reported. Separation of AM and FM components is necessary to take in effect the phases of sidebands in the response analysis. In response to the separation of AM and FM, it is hypothesized that damage accumulation, at earlier stages before formation of macro-cracks, may exhibit primarily frequency modulation due to changes in compliance of material in initial crack growth stages as compared to amplitude modulation from contact interfaces of clapping crack. This section is devoted to the demodulation of signal to its AM and FM components and challenges in this regard. It will be shown that Hilbert Transform is not capable of proper demodulation of the acquired signal in VAM application. Therefore, new AM/FM separation algorithms are presented here to overcome Hilbert Transform limitations.

### Section 4.1—Considerations in Utilizing AM/FM Separation Methods

To clarify the phase effect of sidebands on nonlinearity nature of output signal, a carrier signal as A cos(ωt+φ) and a pair of sidebands as A1 cos (ω+Ω)^{t+ϕ}^{₁} and A₂ cos((ω−Ω)t+ϕ₂) with arbitrary amplitudes and phases are assumed. ω and Ω are the carrier and modulating angular frequencies respectively. A, A1 and A2 are arbitrary amplitudes of the carrier and sidebands. φ, φ1 and φ2 are arbitrary phases of the carrier and sidebands. The symmetrical and antisymmetrical pair of sidebands would be interpreted as AM and FM signals. In this regard, phase of sidebands should be provided by some approaches since this information is not revealed in power spectrum.

The pair of sidebands is said to be symmetrical if A1=A2 and φ1−φ=−(φ2−φ), that is,

$$\frac{( {φ}_{1} + {φ}_{2} )}{2} = φ .$$

The superposition of a carrier and a pair of symmetrical sidebands gives a pure amplitude modulated signal, since

$$A cos ( ω t + φ ) + {A}_{1} cos ( ( ω + Ω ) t + {φ}_{1} ) + {A}_{1} cos ( ( ω - Ω ) t + 2 φ - {φ}_{1} ) = A cos ( ω t + φ ) + {A}_{1} cos [ ( ω t + φ ) + ( Ω t + {φ}_{1} - φ ] + {A}_{1} cos [ ( ω t + φ ) - ( Ω t + {φ}_{1} - φ ] = A [ 1 + 2 \frac{{A}_{1}}{A} cos ( ω t + {φ}_{1} - φ ) ] cos ( Ω t + φ ) = A [ 1 + 2 \frac{{A}_{1}}{A} cos ( ω t + ( \frac{{φ}_{1} - {φ}_{2}}{2} ) ] cos ( Ω t + φ ) \qquad ( 4.1 )$$

where

$$\frac{2 {A}_{1}}{A}$$

identifies the amplitude modulation index and

$${m}_{a} = \frac{{A}_{1}}{A}$$

is defined. The spectrum of an AM signal is shown in FIG. 4.1. Amplitude of both sidebands are the same whereas the phases of the two sidebands are opposite. Note that a pair of symmetrical sidebands gives rise to a component in-phase with the carrier.

On the other hand, the pair of sidebands is said to be antisymmetrical if A1=−A2

and φ1−φ=−(φ2−φ), that is,

$$\frac{{φ}_{1} + {φ}_{2}}{2} = φ .$$

By means of Bessel function expansion, it could be revealed that the superposition of a carrier and a pair of small antisymmetrical sidebands gives rise to an approximately pure frequency modulated signal. As a first step in this direction, the following expansion for frequency modulated signal will be performed:

$$A cos [ ( ω t + φ ) + 2 {m}_{f} sin ( Ω t + θ ) ] = A \{ cos ( ω t + φ ) cos [ 2 {m}_{f} sin ( Ω t + θ ) ] - sin ( ω t + φ ) sin [ 2 {m}_{f} sin ( Ω t + θ ) ] \} = A \{ cos ( ω t + φ ) [ {J}_{0} ( 2 {m}_{f} ) + 2 {J}_{2} ( 2 {m}_{f} ) cos ( 2 ( Ω t + θ ) ) + … ] - sin ( ω t + φ ) [ 2 {J}_{1} ( 2 {m}_{f} ) sin ( Ω t + θ ) + … ] \} = A cos ( ω t + φ ) - 2 {Am}_{f} sin ( ω t + φ ) sin ( Ω t + θ ) \qquad ( 4.2 )$$

where 2mf identifies frequency modulation index which is small in comparison with unity. Equation (4.2) is true when 2mf is small because the first order approximation of Bessel function would be in the form of

$${J}_{n} ( x ) = \frac{{x}^{n}}{{2}^{n} n !} .$$

Therefore, Bessel functions could be substituted with the following values:

$$\begin{matrix}J 0 ( 2 mf ) = 1 , J 1 ( 2 mf ) = mf , \\ J 2 ( 2 mf ) = 0 = J 3 ( 2 mf ) = J 4 ( 2 mf ) , and etc . , \\ cos ( x sin φ ) = {J}_{0} ( x ) + 2 {\sum }_{n = 1}^{∞} {J}_{2 n} ( x ) cos ( 2 n φ ) & ( 4.3 ) \\ sin ( x sin φ ) = 2 {\sum }_{n = 0}^{∞} {J}_{( 2 n + 1 )} ( x ) sin ( ( 2 n + 1 ) φ ) & ( 4.4 )\end{matrix}$$

For derivation of Equation (4.2), Equation (4.3) and Equation (4.4) are used. Now consider:

$$2 {Am}_{f} sin ( ω t + φ ) sin ( Ω t + θ ) = {Am}_{f} \{ cos [ ( ω - Ω ) t + ( φ - θ ) ] - cos [ ( ω + Ω ) t + ( φ + θ ) ] \} \qquad ( 4.5 )$$

By using Equation (4.5), Equation (4.2) becomes

$$A cos [ ( ω t + φ ) + 2 {m}_{f} sin ( Ω t + θ ) ] = A cos ( ω t + φ ) + {Am}_{f} cos [ ( ω + Ω ) t + ( φ + θ ) ] - {Am}_{f} cos [ ( ω - Ω ) t + ( φ + θ ) ] \qquad ( 4.6 )$$

provided that 2mf is small in comparison to unity. It could be concluded from Equation (4.6) and the assumption of φ1=φ+θ, φ2=φ−θ, A1=Amf, and A2=−Amf that the pair of sidebands is antisymmetrical since A1=−A2 and φ2=2φ−φ1, then

$$A cos ( ω t + φ ) + {A}_{1} cos [ ( ω + Ω ) t + {θ}_{1} ] - {A}_{1} cos [ ( ω - Ω ) t + ( 2 φ - {θ}_{1} ) ] = A cos \{ ( ω t + φ ) + \frac{2 {A}_{1}}{A} sin [ Ω t + ( {θ}_{1} - φ ) ] \} = A cos ( ω t + φ ) + \frac{2 {A}_{1}}{A} sin [ Ω t + ( \frac{{θ}_{1} - {θ}_{2}}{2} ) ] \qquad ( 4.7 )$$

Thus, the superposition of a carrier and a pair of small antisymmetrical sidebands gives rise to an approximately pure frequency modulated signal with modulation index equals to

$$\frac{2 {A}_{1}}{A} .$$

The spectrum of an FM signal is shown in FIG. 4.2. The power spectrum shows the same amplitude for the main sidebands; nevertheless, the phase angles are complementary to π. The frequency modulated spectrum displays, in theory, an infinite number of sidebands, however, in practice a finite number of sidebands can be observed since the amplitude of high-order sidebands is negligible. Only the first pair of sidebands are considered in the calculations due to their higher amplitudes compared to higher sidebands.

The presence of symmetrical or antisymmetrical sidebands interprets differently to AM or FM components whereas Fourier analysis of these sidebands results in the same power spectrum, thus there is much more information in a signal than provided by Fourier analysis. A result of categorizing symmetrical and antisymmetrical sidebands would be that any arbitrary unsymmetrical sideband distribution can be expressed as the sum of symmetrical and antisymmetrical pairs, i.e. AM and FM components.

There are relatively few historical studies in the area of Vibro-Acoustic Modulation in separation of modulated signals to its AM and FM components. Researchers have explored the time domain analysis of modulated acoustical responses. Hilbert and Hilbert-Huang transforms are used to obtain instantaneous frequency and amplitude of nonlinear acoustical responses. Such approaches, however, have failed to address: 1) frequency response function prior to analysis and 2) presence of non-modulated carrier in the output signal.

### Section 4.1.1—Frequency and Phase Response of Nonlinear System Under Test

To compensate for environmental and boundary condition responses in the installed sample system, frequency and phase responses should be measured and considered in the selection of high and low frequencies. The system under test, SUT, refers to a system that is being tested for correct operation; here, the sample checked for the damage existence. In particular, the analysis of modulated signal is more problematic when the low frequency is assumed a high value. This is explored by obtaining frequency and phase responses of a specimen under test. The frequency and phase responses of a specimen mounted in the testing machine is shown in FIG. 4.3 for the range of frequencies between 160 kHz and 180 kHz.

The high and low frequencies are assumed 165 kHz and 300 Hz respectively. As it is shown in the FIG. 4.3, there would be 4.5 dB and 0.1π difference in the amplitude and phase of sidebands that contribute to the output of the system. In separation of AM and FM components, phase of sidebands has a leading role in addition to their amplitudes since phase change result in wrong interpretation of modulated signal; so, the effect of phase response on the output of the system under test should be considered in selection of high and low frequencies.

The effect of the amplitude and phase frequency responses of the sample under test is investigated by modeling the carrier and sidebands. This is exemplified using an Amplitude Modulated signal with modulation index of 2ma:

mₙ cos((ω−Ω)t)+A cos(ωt)+mₐ cos(ω+ω)t) (4.8)

By modeling amplitude and phase frequency responses of the sample, as shown in FIG. 4.3, the sidebands amplitude and phases change as follows:

0.7 macos((ω−Ω)t+0.05π)+A cos(ωt)+1.3 macos((ω+Ω)t+0.05π) (4.9)

Hilbert Transform will be explained for separation of AM and FM components of signal in details in section 4.1.2. Hilbert Transform is used here to illustrate the changes of separation results due to amplitude and phase frequency responses of sample. AM and FM components obtained from HT show wrong presence of FM component as illustrated in FIG. 4.4.

The distortion of output signal could be modified by selecting a flat range of frequency and phase responses of system. Since finding a flat area in both frequency and phase responses is challenging, there are two approaches undertaken to minimize the initial condition of sample effect on the output signal. One approach is modifying the output signal by using an inverse filter. The theory states that any Linear Time-Invariant (LTI) system can be described by its frequency response function in frequency domain or by its impulse response in time domain. In presence of nonlinearities, the linear be defined using a nonlinear model. An identification process based on the analysis of the output signal of the system under test when exciting the system by a controlled input signal has to be done. For this purpose, a swept-sine signal s(t) could be introduced to the system under test and the distorted output of system y(t) recorded to be used for nonlinear convolution. The signal s^{˜}(t) is derived from the input signal s(t) as its time-reversed replica with amplitude modulation such that the convolution between s(t) and s^{˜}(t) gives a Dirac delta function δ(t). The signal s^{˜}(t) is called inverse filter. Then, the convolution between the output signal y(t) and the inverse filter s^{˜}(t) is performed to gain modified output.

The other approach to overcome amplitude and phase frequency response problem is selecting a very small low frequency. When the low frequency is selected as a very small value, the frequencies of carrier signal and sidebands are very close to each other and there would be negligible amplitude and phase distortions of modulating frequencies. In this section, the high frequency is selected in a flat area of frequency response to avoid amplitude distortions of modulated signal especially in sidebands. In addition, a very small low frequency, 10 Hz, is used to overcome the effect of phase response of tested specimen on the output signal. It is evident that phases of carrier and sidebands have slight negligible changes. 10 Hz is used as low frequency in fatigue experiments as both cycling load frequency and modulating frequency.

### Section 4.1.2—Non-Modulated Carrier

The classical theory of modulation involves two possible modulation processes, namely amplitude and angular modulation. In theory, angular modulation involves phase and frequency modulations. For simplicity, frequency modulation in angular modulation category was analyzed.

The amplitude modulated signal can be expressed as Equation (4.10).

xₐ(t)=A(1+2mₐ cos(Ωt+θₐ))cos(ωt) (4.10)

where 2ma represents the amplitude modulation index and A is the amplitude of signal. The ω and Ω are the frequencies of carrier and modulating signals respectively. θ is the arbitrary phase of the modulating signal.

The frequency modulated signal can be represented as Equation (4.11).

x_{f}(t)=A cos(ωt+2m_{f} sin(Ωt+θ_{f})) (4.11)

where mf is the frequency modulation index and A is the amplitude of signal. The ω and

Ω are the frequencies of carrier and modulating signals, respectively.

Hilbert transform (HT) can be used for signal demodulation to obtain the instantaneous modulation characteristics consisting of instantaneous amplitude (or envelope function) and the instantaneous frequency for narrow-band (monocomponent) signals. The instantaneous amplitude and frequency reveal whether amplitude and/or frequency modulation are present in the signal. For any narrowband signal x(t), the HT can be defined as Equation (4.12).

$$H [ x ( t ) ] = \hat{x} ( t ) = \frac{1}{π} p . v . {\int }_{- ∞}^{∞} \frac{x ( τ )}{t - τ} d τ \qquad ( 4.12 )$$

where p.v. is the Cauchy principal value. The original signal x(t) and its HT, f(t) can be used to obtain the analytic signal defined as

z(t)=x(t)+jx\hat{ }(t)=A(t)e^{jφ(t)} (4.13)

where A(t) and φ(t) are the envelope and instantaneous phase given as

$$\begin{matrix}A ( t ) = sq . root ( x 2 ( t ) + {x}^{⋀} 2 ( t ) ) & ( 4.14 ) \\ \overline{φ ( t ) = arctan} \frac{\hat{x} ( t )}{x ( t )} & ( 4.15 ) \\ f ( t ) = \frac{1}{2 π} \frac{d φ ( t )}{dt} & ( 4.16 )\end{matrix}$$

The instantaneous amplitude, representing the amplitude modulation, and the instantaneous frequency, representing the frequency modulation index, in a modulated signal, can be obtained using Equations (4.13) and (4.16). The Fourier transforms of instantaneous amplitude and frequency are used to represent the results of HT. The amplitude of Fourier spectrum of instantaneous amplitude and frequency in the first harmonic of modulating frequency has been calibrated to express Modulation Index. Instantaneous amplitude and frequency spectral which represent AM and FM components of pure amplitude and pure frequency modulated signals are shown in FIG. 4.5. The high and low frequencies are 165 kHz and 300 Hz respectively. 2ma and 2mf are 0.1. FIGS. 4.5(a) and 4.5(b) show the AM and FM components of pure amplitude modulated signal. The pure amplitude modulated signal contains only AM component; therefore, FM component of this signal equals to zero as shown in FIG. 4.5(b). On the other hand, the pure frequency modulated signal contains only FM component depicted in FIG. 4.5(d) and the AM component equals to zero as illustrated in FIG. 4.5(d). The pure amplitude modulated signal reflects only AM component and pure frequency modulated signal reflects only FM component.

To investigate the realistic state in mounted sample, pure amplitude and pure frequency modulated signals have been studied as two different scenarios. The realistic scenario in the specimen under test involves presence of additional nonmodulated carrier to modulated signal. The nonlinear modulation process occurs when a crack or defect happens in the sample. The modulated signal arises from nonlinear interaction of carrier and modulating signals in presence of micro/mesoscale damage. In addition to the modulated signal, the non-modulated carrier finds its path to the receiver transducer from the undamaged part of the structure as shown in FIG. 4.6; therefore, the pure AM or FM signals are contaminated by a non-modulated carrier with an arbitrary phase. Indeed, multi-path propagation happens in the sample; the carrier signal travels from both defected and non-defected areas of the sample, the latter one called non-modulated carrier only contributes to the amplitude and phase of received carrier signal. This summation of modulated and non-modulated carriers results in wrong interpretation of modulated signal since the Hilbert Transform and other conventional methods of AM/FM demodulation do not distinguish between these two carrier types and assume the superposed amplitude and phase of carrier signal as the modulated carrier properties.

The addition of non-modulated carrier to amplitude and frequency modulated signals can be expressed as

xₐ(t)=Aₘ(1+2mₐ cos(Ωt+θₐ))cos(ωt+ϕₘ)+Aₙₘ cos(ωt+ϕₙₘ) (4.17)

x_{f}(t)Aₘ cos(ωt+2m_{f} sin(Ωt+θ_{f})+ϕₘ)+Aₙₘ cos(ωt+ϕnm) (4.18)

where Am and φm are amplitude and phase of carrier involved in modulation and

Anm and φnm are amplitude and phase of non-modulated carrier. Am=Anm=1, ϕ=0,

$${φ}_{n m} = \frac{π}{2} ,$$

and θa=θf=0 are assumed.

As shown in FIG. 4.7, the Hilbert Transform does not work properly when an additional non-modulated carrier is present in signal. In fact, additional non-modulated carrier signal which appears at the output of the system should not affect the modulation nature of signal while the superposition of modulated and non-modulated carrier affects the output of HT. The simulated pure amplitude modulated signal with additional non-modulated carrier should have AM and FM components equal to 0.1 and 0 because of its nature which was shown in FIGS. 4.5(a) and 4.5(b) while the HT erroneous interpretation of this signal due to the presence of nonmodulated carrier results in clearly incorrect values of both AM and FM components as shown in FIGS. 4.7(a) and 4.7(b). The HT interpretation of pure frequency modulated signal contains similar incorrect AM and FM components as shown in FIGS. 4.7(c) and 4.7(d).

### Section 4.2—In-Phase/Quadrature Homodyne Separation Algorithm (IQHS)

It is shown that the superposition of a carrier and a pair of antisymmetrical sidebands gives rise to an approximately pure frequency modulated signal and superposition of a carrier and a pair of symmetrical sidebands gives rise to an approximately pure amplitude modulated signal. Therefore, if the sidebands of acquired signal are decomposed to a pair of symmetrical and antisymmetrical sidebands, it will illustrate AM and FM components of the output signal. The demodulation of a modulated signal to AM and FM components based on separation of sidebands to symmetrical and antisymmetrial sidebands could be accomplished by multiplication of modulated signal with its in-phase carrier at modulation phase and quadrature carrier at 90. phase shift of modulation phase as explained mathematically in detail in Supplement A. In order to address the multipath-mixing problem, a new algorithm has been developed and tested both numerically and experimentally. This algorithm utilizes AM and FM reconstruction based on phases and amplitudes of the modulated signal spectral components, FIG. 4.8.

An acquired modulated signal contains two unsymmetrical sidebands with random amplitudes, B1 and B2, and phases, θ1 and θ2, (Expressions (4.19) and (4.20)) and a superposed carrier signal containing both a modulated carrier, involved in the modulation process, and a non-modulated carrier, not involved in the modulation process and only contributes to the amplitude, A, and phase, φ of the superposed carrier (Expression (4.21)).

B₁ cos((ω+Ω)t+θ₁) (4.19)

B₂ cos((ω−Ω)t+θ₂) (4.20)

A cos(ωt+ϕ) (4.21)

It can be seen in Equation (4.22) that the carrier signal consists of two parts related to modulated carrier involved in modulation process with amplitude of Am and modulation phase of φm and non-modulated carrier with amplitude of Anm and phase of φnm received by the experimental setup as a result of the carrier passing through the intact parts of the sample.

A cos(ωt+φ)=Aₘ cos(ωt+φₘ)+Aₙₘ cos(ωt+ϕₙₘ) (4.22)

where Am and φm are amplitude and phase of the modulated carrier and Anm and ϕnm are amplitude and phase of the non-modulated carrier. The acquired signal contains carrier and sidebands components expressed in Expressions (4.19), (4.20), and (4.21).

B₂ cos((ω+Ω)t+θ₂)+Aₘ cos(ωt+ϕₘ)B₁ cos((ω+Ω)t+θ₁)+Aₙₘ cos(ωt+ϕₙₘ) (4.23)

By multiplying the acquired signal by cos(ωt+φm), the in-phase carrier, the following components are obtained.

$$\frac{{B}_{2}}{2} cos ( ( 2 ω - Ω ) t + {ω}_{m} + {θ}_{2} ) + \frac{{B}_{2}}{2} cos ( ω t - {θ}_{2} + {φ}_{m} ) + \frac{{A}_{m}}{2} + \frac{{A}_{m}}{2} cos ( 2 ω t + 2 {φ}_{m} ) + \frac{{B}_{1}}{2} cos ( ( 2 ω + Ω ) t + {φ}_{m} + {θ}_{1} ) + \frac{{B}_{1}}{2} cos ( Ω t + {θ}_{1} - {φ}_{m} ) + \frac{{A}_{n m}}{2} cos ( {φ}_{m} - {φ}_{n m} ) + \frac{{A}_{n m}}{2} cos ( 2 ω t + {φ}_{m} + {φ}_{n m} ) \qquad ( 4.24 )$$

The high frequency components of the signal could be filtered by a low-pass filter with the cut-off frequency above Ω. A low-pass filter (LPF) is a filter that passes signal with a frequency lower than a selected cut-off frequency and attenuates signals with frequencies higher that the cut-off frequency. The remaining part is detrended (DC component is removed). Deterending is removing a trend from a time series, here the DC component. When describing a periodic function in the time domain, the DC component is the mean amplitude of the waveform. The outcome of this low-pass filtering and detrending process is shown in Equation (4.25).

$$\frac{{B}_{2}}{2} cos ( Ω t - {θ}_{2} + {φ}_{m} ) + \frac{{B}_{1}}{2} cos ( Ω t + {θ}_{1} - {φ}_{m} ) \qquad ( 4.25 )$$

Then the signal in Equation (4.25) is squared:

$${[ \frac{{B}_{2}}{2} cos ( Ω t - {θ}_{2} + {φ}_{m} ) + \frac{{B}_{1}}{2} cos ( Ω t + {θ}_{1} - {φ}_{m} ) ]}^{2} = \frac{{B}_{2}^{2}}{8} + \frac{{B}_{2}^{2}}{8} cos ( 2 Ω t - 2 {θ}_{2} + 2 {φ}_{m} ) + \frac{{B}_{1}^{2}}{8} + \frac{{B}_{1}^{2}}{8} cos ( 2 Ω t + 2 {θ}_{1} - 2 {φ}_{m} ) + \frac{{B}_{1} {B}_{2}}{4} cos ( 2 Ω t + {θ}_{1} + {θ}_{2} ) + \frac{{B}_{1} {B}_{2}}{4} cos ( {θ}_{2} + {θ}_{1} - 2 {φ}_{m} ) \qquad ( 4.26 )$$

Finally, the only DC component of the signal is measured:

$$D {C}_{co s} = \frac{{B}_{2}^{2}}{8} + \frac{{B}_{1}^{2}}{8} + \frac{{B}_{1} {B}_{2}}{4} cos ( {θ}_{2} + {θ}_{1} - 2 {φ}_{m} ) \qquad ( 4.27 )$$

The MA is defined:

MA=p2DC cos (4.28)

MA represents the Amplitude Modulation index (AM component) as a pair of symmetrical sidebands.

The same algorithm can be used to calculate FM component of the signal. In order to find MF representing the Frequency Modulation index (FM component), the signal as defined in Equation (4.23) should be multiplied by sin(ωt+φm) at the first step. This sin(ωt+φm) is the quadrature of carrier signal which also could be expressed as cos(ωt+φm+π):

$$\frac{{B}_{2}}{2} sin ( ( 2 ω - Ω ) t + {θ}_{2} + {φ}_{m} ) + \frac{{B}_{2}}{2} sin ( Ω t - {θ}_{2} + {φ}_{m} ) + \frac{{A}_{m}}{2} sin ( 2 ω t + 2 {φ}_{m} ) + \frac{{B}_{1}}{2} sin ( ( 2 ω + Ω ) t + {θ}_{1} + {φ}_{m} ) - \frac{{B}_{1}}{2} sin ( Ω t + {θ}_{1} - {φ}_{m} ) + \frac{{A}_{n m}}{2} sin ( 2 ω t + {φ}_{m} + {φ}_{n m} ) + \frac{{A}_{n m}}{2} sin ( {φ}_{m} - {φ}_{n m} ) \qquad ( 4.29 )$$

The high frequency components of signal are filtered out by a low-pass filter with the cut-off frequency above Ω and then the signal is detrended.

$$\frac{{B}_{2}}{2} sin ( Ω t - {θ}_{2} + {φ}_{m} ) - \frac{{B}_{1}}{2} sin ( Ω t + {θ}_{1} - {φ}_{m} ) \qquad ( 4.30 )$$

The signal in Equation (4.30) is squared.

$${[ \frac{{B}_{2}}{2} sin ( Ω t - {θ}_{2} + {φ}_{m} ) - \frac{{B}_{1}}{2} sin ( Ω t + {θ}_{1} - {φ}_{m} ) ]}^{2} = \frac{{B}_{2}^{2}}{8} - \frac{{B}_{2}^{2}}{8} cos ( 2 Ω t - 2 {θ}_{2} + 2 {φ}_{m} ) + \frac{{B}_{1}^{2}}{8} - \frac{{B}_{1}^{2}}{8} cos ( 2 Ω t + 2 {θ}_{1} - 2 {φ}_{m} ) + \frac{{B}_{1} {B}_{2}}{4} cos ( 2 Ω t + {θ}_{1} - {θ}_{2} ) - \frac{{B}_{1} {B}_{2}}{4} cos ( {θ}_{2} + {θ}_{1} - 2 {φ}_{m} ) \qquad ( 4.31 )$$

The DC component of the signal is measured as follows:

$$D {C}_{si n} = \frac{{B}_{2}^{2}}{8} + \frac{{B}_{1}^{2}}{8} - \frac{{B}_{1} {B}_{2}}{4} cos ( {θ}_{2} + {θ}_{1} - 2 {φ}_{m} ) \qquad ( 4.32 )$$

The MF is defined by

MF=p2DC sin (4.33)

The schematic steps of In-phase/Quadrature Homodyne Separation (IQHS) algorithm are shown in FIG. 4.9. The IQHS algorithm is capable of demodulating the modulated signal to its AM and FM components by using the symmetrical and antisymmetrical sidebands properties. In the experimental process, the cycling loading frequency is used as the modulating frequency, Ω. The System Under Test (SUT) is the mounted sample to investigate damage evolution during fatigue loading. The carrier signal generated in the F-scan LABVIEW software is amplified in the first step. The reason for this amplification is that the transducers generally require an external power supply and some form of additional amplification or filtering of the signal in order to produce a suitable electrical signal which is capable of being measured or used. The amplified high voltage is introduced to the SUT and is modulated due to interaction with modulating signal, low frequency signal. This signal is received by another transducer and filtered in the applicable frequency range of the specific transducer, here is 120 kHz to 220 kHz. This modulated signal would be recorded and used as the input of the post processing IQHS algorithm. The other component of this algorithm is the carrier signal to be used for multiplication by the acquired signal. The practical usage of the proposed algorithm is accomplished by using a reference signal instead of cos(ωt+φm) and sin(ωt+φm). The reference signal is obtained by sending the high frequency signal to transducer attached on the sample and receiving the response signal by F-scan software. This reference signal is recorded at the beginning of each test and is normalized to have unit amplitude to compensate for its amplitude effect on the Modulation Index results. The next step is making the acquired and reference signals in-phase by solving the time delay in receiving signals. The quadrature reference signal is obtained by

$$\frac{π}{2}$$

shift of the signal phase. The AM and FM components are obtained from multiplication of the modulated signal by the in-phase carrier and quadrature carrier respectively after completing the IQHS algorithm steps containing LPF, detrending, squaring and measuring DC component.

### Section 4.3—Sweeping-Phase Homodyne Separation Algorithm (SPHS)

The IQHS algorithm works based on known modulation phase, φm. HT cannot detect this phase as it cannot distinguish between modulated and non-modulated carrier while IQHS algorithm is capable of recognizing the modulated carrier in presence of non-modulated carrier. The IQHS result is valid whenever the phase changes are negligible. It could be assumed that phase change is a very small number because of a small size of the tested samples and high speed of sound in steel. The IQHS algorithm as explained before works based on the multiplication of acquired modulated signal and background carrier signal in time domain. In order to practically use of this method in larger samples, the Sweeping-Phase Homodyne Separation (SPHS) algorithm has been developed.

Finding phase of a modulated carrier, modulation phase (φm), contaminated with a non-modulated carrier is problematic. Therefore, a sweeping phase approach to finding the DC components representing AM and FM components instead of applying IQHS can be used. In the sweeping-phase homodyne separation (SPHS) algorithm, the reference signal is assumed to be a sweeping-phase signal which sweeps over sampling points of reference signal and generates a phase shifted reference signal. The result of DC component is expressed in relation to the sweeping modulation phase (φs). Mi represents the result of ith step of SPHS. Mi which is sweeping modulation index equals to MA and MF in its extreme values. The extreme values of DC components occur at the in-phase and quadrature references since the modulation phase is present in the sideband phases. Furthermore, when in-phase value of Mi (sweeping modulation index) with respect to sweeping modulation phase happens, the sweeping modulation phase (cos) represents the valid modulation phase (φm). In fact, this acquired phase is the phase of modulated carrier which is involved in the modulation process that is differentiated from phase of nonmodulated carrier.

For better understanding of the extraction of modulation phase and AM and FM components, a pure Amplitude Modulated (AM) signal with additional non-modulated carrier is assumed:

xₐ(t)=A(1+2mₐ cos(Ωt+θₐ))cos(ωt+ϕₘ)+Aₙₘ cos(ωt+ϕₙₘ) (4.34)

Expanding the above expression gives:

xₐ(t)=Amₐ cos((ω−Ω)t+ϕₘ−θₐ)+A cos(ωt+ϕₘ)+Amₐ cos(((ω+Ω)t+ϕₘ+θₐ)+Aₙₘ cos(ωt+ϕₙₘ) (4.35)

Using SPHS, the signal is multiplied by a sweeping-phase reference cos(ωt+φs) in which Cps is between 0 and 27. It is discussed in 4.2 that the Amplitude Modulation index, AM component, can be measured based on DC cos using Equation (4.27). Substituting amplitudes and phases of sidebands by corresponding values obtained from Equation (4.35), B1=B2=Ama, θ1=φm+θa, and θ2=φm−θa results in DC component as seen in Equation (4.36).

$$D C = \frac{{A}^{2} {m}_{a}^{2}}{8} + \frac{{A}^{2} {m}_{a}^{2}}{8} + \frac{{A}^{2} {m}_{a}^{2}}{4} cos ( 2 {φ}_{m} - 2 {φ}_{s} ) \qquad ( 4.36 )$$

In this modeled example, the modulation phase, φm, is assumed zero. DC components are reaching their extreme values when the cos(2φm−2φs) is equal to ±1. In other words, the maximum and minimum of DC components occur when 2 φm−2φs=0 and 2 φm−2φs=π. The first case is corresponding to DC cos and the second case is corresponding to DC sin. The DC component obtained from DC cos corresponding to in-phase modulated carrier reflects the modulation phase, φm. The modulation phase could be obtained from 2 φm−2φs=0. FIG. 4.10 represents the MI graph with respect to the sweeping modulation phase (φs). The maximum and minimum of the MI graph is related to AM and FM components, respectively. Also, the corresponding phase of DC cos expresses the modulation phase (φm). By using this approach, φm, MA and MF, modulation phase and AM and FM components, are measured by detecting extreme values of the sweeping modulation index (Mi) using Equations (4.28) and (4.33):

MA=ama,MF=0,φm=0

In another example, a pure Frequency Modulated (FM) signal with additional non-modulated carrier is assumed:

xf(t)=A cos(ωt+2mf sin(Ωt+θf)+φm)+Anm cos(ωt+φnm)

where 2mf is the frequency modulation index. By expanding the above expression and considering only the first pair of sidebands:

x_{f}(t)=Am_{f} cos[(ω+Ω)t+(ϕₘ+θ_{f})] (4.37)

+A cos(ωt+ϕₘ) (4.38)

−Am_{f} cos[(ω−Ω)t+(ϕₘ−θ_{f})]+Aₙₘ cos(ωt+ϕₙₘ) (4.39)

Again, in the modeled pure frequency modulated signal, the modulation phase is assumed as zero but for generalization, it is shown by φm in measurements. By using SPHS and multiplying by sweeping-phase reference signal, the DC component is measured based on Equation (4.27) and assuming, B1=Amf, B2=−Amf, θ1=φm+θf, and θ2=φm−θf:

$$D C = \frac{{A}^{2} {m}_{f}^{2}}{8} + \frac{{A}^{2} {m}_{f}^{2}}{8} + \frac{{A}^{2} {m}_{f}^{2}}{4} cos ( 2 {φ}_{m} - 2 {φ}_{s} ) \qquad ( 4.40 )$$

The minimum and maximum of DC components appear at 2φm−2φs=0 and 2φm−2φs=π as shown in FIG. 4.11. In this case, the minimum is related to the in-phase carrier signal obtained from DC cos. The modulation phase, φm, is always obtained from the in-phase carrier signal corresponding to DC cos component. Accordingly, the modulation phase and AM and FM components can be determined from the graph as:

MA=0,MF=amf,φm=0

FIGS. 4.10 and 4.11 illustrate the sweeping modulation phase (Mi) with respect to sweeping modulation phase (φs) for the two modeled examples, pure amplitude modulated and pure frequency modulated signals. AM and FM components are gained from in-phase and quadrature modulated carrier instead of arbitrary superposed carrier of modulated and nonmodualted carrier. The modulation phase is always measured based on in-phase modulated carrier obtained from DC cos component. The AM and FM components of these two modeled examples are different but the modulation phase corresponding to in-phase modulated carrier of Mi (MA) is identical since φm is assumed zero in both cases.

The SPHS algorithm as shown in FIG. 4.12 concludes multiple implementations of IQHS with phase shift of carrier signal to the next sampling point which results in sweeping phase of carrier signal. The precision of this approach is improved by increasing sampling points. While the sampling rate of used data acquisition board is 2 MS/s, the sampling point increased 5 times to 10 MS/s in which data points between original sampling points are added by means of interpolation. Using this modification, SPHS could be used to separate modulated signal to its valid AM and FM components. In addition, one important feature of the SPHS algorithm is that it can detect the phase of modulated carrier, which is involved in the modulation process, called modulation phase (φm in Equation (4.23)). The flowchart of SPHS algorithm is shown in FIG. 4.12.

In this process, the modulated signal received from system under test is multiplied by the background carrier signal, reference signal. Prior to this multiplication the sampling rate of acquired signals are increased in order to improve the precision of computations. After applying IQHS algorithm on this signals, MI, AM and FM components are recorded. Then the recurring algorithm continues the same process by shifting the reference signal to the next sampling point. After completion of this recurring algorithm, the graph of MIs is depicted and the modulation phase (φm) and the valid AM and FM components corresponding to this phase are measured.

The following enhancements to the SPHS algorithm led to a robust method to detect the modulation phase. The processed results of samples under fatigue experiment showed a correlation between modulation phase and the fatigue crack growth. The mentioned phase is changing continuously when a fatigue crack is forming; however, it is almost constant prior to formation of defects in the tested sample. These results are presented in the following chapter (i.e., Section 5).

### Section 4.4—Enhancement in Precision of IQHS and SPHS

The IQHS and SPHS algorithms are based on multiplication of received modulated signal and carrier signal. The received modulated signal multiplication by the in-phase, cos(ωt), and quadrature, sin(ωt), carrier signals produce AM and FM spectral component amplitudes in IQHS. The extreme values of modulation index with reference to initial phase of carrier signal represents AM and FM components in SPHS. There are different steps which could enhance the SPHS efficiency as discussed below: a) resampling the received modulated and carrier signals, b) low pass filter design, c) sample time optimization, d) averaging modulation indices.

### Section 4.4.1—Resampling the Received Signals

The signals are received by National Instrument USB-6361 data acquisition board. This board can acquire signals with 2 MS/s sample rate for all channels. The received signals have 2 MHz sampling rate since only one channel is involved in signal acquisition. The multiplication process of received signal and carrier signal is performed in time domain; therefore, a higher sampling rate could improve precision of the IQHS algorithm. To tackle the limitation of board sampling rate, the signals could be resampled using interpolation of received signals. “Interp” as an inhouse MATLAB function is used to resample the acquired signals. The algorithm of this function is briefly explained in Supplement B. As it is shown in FIG. 4.13, the higher sampling rate results in smoother signal waves.

The precision of IQHS and SPHS algorithms is increased using smoother waveforms since these algorithms are implemented in time domain. In signal multiplication step, the higher sampling rate results in a very close to match in-phase and quadrature multiplications. To clear the sampling rate effect on the IQHS and SPHS algorithms, a pure amplitude modulated (AM) signal is generated and saved as .wav format in MATLAB then the generated signal is processed by two sampling rates: a) the generated sampling rate of 2 MHz and b) the resampled signals with a factor of 5 which results in 10 MHz sampled signals.

AM is generated based on Equation (4.41) where ma=0.01, Am=0.5, φm=1, Anm=0.2 and φnm=φ/2 are assumed. As it is shown in FIG. 4.14, the sweeping result with higher resampled signals is smoother and shows the correct result related to FM component of the signal.

xn(t)=Am(1+2 macos Ωt)cos(ωt+ωm)+Anm cos(ωt+φnm) (4.41)

### Section 4.4.2—Low Pass Filter

The IQHS and SPHS algorithms are extracted from the first pair of sidebands of modulated signals. If the received modulated signal contains only AM component, the low pass filter design will not play a significant role in signal processing due to presence of only one pair of sidebands. When the modulated signal contains an FM component, especially a high level of FM, in addition to AM component, the amplitudes of higher sidebands are increased and this increase can lead to wrong interpretation in AM/FM separation process. So, the low pass filter should be designed not only to eliminate carrier frequency after homodyning modulated signal by multiplying with in-phase and quadrature carrier signals but also to eliminate the higher sidebands effect.

To see the effect of higher sidebands with a high level of FM component, a combination of AM and FM signal is generated according to Equation (4.42) where ma=0.02, mf=0.04, Am=0.5, φm=1, Anm=1 and φnm=π/2. The processed result without filtering higher sidebands shows wrong equal AM and FM values as shown in FIG. 4.15 while the mf should be twice of ma. After proper use of low pass filter, the correct result is depicted in FIG. 4.16.

xn(t)=Am(1+2 macos Ωt)cos(ωt+2mf sin(Ωt+φm)+Anm cos(ωt+φnm) (4.42)

The low vibration fatigue frequency is 10 Hz in the series of experiments which makes it hard to design a low pass filter to eliminate higher sidebands without affecting the first pair of sidebands. After trying different types of low-pass filters and adjusting the filter design, a low pass infinite impulse response (IIR) filter is adopted in MATLAB to remove higher sidebands and carrier frequency. The specification of this filter is explained in Supplement B. The processing result is completely compatible with generated modulated signal by using low pass filter.

### Section 4.4.3—Sample Time Optimization

Another parameter which affects the processing result is signal length. Different processing procedures revealed that short length signal acquisition and processing will affect the final results. The duration of acquired signal should be kept at least double of sampling rate for proper work of designed filter.

### Section 4.4.4—Averaging Modulation Indices

Another improvement which can be made to the processing program is related to sampling the results over different segments of the received signals. The precision of AM/FM components is increased by averaging of the processing results over several segments of signal.

### Section 4.5—Modeled Signal for Comparison of SPHS and HT

Hilbert Transform is used for separation of AM and FM components in VAM method. This section is devoted to comparison between efficiency of HT and SPHS in separation of AM and FM component during fatigue experiment. In the study of VAM method in a fatigue experiment, different scenarios might happen. The output modulated signal based on what happens in the real structure could be in a form of pure amplitude modulated signal, pure frequency modulated signal or a combination of both. To clarify the efficiency of SPHS algorithm compared to HT in interpretation of fatigue test results, the modeling of some realistic cases is needed before moving on to the experiments; therefore, SPHS and HT results are compared in both presence and absence of additional non-modulated carrier for three different modulation scenarios: a) pure amplitude modulated signal, b) pure frequency modulated signal, and c) a combination of amplitude and frequency modulated signals. In all cases, carrier signal, ω, and modulating signal, Ω, are assumed 165 kHz and 300 kHz.

### Section 4.5.1—Pure Amplitude Modulated Signal

Pure amplitude modulated signal is assumed as x(t)=(1+2 macos Ωt)cos ωt (4.43)

where ma is assumed 0.1. The power spectrum of this signal is shown in FIG. 4.17. The sidebands are completely symmetrical and only the first pair of sidebands appears in the AM signal.

The pure amplitude modulated signal is processed with both SPHS and HT methods. The AM and FM separated components obtained by both approaches are shown in FIG. 4.18. FIGS. 4.18(a) and 4.18(b) show the AM and FM components as a result of demodulating signal by Hilbert Transform. The AM and FM components measured from SPHS algorithm are shown in FIGS. 4.18(c) and 4.18(d). Since there is no additional non-modulated carrier in this signal; therefore, the HT and SPHS show the correct nature of the modulated signal. Indeed, results of both methods are identical.

### Section 4.5.2—Amplitude Modulated Signal with Additional Non-Modulated Carrier

The pure amplitude modulated signal expressed in Equation (4.43) is contaminated by an extra non-modulated carrier which is not involved in the modulation process and received in the output of SUT. The amplitude and phase of this additional carrier is assumed as 1 and π/2.

$$x ( t ) = ( 1 + 2 {m}_{a} cos Ω t ) cos ω t + cos ( ω t + \frac{π}{2} ) \qquad ( 4.44 )$$

ma is assumed 0.1 in Equation (4.44). The power spectrum of this signal is shown in FIG. 4.19. The amplitude of carrier is higher than the case in subsection 4.5.1 because of presence of the non-modulated carrier while the amplitudes of the sidebands are identical. The additional non-modulated carrier contributes to the amplitude and phase of received carrier signal; therefore, the received carrier signal is a superposition of the modulated carrier, involved in the modulation process traveling through the defect area, and the non-modulated carrier which is not involved in the modulation process and travels through non-defected area of sample.

The amplitude modulated signal with additional non-modulated carrier is processed with both SPHS and HT methods and the AM/FM separation results are depicted in FIG. 4.20. The AM component of this signal should be equal to 0.1 since ma is assumed 0.1 and the FM component should be equal to 0 since there is no frequency modulation, mf, in the pure amplitude modulated signal. The AM and FM components measured by HT are shown in FIGS. 4.20(a) and 4.20(b). Both AM and FM results of HT demodulation show erroneous values while the AM and FM components obtained from SPHS correct represent the signal. If this scenario happens in the real structure then using HT would not lead to correct identification of AM and FM components.

### Section 4.5.3—Pure Frequency Modulated Signal

The other case which might happen in the output of an experiment is the modulated signal in a form of pure frequency modulated signal. Pure frequency modulated signal is defined by Equation (4.45) in which the frequency of a carrier signal is modulated by a sinusoidal function.

x(t)=cos(ωσt+2mf sin Ωt) (4.45)

Frequency modulation index, mf, is assumed 0.1 for simulation purposes. While frequency modulation index, mf is equal to the previous assumed amplitude modulation index, ma, in 4.5.1 and 4.5.2, the modulation establish in different forms at the output modulated signal. In pure frequency modulated signal, the amplitude is constant and the frequency is varying according to the modulation index, whereas in the pure amplitude modulated signal, the frequency is constant and the amplitude is varying. The power spectrum of the pure modulated signal is shown in FIG. 4.21. While only the first pair of sidebands appears in the pure amplitude modulated signal, the higher sidebands appear in this case. The sidebands are completely symmetrical in power spectrum but phase angles of sidebands are different than pure amplitude modulated signal. In contrast to opposite phase angles of first sidebands in pure amplitude modulated signal, the phase angles of main sidebands are each complementary to π in frequency modulated signal.

The pure frequency modulated signal is processed with both SPHS and HT methods. FIGS. 4.22(a) and 4.22(b) illustrates the AM/FM separation results of HT and FIGS. 4.22(c) and 4.22(d) indicated the AM/FM separation results of SPHS. The AM and FM components obtained by SPHS are compatible with results of HT as shown in FIG. 4.22 because there is no additional carrier.

### Section 4.5.4—Frequency Modulated Signal with Additional Non-Modulated Carrier

To investigate a more realistic scenario, the pure frequency modulated signal expressed in Equation (4.45) is contaminated by an extra non-modulated carrier which is not involved in the modulation process and received in the output of system. The amplitude and phase of this additional carrier is assumed as 1 and 2.

$$x ( t ) = cos ( ω t + 2 {m}_{f} sin Ω t ) + cos ( ω t + \frac{π}{2} ) \qquad ( 4.46 )$$

mf is assumed 0.1 in Equation (4.46). The power spectrum of the signal is shown in FIG. 4.23. The amplitude of carrier is higher than the case in section 4.5.3 because of non-modulated carrier while the amplitudes of sidebands are identical. The presence of non-modulated carrier contributes to the amplitude and phase of carrier signal and results in a superposed carrier signal of both modulated and non-modulated carrier signals.

The frequency modulated signal with additional non-modulated carrier is processed with both SPHS and HT methods. The AM and FM components of this signal analyzed by HT are shown in FIGS. 4.24(a) and 4.24(b), respectively and the AM and FM components obtained by SPHS processing are illustrated in FIGS. 4.24(c) and 4.24(d) respectively. The pure frequency modulated should not show any sign of AM component while the HT results show incorrect AM component in addition to erroneous FM component. On the other hand, SPHS algorithm is completely capable of interpreting the true nature of this signal and the obtained AM and FM values are 0 and 0.1 respectively as expected. The MI obtained by SPHS represents the true nature of signal while HT is not capable of demodulating the signal to its AM and FM components as shown in FIG. 4.24.

### Section 4.5.5—Combination of Amplitude and Frequency Modulated Signals

The AM/FM separation results of pure amplitude and frequency signals with and without additional non-modulated carrier obtained by both HT and SPHS approaches. A more realistic scenario which happens in the SUT consists of both amplitude and frequency modulated signals. The multiplication of AM and FM shown in Equation (4.47) is assumed as a combination of amplitude and frequency signals.

x(t)=(1+2 macosΩt)cos(ωt+2mf sin Ωt) (4.47)

Amplitude modulation index, ma, and Frequency modulation index, mf, are assumed 0.1 and 0.02 for the simulations. The power spectrum of the signal is shown in FIG. 4.25. It was mentioned before that pure amplitude modulated signal has symmetrical sidebands and pure frequency modulated signals has antisymmetrical sidebands. The sidebands of a combination of pure AM and FM signals have different amplitude and phases; therefore, the sidebands are unsymmetrical even in the power spectrum. Also, the phase angles of the sidebands especially the main sidebands which is involved in the SPHS processing are dissimilar.

The combination of AM and FM signals is processed with both SPHS and HT methods. The AM and FM components obtained by HT method are shown in FIGS. 4.26(a) and 4.26(b) respectively and the AM and FM components of SPHS processing are illustrated in FIGS. 4.26(c) and 4.26(d) respectively. The combination of pure AM and FM signals should show the amplitude modulation index as 0.1 and frequency modulation index as 0.02. The MIs obtained by both approaches are identical and show the valid nature of modulated signal as shown in FIG. 4.26 because there is no additional carrier.

### Section 4.5.6—Combination of AM and FM Signals with Additional Non-Modulated Carrier

This case is the most realistic one among simulated signals. Presence of both AM and FM signals and a non-modulated carrier signal is the most probable case that would happen in mounted samples during fatigue experiment. The AM×FM signal expressed in Equation (4.48) is contaminated by an additional non-modulated carrier which is not involved in the modulation process and could be present in the system output. The amplitude and phase of non-modulated carrier is assumed as 1 and

$$\frac{π}{2} .$$

$$x ( t ) = ( 1 + 2 {m}_{a} cos Ω t ) cos ( ω t + 2 {m}_{f} sin Ω t ) + cos ( ω t + \frac{π}{2} ) \qquad ( 4.48 )$$

The amplitude modulation index, ma, and frequency modulation index, mf, are assumed 0.1 and 0.02 in Equation (4.48). Power spectrum of the signal (FIG. 4.27) shows higher amplitude of carrier signal than the previous case in section 4.5.5 because of the non-modulated carrier while the amplitudes of sidebands are identical. Presence of both modulated and non-modulated carrier signals leads to a superposed carrier signal with different amplitude and phase of both carrier signals.

The AM×FM signal with additional non-modulated carrier is processed with both SPHS and HT methods. FIGS. 4.28(a) and 4.28(b) show the results of HT method and AM and FM components of SPHS processing are shown in FIGS. 4.28(c) and 4.28(d), respectively. The AM×FM signal consists both AM and FM components with 0.1 and 0.02 modulation indexes respectively. The AM and FM components of HT show erroneous values in presence of modulated and non-modulated carrier signal while AM and FM separated components obtained by SPHS represent the true nature of signal.

Three simulated scenarios which includes pure amplitude modulated signal, pure frequency modulated signal and combination of amplitude and frequency modulated signal could happen in AM/FM separation of VAM technique. The VAM technique monitoring the MI values of modulated signal in power spectrum could not distinguish between different nonlinearity sources. Separation of AM and FM components of the modulated signal could be a solution to increase sensitivity of VAM method to flaws. Hilbert Transform as the conventional method of demodulating signal to express its AM and FM components lacks in the correct interpretation of the modulated signal when a non-modulated carrier is present. It is expected to receive the non-modulated carrier signal in the output along with modulated carrier which is involved in the modulation process. The AM/FM separation results of HT show that it could not be used as an effective method to demodulating output of VAM setup. On the contrary, the SPHS method is functional in analysis of all investigated scenarios. Considering all explored scenarios, HT results is disrupted by presence of non-modulated carrier whereas SPHS method works fine and represent the valid nature of modulated signal. The simulation results suggested the commencement of testing the proposed algorithm on fatigue experiment data.

### Section 5—Experimental Tests

Fatigue failure is one of the most common failure modes of structural components; therefore, integrity of the structure depends on the prediction of fatigue cracks in early stages. The Vibro-Acoustic Modulation (VAM) method detects material defects by monitoring the modulation components generated by the interaction between a carrier (high-frequency ultrasound, ω) signal and a modulating (low frequency structural vibration, Ω) signal in the presence of various flaws such as fatigue and stress-corrosion cracks, bolted connections and delaminations. The VAM method has been studied excessively to detect defects in a variety of materials. Fatigue crack evolution in A-108 and A-36 steels is investigated using VAM method and an in-plane non-resonance very low frequency (10 Hz). Large number of samples have been tested to examine a) multi-path propagation of carrier signal, b) Modulation Index (MI) monitoring by VAM method, c) efficiency of the IQHS and SPHS algorithms in detecting cracks, and d) VAM sensitivity compared to Ultrasonic Testing (UT) and Eddy-Current Testing (ET) during fatigue cycling loading.

Two tests had been conducted to examine multi-path propagation of carrier signal in VAM output. As it was shown by modeling different scenarios in section 4.5, when the acquired signal consists a non-modulated carrier component, Hilbert Transform is unable to separate modulated signal to its valid AM and FM components. This limitation of HT in interpretation of VAM results necessitates development of new AM/FM separation methods. In order to explore the multipath propagation of carrier signal, two samples using 1- and ½-inch washers are used. The difference between these two samples arises from presence and absence of the non-modulated carrier in the output of system. The use of a 1-inch washer which covers all the samples path width is expected to result in complete involvement of carrier in the modulation process due to the contact between washer and the bar; thus, there would be no non-modulated carrier. On the other hand, using a ½-inch washer gives space to carrier to travel from contact-free parts of the sample; thus, it is likely to receive non-modulated carrier in the output.

A series of tests are explained below to implement VAM method on monitoring of crack evolution during fatigue cycling loading. In fatigue experiments, the modulation index, MI, is monitored for prediction of fatigue life time. Abrupt increase in the MI values considered as a sign of damage in the sample. In addition, IQHS and SPHS are used to separate AM and FM components.

### Section 5.1—MI Evolution During Fatigue Test

The initial objective of these tests was to do a life cycle analysis and assess the material degradation using the acoustical parameters obtained from the F-SCAN Vibro-Modulation system. For this purpose, improving the previous system in such a way that can calculate Modulation Index while utilizing fatigue cycling, 10 Hz, instead of shaker, 300 Hz, was a milestone that had been reached. Moreover, recorded signals were needed for enhancing post processing method to separate AM and FM. To apply VMT method with IQHS and SPHS algorithms to the fatigue test specimens, several specimens have been tested.

### Section 5.1.1 Nonlinear Acoustic Vibro-Modulation System Setup

The test setup shown in FIG. 5.1(a) consists of tension/compression testing system (MTS 810 servo-hydraulic Machine) capable of high cycle, low cycle fatigue and monotonic load testing, and the Nonlinear Vibro-Modulation system. The specimen to be tested is installed in the fatigue-testing frame, as shown in FIG. 5.1(b).

The calibrating specimen is a center notch specimen, as shown in FIG. 5.2(b), which is equipped by IST universal sensor/transducers (annotated by 5,6). The modulating signal is generated by a magnetostrictive shaker (annotated by 7) vibrations. The shaker is replaced by a low frequency vibration of cycling loading, 10 Hz, in order to enhance the VAM method to use structural vibration as modulating frequency. The small modulating signal also helps to eliminate the amplitude/phase frequency response effect on the output modulated result. All the test results presented here are conducted by using fatigue cycling as a source of the low frequency vibration to interact with the high frequency ultrasonic waves sent to the specimen. The vibration in this research caused by cycling loading is different than vibration caused by the shaker (Resonance Frequency), in this set of tests the test setup is closer to the actual field condition. The manufacturing of the specimen had been done in our laboratory.

The calibrating specimen is a center notch specimen, or an edge-notch specimen. Dimensions are given in FIG. 5.2. The specimen is manufactured out of low-Carbon steel (yield stress 44 ksi). The advantage of the center notch or edge-notch specimen is that first damage accumulation is expected to occur at the notch tip at half height of the specimen.

The applied VAM technique in this example consists of a computer with a LabVIEW F-scan software that generates the carrier signal. This occurs via Data Acquisition board (DAQ) and the high frequency amplifier that are connected to the computer as shown in the FIG. 5.3(d). The amplified high frequency signal is introduced to the sample by the transmitter transducer (Tx). The received modulated signal will be transmitted to the DAQ via the receiver sensor (Rx). The typical specimens under tests are 1″ by 10″ rectangular bars of ⅛″ thickness and ¼″ diameter center-notch. The VAM for Fatigue Damage Evolution Fatigue tests were conducted using an 810 MTS test frame connected to a digital data acquisition and processing station. The specimens were mounted parallel to the applied load. A 10 Hz tension only low-load fatigue cycling was used for the measurement purposes. The applied tensile load during the initial tests are 20 kN maximum and 0 kN minimum.

Since in fatigue tests, results of different but identical tests might differ widely, statistical interpretation by the designer is needed. From the initial estimations maximum tension load was set to 20 KN and minimum load was set to 0 KN for all of the specimens. The fatigue test was designed to be conducted as a tensile only(R=0). Thus, R (ratio of minimum stress to maximum stress) is equal to zero as shown in FIG. 5.4. Recommended cycling loading frequency of fatigue experiment is 0.01 to 100 Hz due to limitations of servohydraulic testing machines. Also, higher cycling frequencies would affect the experimental results because of temperature effect in the vibrational loading regime. The chosen frequency for fatigue experiment, 10 HZ, is in the recommended range. After several trials for the same specimen, with the same fatigue parameters, the range of the number of cycles to the failure was estimated between 30000 to 40000 cycles.

Before starting the fatigue test, the amplitude-frequency response of mounted sample is measured for applicable frequency range of sensors, 120 to 200 KHz. One example of the recorded frequency response is shown in FIG. 5.5. Since the representative MI value is obtained by averaging of MI values on a 5 KHz frequency range, the signals should be selected in the flat area of frequency response of sample to avoid effect of amplitude and phase frequency response on sideband amplitudes. Moreover, 10 Hz modulating frequency decreases the effect of frequency response on sidebands due to small differences between sidebands and carrier amplitudes. In this case, the range of 165 kHz to 170 kHz is selected to measure MI values. Chosen frequency needs to be smooth and close to zero dB.

For recording the modulation index values, background fatigue cycling is needed. To keep the test in low-cycle fatigue, high loads were used during the tests; however, lower fatigue load (closer to the actual field) is applied to the specimens for the measurements. Therefore, maximum tension load of 1 KN and minimum load of 0 KN is applied with the same frequency of 10 Hz during the measurements. The initial measurements will be conducted with the mentioned setup, before staring the main test that would be called cycle zero. For post-processing purposes 5 signals at specific frequencies have to be recorded for each test. For choosing proper frequencies for recording signals, some characteristics need to be considered such as having the sidebands in a flat range to eliminate the effect of frequency response on the measured sidebands since frequency response will affect the measurements. In future, the effect of frequency response on the sidebands has to be considered.

The results obtained from six of the conducted tests are visualized as a modulation index vs number of fatigue cycle/fatigue life time graph in FIG. 5.6. Six of the fatigue test monitoring by VAM method are represented here. For all of them, the same high load of 20 KN as maximum tension and 0 KN as minimum load for the fatigue was applied. The results from the tests confirms one of initial assumption that utilizing fatigue cycling would work well with the current system; since MI changes are consistent with the material degradation process. In order to be able to compare the data from all of the tests, the data are normalized to the number of fatigue cycles and Initial Modulation Index of −60 dB.

The resulting filtered and normalized graph of the modulation index vs number of fatigue cycles reveals a relatively consistent set of trends for different conducted tests. These results show that besides the gradual increase in MI during the fatigue test, for most of the specimens after 80 percent of their life, a significant increase is observed in the MI values. This abrupt MI change is a sign of damage in the sample; therefore, the failure of the sample could be predicted 20% in advance of failure.

For the first cycles, as it is observed in most of our findings, some significant changes might occur on the initial modulation index values due to high level and unpredictable variations of background modulation. The contact nonlinearity between the clamps of fatigue machine and the specimen could be one of the reasons. However, this will be fixed after a couple of cycles. Then the trend would look like the normal trend.

### Section 5.1.3—Sample Thickenss Effect on VAM

The thickness of sample is varied to explore the thickness effect on the VAM output. The sample geometry is identical to the typical center-hole specimen; however, the sample thickness is doubled and is ¼ inch. Because of the doubled section area, the applied fatigue load is also doubled (40 KN) in order to maintain the same maximum tensile load. FIG. 5.7 shows this sample during the fatigue test.

The resulting modulation index evolution throughout the fatigue life is shown in FIG. 5.8. As seen in previous test series with sample with ⅛ inch thickness, a steep increase of MI is seen as soon as 80% of life time has passed. Therefore, the sample thickness does not appear to influence the VAM results regarding monitoring of damage evolution during fatigue loading.

### Section 5.2—Multi-Path Propagation of Carrier Signal

As explained in subsection 4.1.2, the non-modulated carrier that is not involved in the modulation process appears as an extra carrier signal in the received modulated signal. The superposition of this non-modulated carrier with modulated carrier which is involved in the modulation process results in erroneous results of AM/FM separation using HT demodulating method. This non-modulated carrier travels to receiving transducer through intact areas of the sample. This multi-path propagation effect is difficult to investigate during fatigue tests; therefore, a test is designed to explore the multi-path propagation effect. A sample with 10 in length, 1 in width and ⅛ in thickness is prepared from steel A-108 and a hole is placed in the middle of sample. The sample is vibrated with a low fatigue loading with 10 Hz cycling frequency; this low vibration parallel to the sample direction generates the modulating signal as it is present in fatigue experiments. This sample is tested separately when a bolt connection is installed on the middle hole with a 1-in washer and a ½-in washer shown in FIGS. 5.9(a) and 5.9(b), respectively.

### Section 5.2.1—Bolt Connection with 1-Inch Washer

The sample is covered in the bolt connection area by a 1-in washer; so, the whole path of signal from transmitter to receiver is covered by the washer which results in the modulated output. The carrier signal will be modulated by modulating signal in presence of contact-type nonlinearity such as bolt connection. Using a large 1-inch washer covering the whole sample width results in passing the whole signal through the connection. The whole covered path prevents presence of nonmodulated carrier in the receiver. The acquired signal is a prevailing AM modulated signal without additional non-modulated carrier. The sample is shown in FIG. 5.9(a).

The acquired signal in time domain is illustrated in FIG. 5.10. It is evident from the figure that the signal shows prevailing amplitude modulation, AM. The varying amplitude of signal is a sign of high AM component in the output signal; this amplitude variation can be expressed by envelope function.

The received signal is then processed to measure MI using four different approaches: a) Fourier Transform (FT), b) Hilbert Transform (HT), c) envelope function, and d) Sweeping-Phase Homodyne Separation (SPHS). Subsequently, AM and FM separated components are measured by SPHS and HT demodulating. These results are shown in FIG. 5.11.

Firstly, the modulation index, MI, is measured by Fourier Transform (FT) spectrum. Modulation Index is evaluated directly by the relative amplitude of sidebands components to the carrier component:

$$MI = 20 {log}_{10} ( \frac{{B}_{1} + {B}_{2}}{2 A} ) \qquad ( 5.1 )$$

B1 and B2 are the amplitude of higher and lower sidebands and A is the amplitude of carrier frequency.

Secondly, MI is measured from envelope function. Usage of a 1-inch diameter washer results in modulation of the whole signal passing through the connection and absence of non-modulated carrier. Modulation Index could be measured by subtracting the maximum and minimum of envelope function. Assuming an amplitude modulated signal in absence of non-modulated carrier, the received signal would have the following form:

xₙ(t)=a(1+mₐ cos(Ωt+θ))cos(ωt+ϕ) (5.2)

Maximum and minimum values of envelope function would be A(1+ma) and A(1−ma). So, MI could be measured by Equation (5.3).

$${MI}_{envelope} = \frac{1 max ( env ) - min ( env )}{2 max ( env ) + min ( env )} \qquad ( 5.3 )$$

FIG. 5.11 enlarges the envelope function of the received signal. The maximum and minimum of envelope is measured as 0.545 and 0.481, respectively. The MI value measured based on Equation (5.3) would be 0.031.

After measuring MI values with FT and envelope function analysis, SPHS and HT are used to decompose the modulated signal to its AM and FM components. The MI could also be measured based on this AM/FM separated values to be compared with FT and envelope function results. SPHS can be used to compensate for distortions due to a non-modulated carrier with unknown initial phase. In this approach, the signal is multiplied by a sweeping-phase reference signal instead of multiplying signal with in-phase and quadrature reference signal. When the sweeping-phase reference is completely in-phase with the received signal, sweeping modulation index (Mi) represents AM component of the signal and when the sweeping-phase reference signal is in quadrature phase difference with the received signal, sweeping modulation index (Mi) represents FM component of the signal. The AM and FM components appear as the maximum and minimum of the DC component of sweeping algorithm as shown in FIG. 5.12.

FIG. 5.12 shows Mi results of SPHS in a bolt connection with 1-inch washer with respect to initial phase of the reference carrier, modulation phase. The extreme values of sweeping modulation index are corresponding to the AM and FM components. When the Mi results starts from one of this extreme values, it shows that there is no non-modulated carrier to change the phase of the superposed carrier; therefore, the phase of reference carrier and modulated signal are the same as modulation phase. The SPHS results show that the sweeping modulation index, Mi, starts from maximum which is an indication of absence of phase shift and non-modulated carrier.

The HT demodulating results of the received signal is measured and MI values are measured from AM and FM components. The MI results of four processing approaches:

a) FT, b) envelope function, c) SPHS, and d) HT are shown FIG. 5.13. The four measurements of MI are very close to each other, as expected, since using a large washer will result in modulation of almost the whole signal which passes through bolt connection (there is no path for signal to avoid modulating). Accordingly, the non-modulated carrier has an exceedingly small amplitude; therefore, SPHS and HT separated AM and FM components show almost identical results.

It was expected to receive only modulated carrier when 1-inch washer is used. The identical MI measurements by different approaches confirm this hypothesis.

### Section 5.2.2—Bolt Connection with ½-Inch Washer

The same sample with bolt connection and ½-inch washer, as shown in FIG. 5.9(b) was tested. The cycling load with 10 Hz frequency generates the modulating signal. Since the whole path of signal from transmitter to receiver is not covered by the ½-washer which produces contact-type nonlinearity, the presence of non-modulated carrier in the received carrier is expected. The presence of nonmodulated carrier influences the amplitude and phase of superposed modulated carrier. The HT should not be capable of demodulating the acquired modulated signal due to this non-modulated carrier.

It should be mentioned that FT and envelope analysis will not reflect the correct MI values in presence of non-modulated carrier; if it is assumed that the carrier involved in modulation is contaminated by an additional non-modulated carrier as shown in Equation (4.22). The amplitude and phase of the superposed carrier from modulated and non-modulated carrier could be measured by Equations (5.4) and (5.5).

$$\begin{matrix}A = \sqrt{{A}_{m}^{2} + {A}_{nm}^{2} - 2 {A}_{m} {A}_{nm} cos ( {φ}_{m} - {φ}_{nm} )} & ( 5.4 ) \\ φ = {φ}_{nm} + {tan}^{- 1} ( \frac{sin ( {φ}_{m} - {φ}_{nm} )}{\frac{{A}_{nm}}{{A}_{m}} + cos ( {φ}_{m} - {φ}_{nm}} ) & ( 5.5 )\end{matrix}$$

The presence of non-modulated carrier is distorting the amplitude and phase of carrier signal; therefore, MI calculated via “Fourier transform” is not reflecting valid modulation index. In contrary, decomposition of the modulated signal to its AM and FM components by SPHS algorithm explains the correct modulation nature of signal.

FIG. 5.14 shows Mi result of bolt connection with ½-inch washer. The SPHS results show that the sweeping modulation index with reference to sweeping modulation phase does not start from maximum which is an indication of the presence of phase shift and therefore non-modulated carrier. In fact, the phase of superposed carrier is different than the modulation phase because of non-modulated carrier.

In using a 1-inch washer, it is expected that only modulated signal is received since the sample's width is 1 inch and there is no path for signal to avoid modulating. In this case, our approach and Hilbert Transform should show almost identical results. On the other hand, the ½-inch-diameter washer not covering the whole sample width should cause a non-modulated carrier. Hence, discrepancies in SPHS and HT results can be expected, as shown in FIG. 5.15. It is expected that AM component dominates the received signal because of the contact-type nonlinearities; therefore, Hilbert Transform reveals improper decomposition result. Note that HT is not capable of demodulating the received signal to its components.

### Section 5.3—AM and FM Separation During Fatigue Damage Evolution

After successful implementation of VAM method in detecting flaws during fatigue experiment of simple samples, efforts were focused on practical usage of this method on condition with high initial nonlinearity due to contact-type nonlinearity such as bolt connections. The IQHS and SPHS algorithm are developed in MAT-LAB as well as HT method for AM/FM separation.

### Section 5.3.1—The IQHS Implementation

A test was designed to observe AM and FM dynamics during tensile fatigue of a A-108 steel bar as shown in FIG. 5.16. The thickness, width and height of the under-test sample are ⅛ in, 1 in and 10 in, respectively. No bolt is attached to the sample. The test is a tension-only fatigue test with fatigue loading of 0 to 20 KN and fatigue frequency of 10 Hz. The AM/FM separation has been processed by IQHS algorithm. The damage was accumulated across the bar near the central hole (damage zone is shown as a grey area obtained by the ultrasonic microscope) so that there were no non-modulated paths, and, therefore, IQHS and HT comparison can be made. The results validated the hypothesis that initial damage produces primarily FM modulation which is taken over by AM modulation as visible contact-type defect (crack) has developed. The results show that even though both AM and FM components have a very low value at the beginning of the test, the FM component starts increasing prior to formation of any visible macro cracks. After growth of the macro crack, the AM components dominates the FM component. It should be mentioned that AM and FM components are both normalized to the amplitude of the received signal.

Another test presented here demonstrates the ability of the developed algorithm to detect early damage evolution (FM signal) in the presence of AM strong structural nonlinearity such as bolted connection, as shown in FIG. 5.17. In this specimen, the bolt connection near the central hole area introduces initial high nonlinearity to the MI readout of the sample, such that MI increase could not be observed as the sign of damage accumulation. However, while the AM component of the modulated signal shows the contact-type nonlinearity as the initial high value, FM component is a very small value. The FM increase should be considered as the indicator of micro damage accumulation in the sample before the crack could be visible.

### Section 5.3.2—The SPHS Implementation

ASTM A-36 is the most commonly used mild and hot-rolled steel. It has excellent welding properties and is suitable for grinding, punching, tapping, drilling and machining processes. A-36 can be galvanized to provide increased corrosion resistance. A-36 bars with ⅛-in thickness and 1-in width are used for following experiments instead of A-108 steel. The consistency of all results proved that steel type could not make any issue in regard to application of VAM technique.

The primary experiments show the ability of IQHS algorithm to demodulating AM and FM components of the acquired signals in the VAM method. The IQHS algorithm is working based on known modulation phase, φm. The IQHS result is valid whenever the phase changes are negligible. It could be assumed that phase change is a very small number because of small size of the tested samples and high speed of sound in steel. In order to enhance VAM method to a global detection method without knowledge of modulation phase, the Sweeping-Phase Homodyne Separation (SPHS) algorithm has been developed. SPHS is capable of separating modulated signal to its valid AM and FM components in presence of non-modulated carrier. Moreover, the SPHS can detect modulation phase, involved in the modulation process. In the following test series, AM and FM components separated by SPHS are inspected as well as modulation phase changes during damage accumulation.

### Section 5.3.2.1—Sample without Connection

A sample is tested under 20 KN tension only cycling loading to validate the improvement of SPHS algorithm and to investigate modulation phase evolution during the fatigue experiment. This sample is made of A-36 steel. Length, width and thickness of sample are 10 in, 1 in, ⅛ in, respectively. A hole is made in the middle of sample to control the fracture area as depicted in FIG. 5.18(a). The crack in the vicinity of central hole is also shown in FIG. 5.18(b).

The processed results of SPHS method are shown in FIG. 5.19. All results are shown with respect to cycle/Fatigue Life Time. The sample failed after 46339 cycles and the crack was visible at the 44057 cycle which is approximately 95% of fatigue life time. FIG. 5.19(a) shows the AM and FM components of the acquired signal processed by SPHS algorithm. While the AM component is dominant in the recorded signals of fatigue experiment as it is almost equal to the MI value due to small contribution of FM components, the FM is present and contributes to the modulated signal as well.

A similar pattern, specifically an increase in the value after formation of microcracks, is observed in all three measurements of MI, AM and FM components. In addition, the modulation phase of the signal is measured during the fatigue cycle. Interestingly, the modulation phase is almost constant prior to formation of crack and increase in the MI value. After formation of the microcracks, the modulation phase starts to continuously decrease. The fluctuations in the modulation phase is observed after the crack is visible and opening and closing of the crack occurs.

Another sample without any connections with the same dimensions of the previous sample is tested to observe the SPHS results of low cycle fatigue as it is shown in FIG. 5.20(a). This sample was going through 26 KN tension only cycling load. This high load leads to low cycle failure of the sample at cycle 13802. When a component is subjected to low cycle fatigue, it is repeatedly plastically deformed. The crack was visible at cycle 12773 which is approximately 93% of fatigue life of the sample (FIG. 5.20(b)).

The AM and FM components separated by SPHS and the MI increase of this case is not as clear as the previous results as shown in FIG. 5.20(c) but consideration of modulation phase shows that the continuous change in the modulation phase to the lower values could be a very strong sign of damage presence in the structure. FIG. 5.20(d) shows modulation phase changes after microcrack formation.

### Section 5.3.2.2—Sample with Connection

Various samples with connections were tested to investigate the SPHS algorithm results. Length, width and thickness of samples are 10 in, 1 in, and ⅛ in. A hole is made in the middle of samples similar to the previous samples to control the fracture. A connection is designed as shown in FIG. 5.21 with the same ASTM A-36 material and installed on the middle hole.

Two pieces of 2-inch long bar are used as a contact-type connection in both side of the bar which is under cycling loading. This connection is attached to the sample using bolt and nut. Thus, all the generated contacts between connection bars with the sample and with bolt and nut are perpendicular to the vibration direction. The attached connection shown in FIG. 5.22(a) introduced a very high initial nonlinearity level of the MI measurements. The MI stays at −32 dB in this sample (FIG. 5.22(b)) whereas the MI was −55 dB in the simple sample without connection (FIG. 5.19(b)).

However, while the high nonlinearity level in presence of connection makes the MI readings unable to predict the failure of structure as depicted in the FIG. 5.22(b), the modulation phase changes can elaborate the crack growth in the sample during fatigue cycles as shown in FIG. 5.22(c).

Other examples of SUT with connection is considered as a threaded hole. The hole is threaded by tap NF #28. Firstly, The screw is attached to the sample without any usage of nuts at the end as shown in FIG. 5.23(a).

In usage of screw without nut, the prevailing contact is in the threaded parts, perpendicular to the vibration direction. The MIs of VAM method show an initial high level of nonlinearity as shown in FIG. 5.23(c). This high level of nonlinearity obscures VAM capability of detecting cracks by monitoring the MIs. The MI increase could not be observed due to presence of contact-type nonlinearities.

While interpretation of MI and AM/FM separation results is very challenging, the modulation phase could be a sign of crack formation in the sample as shown in FIG. 5.23(c). By continuous monitoring of modulation phase, it is observed that modulation phase starts decreasing in the early stages of crack formation. The continuous decreasing of modulation phase after a few steps declaring damage presence in the sample.

In another sample as shown in FIG. 5.24(a), the screw is supported with washer and nut at the end. The difference between this sample and the sample showed in FIG. 5.23(a) arises from contact direction. While contact was perpendicular to the vibration direction in the previous sample, a mixture of contacts parallel and perpendicular to the vibration is present when a screw and nut is used. Again, the results show the high initial nonlinearity due to the contact-type connection as shown in FIG. 5.24. Therefore, damage cannot be detected by monitoring the MI increase of VAM method. The FM component calculated using SPHS algorithm shows an initial increase in the 70% of fatigue life time which appears to be the damage indication. Despite the challenging interpretation of AM/FM separation results, the decreasing trend in modulation phase shown in FIG. 5.24(b) measured using SPHS method reveals the damage accumulation in early stages of fatigue crack growth.

Indeed, however FM component evolution could be assigned to the crack growth in the sample, the modulation phase changes could be a more reliable damage indicator to defect micro-defect formation in the tested samples. In all tested samples modulation phase starts decreasing prior to any visible crack or damage in the structure. It appears that the modulation phase changes correlates to micro-crack formation. The modulation phase detection is a robust method of detecting damage in the sample and it can provide earlier sign of crack than the either MI or AM/FM observations.

### Section 5.4—Crack Detection Capability of VAM Compared to UT and ET

Comparison between Ultrasonic Testing (UT), Eddy Current Testing (ET) and VibroAcoustic Modulation (VAM) methods provides information regarding sensitivity of these method to fatigue cracks. The ⅛ inch-thick center hole specimen (as used in previous test series) is tested with 20 KN maximum tension load and 10 Hz cycling loading. Fatigue test had been conducted until the slope increase of Modulation Index (MI) was observed. The MI is measured in 5 kHz range sweeping carrier frequency with 100 Hz steps. In fact, the MI is averaged over 50 measured values. The range is selected in a flat portion of amplitude frequency response of the sample under test (SUT) to avoid the effect of distortions of frequency response. The increase in the MI is the indicator of defect in the sample via VAM. FIG. 5.25 shows the MI-cycle number curve in which two colored lines separates two consecutive test days. The test is stopped as soon as the MI increase observed. The sample is taken out of the fatigue machine. UT and ET equipment are used to investigate whether any sign of defect in the sample can be detected. Note that neither of the conventional tests is capable of identifying signs of defect in the sample. Hence, it can be concluded that Vibro-Acoustic Modulation Method is superior to existing technologies in regard to sensitivity of defect detection. When the crack is visible, both UT and ET are capable of crack detection.

### Section 5.4.1—UT Inspection

By using OLYMPUS Epoch 650 ultrasonic flaw detector fatigue crack was detected with 70. angle beam when it was visible. The transmitted ultrasonic signal specifications are mentioned in Table 5.1.

TABLE 5.1
Ultrasonic wave specifications

| Frequency | 5.0 MHz |
|---|---|
| Velocity | 0.1273 in/μs |
| Angle | 70.0° |

UT result shows the crack depth and the horizontal distance of sensor to the crack position at 0.107 in and 0.394 in respectively as illustrated in FIG. 5.26(a). The horizontal distance measured between sensor position and the vicinity of hole in which the fracture is expected to happen is approximately equal to the horizontal echo distance to the detected crack as shown in FIG. 5.26(b).

### Section 5.4.2—ET Inspection

OLYMPUS NORTEC 600 eddy current flaw detector is used for ET inspection. The near surface crack would lead to vertical displacement in impedance plane graph. An impedance plane plot graphs coil resistance on the x-axis versus inductive reactance on the y-axis. Variations in the plot correspond to variations in the test piece. The inspection measurements are dependent entirely on the comparison of the signal against the reference calibration.

Coil on the defect-free part of SUT is shown in FIG. 5.27 by white color. which is used as the reference. The horizontal line is the lift off in which the probe has been “nulled” (balanced) on the steel part. This inspection is done with a pencil probe. The red line shows the inspection of the vicinity of the middle hole when the crack is visible at cycle 45921 (91% of fatigue life time). As it is shown in FIG. 5.27 by the red line, the results show presence of crack compared to the reference line. Variations in the electrical conductivity and magnetic permeability of the sample around the middle hole due to the presence of defects causes a change in eddy current and a corresponding change in phase and amplitude that can be detected by measuring the impedance changes in the coil, which is a sign of the crack presence.

### Section 5.4.3—Continuous VAM, UT and ET Inspection

Another sample with 10 in thickness, 1 in width and ⅛ in Thickness is Subjected to fatigue cycling loading to compare sensitivity of VAM, UT and ET to the fatigue defects. The cycling loading is 0 to 20 KN. The cycling loading introduced 10 Hz low frequency signal. The carrier signal would be modulated by this low frequency signal in presence of cracks. The MI evolution during fatigue experiment is recorded. This sample failed at cycle 50450 and the crack was visible at cycle 45921. The fatigue cycles are normalized to the fatigue life time of the specimen; therefore, the horizontal axis of FIG. 5.28 shows values between 0 and 1. As it is indicated in FIG. 5.28, the steep slope in the MI vs. Cycles is observed around 75% of the fatigue life of the specimen.

The UT and ET are also used to monitor this sample continuously. Four of inspected data points are pointed in VAM measurement data graph (FIG. 5.28) by labels a to d and the corresponding ET and UT graphs to observe the development of crack by ET and UT are shown in FIGS. 5.29 and 5.30, respectively. Data points a, b, c and d are related to cycles 5573, 34675, 41723 and 47755, respectively which corresponds to 11%, 68%, 83% and 95% of the fatigue life time. Label d is showing the visible crack cycle. The VAM, ET and UT could be able to predict the crack before it is observable. The Echo-pulse graphs of UT inspection of these four data are depicted in FIG. 5.29. FIGS. 5.29(a) and 5.29(b) show data collected prior to abrupt MI increase which is the indication of damage in VAM technique. While there is no sign of damage in UT results prior to MI increase, the UT could detect defects after VAM detection. Noted that the first peak in the UT is the reflection of angle beam sensor plastic cover.

ET is also used to monitor this sample. The impedance plane graphs of ET are shown in FIG. 5.30. The ET inspection related to the cycles prior to VAM indication are shown in FIGS. 5.30(a) and 5.30(b). The white lines are depicting the reference impedance obtained from intact areas of the sample as the reference impedance lines. Such as UT inspection, the ET inspection could not detect damage in the structure prior to VAM indication.

Continuous monitoring of the sample with three approaches—VAM, UT and ET—show that VAM is more sensitive to the structural defects than the other ones.

When MI abrupt increase is observed during fatigue experiment, no observation of damage could be detected by UT and ET. The VAM, ET and UT methods could be able to predict the crack before it is observable. It should be mentioned that better sensitivity of VAM compared to UT and ET is not the only advantage of VAM with respect to UT and ET.

The main advantage of VAM over UT and ET is its global inspection capability. Installment of a series of sensors on the sample will help to detect flaws remotely whereas the UT and ET needs manual inspection of the component.

### Section 6—Advancement in Vibro-Acoustic Modulation NDE Technique

This work set out to investigate the applicability of the VAM technique in the field testing for critical bridge components made out of structural steel. The desired outcome would help to prevent disastrous collapse of bridges by estimation of the remaining fatigue life of the fracture critical members. Therefore, several fatigue tension only tests have been conducted on two types of steel material, ASTM A-36 and ASTM A-108. As a result of these tests for the typical test specimens under similar condition, 20 to 30 percent of the life cycle damage precursor warning before failure was demonstrated. In this investigation, the following research goals had been met.

In the beginning several preliminary tests of the VAM method using a shaker was conducted and the steel material degradation was successfully observed as MI trend vs number of fatigue loading cycles. The next achieved milestone was to conduct the MI measurements via low load fatigue cycling as a substitution for the resonance frequency generated by the shaker.

In the tests with typical specimens, consistency in the trends of MI is observed with respect to fatigue cycles per fatigue life time, meaning that gradual increase of the graph in the beginning changed to a steep slope in 70% to 80% of the fatigue life time of the specimen.

It is also concluded that fatigue load cycling used for the measurements can successfully substitute resonance frequency generated by the shaker as a modulating frequency source.

Furthermore, the general applicability test of the VAM technique for thicker samples turned out successfully with start of the steep slope 25% to 30% before the actual failure occurred.

The Vibro-Acoustic Modulation (VAM) method reliably detects and monitors damage evolution from micro-defects to macro-cracks. Contact-type structural elements such as bolt connections and other structural components may create significant baseline nonlinearity, limiting VAM practical implementation. It is proposed that fatigue damage may produce predominantly Frequency Modulation, while contact structural nonlinearities produce primarily Amplitude Modulation. If true, separating AM and FM may address the major deficiency of the VAM method.

Indeed, if the above hypothesis is true: structural contacts (as well as large cracks) exhibit AM, while initial stage of fatigue damage generates primarily FM. This is a very significant finding promising improved detection and characterization of damage evolution, which was demonstrated experimentally.

It was found that AM/FM separation using the traditional Hilbert Transform may not work for multipath propagation, which is common in practical settings. Therefore, two new AM/FM separation techniques, IQHS and SPHS algorithms, have been developed and validated both numerically and experimentally.

The further investigation of IQHS and SPHS algorithms show that these algorithms can separate AM and FM components of VAM response during the fatigue experiments. However, both AM and FM components appear in the modulated signal, the AM is the dominant component of the output signal. Although modulation index of AM is higher than 10 times of MI of FM, both AM and FM show increase during the fatigue experiment. The FM component could be a sign of crack formation in the presence of high nonlinearity due to the contact-type connections which makes MI reading impossible.

The other investigated parameter in this process is modulation phase of the modulated carrier, involved in the process of modulation, rather than the non-modulated carrier which is not involved in the modulation process and finds its path to the receiving transducer from the defect-free areas of the SUT. This happens because of multi-path propagation of signal in the structural component. In general, SPHS appears to be able to separate the AM and FM components. As shown in FIG. 6.1, the FM component of signal and modulation phase which are calculated by SPHS algorithm could be used to indicate crack evolution under fatigue loading while the high nonlinearity generated by contact-type connections obscures the crack detection capability of VAM method using MI monitoring. Modulation phase is capable of predicting crack with more precision in earlier stage.

Demodulation of the received signal from Vibro-Acoustic Modulation testing of the specimens shows preliminary frequency modulation dominance in micro-crack initiation and growth compared to prevalent amplitude modulation in contact-type macro-crack formation. These findings contribute in several ways to the application of this approach and pave the way for more research in this area for different samples with different geometries both in small and large scales. Considerably more empirical work needs to be done on variety of fatigue prone details in bridges both in small and actual scale to establish the VAM technique as an applicable method for life cycle analysis of bridges. The IQHS and SPHS algorithms could solve the problems towards practical implementation of the VAM method on existing structures. Therefore, a series of comprehensive tests should be performed on the real structures in the field.

### Supplement A—Separation of Unsymmetrical Sidebands

Vibro-Acoustic Modulation technique for monitoring damage evolution in material uses a carrier signal and a modulating signal. In presence of defects, these signals interact to each other and provide modulated output which reveals as sidebands to the carrier frequency while there is no interaction and modulated signal in flawless samples. Separating this modulated signal to its AM and FM components is the approach undertaken to monitor the damage evolution with consideration of phases of sidebands. To take into account the phases of sidebands, symmetric and antisymmetric properties of amplitude and frequency modulation components are considered. Indeed, AM presents as symmetrical sidebands whereas FM presents as antisymmetrical sidebands. The practical usage of symmetric and antisymmetric properties depends on the fact that any arbitrary unsymmetrical sideband distribution can be expressed as the sum of symmetrical and antisymmetrical pairs. To show this, let one arbitrary pair of unsymmetrical sidebands separated from carrier frequency be assumed as follow:

B1 cos(ω+Ω)t+θ1) (A.1)

B2 cos(ω−Ω)t−θ2) (A.2)

Carrier wave is assumed to be A cos(ωt) (A.3)

No particular relation is assumed between B1 and B2 or between θ1 and θ2. It could be now shown that sum of the two sidebands (A.1) and (A.2) can be expressed as the sum of symmetrical and antisymmetric pairs.

Firstly, note that

$${B}_{1} cos ( ( ω + Ω ) t + {θ}_{1} ) + {B}_{2} cos ( ( ω - Ω ) t - {θ}_{2} ) = {B}_{1} [ cos ω t cos ( Ω t + {θ}_{1} ) - sin ω t sin ( Ω t + {θ}_{1} ) ] + {B}_{2} [ cos ω t cos ( Ω t + {θ}_{2} ) + sin ω t sin ( Ω t + {θ}_{2} ) ] = [ {B}_{2} cos ( Ω t + {θ}_{2} ) + {B}_{1} cos ( Ω t + {θ}_{1} ) ] cos ωt + [ B 2 sin ( Ω t + θ2 ) - B 1 sin ( Ω t + θ1 ] sin ω t \qquad ( A .4 )$$

Now the term in cos ωt is the in-phase term and is therefore the sum of a pair of symmetrical sidebands, while the term in sin ωt is the quadrature term and is the sum of a pair of antisymmetrical sidebands. Let us assume a modulated signal with a pair of symmetrical sidebands with arbitrary amplitude and phase:

A cos(ωt+ϕ)+A₁ cos(ω+Ω)t+ϕ₁)+A₁ cos((ω−Ω)ₜ+2ϕ−ϕ₁) (A.5)

Now let φ=0, A1=As and φ1=φs in Eq. A.5, so that, after subtracting the carrier, Eq. A.5 becomes

Aₛ cos((ω+≠)t+ϕₛ)Aₛ cos((ω−Ω)t−ϕₛ)=2Aₛ cos(Ωt+ϕₛ)cos ωt (A.6)

Then, equating coefficients of cos ωt in Eqs. A.4 and A.6:

$$2 As cos ( Ω t + ϕ s ) = B 2 cos ( Ω t + θ2 ) + B 1 cos ( Ω t + θ1 ) = B 2 ( cos Ω t cos θ2 - sin Ω t sin θ2 ) + B 1 ( cos Ω t cos θ1 - sin Ω t sin θ1 ) = ( B 2 cos θ2 + B 1 cos θ1 ) cos Ω t - ( B 2 sin θ2 + B 1 sin θ1 ) sin Ω t = 2 As ( cos Ω t cos ϕ s - sin Ω t sin ϕ s ) \qquad ( A .7 )$$

Equating coefficients of cos Ωt and of sin Ωt on opposite sides of the equation:

$$\begin{matrix} 2 {A}_{s} cos {ϕ}_{s} = {B}_{2} cos {θ}_{2} + {B}_{1} cos {θ}_{1} & ( A .8 ) \\ 2 {A}_{s} sin {ϕ}_{s} = {B}_{2} sin {θ}_{2} + {B}_{1} sin {θ}_{1} & ( A .9 ) \\ Therefore & \\ 2 {A}_{s} = \sqrt{{( {B}_{2} cos {θ}_{2} + {B}_{1} cos {θ}_{1} )}^{2} + {( {B}_{2} sin {θ}_{2} + {B}_{1} sin {θ}_{1} )}^{2}} = \sqrt{{B}_{1}^{2} + {B}_{2}^{2} - 2 {B}_{1} {B}_{2} cos ( {θ}_{2} - {θ}_{1} )} & ( A .10 ) \\ and & \\ {φ}_{s} = {tan}^{- 1} ( \frac{{B}_{2} sin {θ}_{2} - {B}_{1} sin {θ}_{1}}{{B}_{2} cos {θ}_{2} + {B}_{1} cos {θ}_{1}} ) & ( A .11 )\end{matrix}$$

For antisymmetrical sidebands, the following expression is obtained

$$\begin{matrix}2 {A}_{a} = \sqrt{{B}_{1}^{2} + {B}_{2}^{2} - 2 {B}_{1} {B}_{2} cos ( {θ}_{2} - {θ}_{1} )} & ( A .12 ) \\ and & \\ {φ}_{a} = {tan}^{- 1} ( \frac{{B}_{1} sin {θ}_{1} - {B}_{2} sin {θ}_{2}}{{B}_{1} cos {θ}_{1} - {B}_{2} cos {θ}_{2}} ) & ( A .13 )\end{matrix}$$

As a consequence of the foregoing, the original unsymmetrical pair of sidebands can be expressed as the sum of a symmetrical and an antisymmetrical pair of sidebands as follows:

$${B}_{1} cos ( ( ω + Ω ) t + {θ}_{1} ) + {B}_{2} cos ( ( ω - Ω ) t - {θ}_{2} ) = {A}_{s} cos ( ( ω + Ω ) t + {φ}_{s} ) + {A}_{s} cos ( ( ω - Ω ) t - {φ}_{s} ) + {A}_{a} cos ( ( ω + Ω ) t + {φ}_{a} ) + {A}_{a} cos ( ( ω - Ω ) t - {φ}_{a} ) \qquad ( A .14 )$$

The values of As, φs, Aa, and φa are given in Eqs. A.10 to A.13.

### Supplement B—Separation of Unsymmetrical Sidebands

Using different MATLAB functions might be challenging to generate the algorithms and results presented in this discussion. Two main functions, Interp and IIR filter, are explained more in this Supplement. Interp function is used to increase the sampling rate and an IIR filter is used to filter higher sidebands and frequencies after homodyning the multiplied modulated and carrier signals.

The precision of IQHS and SPHS mainly depends on the sampling rate of recorded signals because these algorithms work based on the multiplication of acquired and reference signal in time domain. Interpolation increases the original sample rate of a sequence to a higher rate. It is the opposite of decimation. Interp function in MATLAB inserts zeros into the original signal and then applies a lowpass interpolating filter to the expanded sequence. The function uses the lowpass interpolation algorithm:

Expand the input vector to the correct length by inserting zeros between the original data values.

Design a special symmetric FIR filter that allows the original data to pass through unchanged and interpolates to minimize the mean-square error between the interpolated points and their ideal values.

Apply the filter to the expanded input vector to produce the output.

IIR and FIR filters are two primary types of digital filters used in Digital Signal Processing (DSP) applications. In Infinite Impulse Response (IIR) filters, the impulse response is infinite because there is feedback in the filter; if you put in an impulse (a single “1” sample followed by many “0” samples), an infinite number of non-zero values will theoretically come out.

DSP filters can also be Finite Impulse Response (FIR). FIR filters do not use feedback; therefore, for an FIR filter with N coefficients, the output always becomes zero after putting in N samples of an impulse response.

In the present disclosure, the low pass filter (LPF) is designed based on IIR filters which can achieve a given filtering characteristic using less memory and calculations than a similar FIR filter. The primary advantage of IIR filters over FIR filters is that they typically meet a given set of specifications with a much lower filter order than a corresponding FIR filter. However, IIR filters have nonlinear phase, data processing within MATLAB software is commonly performed offline, that is, the entire data sequence is available prior to filtering. This allows for a noncausal, zero-phase filtering approach (via the filtfilt function), which eliminates the nonlinear phase distortion of an IIR filter.

The classical IIR filters, Butterworth, Chebyshev Types I and II, elliptic, and Bessel, all approximate the ideal brick wall filter in different ways. For most filter types, lowest filter order can also be found which fits a given filter specification in terms of passband and stopband attenuation, and transition width(s). All classical IIR lowpass filters are ill-conditioned for extremely low cutoff frequencies. Therefore, instead of designing a lowpass IIR filter cut-off with a very narrow passband, it can be better to design a wider passband and decimate the input signal. Therefore; a Butterworth filter is chosen with the passband frequency, stopband frequency, passband ripple and stopband attenuation of 15 Hz, 50 Hz, 1 dB and 80 dB respectively since 10 Hz is used as the modulation frequency in implementation of VAM technique.

Yet further details and exemplary embodiments will be discussed hereinbelow:

Vibro-Acoustic Modulation method for detection and characterization of various structural and material flaws has been actively researched for the last two decades. Most of the studies focused on detection and monitoring of macro-cracks requiring well established baseline (no-damage) value of the modulation index. The baseline value is specific for a particular structure, measuring setup, and other factors and can't be established in many practical situations without a long-term monitoring looking for a relative change in the Modulation Index. In this application, a baseline-free Vibro-Acoustic Modulation method is proposed and investigated, which does not require monitoring of relative Modulation Index changes, unlike conventional approaches. It was hypothesized that the nonlinear mechanisms (and respective nonlinear response) of a structure are different for undamaged and damaged material. For example: material without damage or at early stages of fatigue have classic elastic or hysteretic/dissipative nonlinearity while damaged (cracked) material may exhibit contact bi-linear or Hertzian nonlinear mechanisms. These mechanisms yield different power law dependencies of Modulation Index (MI) as function of applied vibration amplitude, B: MI˜Bβ. Thus, quadratic nonlinearity yields linear dependence, β=1, and Hertzian nonlinearity results in β<1. Other nonlinear mechanisms yield different power laws. Therefore, measuring power damage coefficient β instead of MI may offer testing without established reference value. It also offers some insights into the nonlinear mechanisms transformation during damage evolution. This approach was experimentally investigated and validated.

Vibro-Acoustic Modulation (VAM) technique has been introduced in 1990s for detection of contact-type defects such as cracks and delaminations. Later, the method was applied to monitoring a damage evolution at the microscopic level demonstrating its high sensitivity to damage initiation before macro defects are developed. There have been numerous follow up studies, for example of the method applied to a variety of structural and material defects demonstrating high damage sensitivity of VAM as well as its other advantageous features. VAM utilizes nonlinear interaction (modulation) of a high frequency ultrasonic wave (carrier signal) having frequency co and a low frequency vibration (modulating vibration) with frequency Ω<<ω. Material nonlinearity and especially highly nonlinear damage-related interfaces such as cracks, disbonds, as well as structural contact interfaces (bolted connections, overlays, etc.) cause the wave interaction/modulation. In majority of studies, the modulation is quantified by a Modulation Index (MI) defined in the spectral domain as the ratio of the side-band spectral components at frequencies ω±Ω to the amplitude of the carrier. MI does not differentiate between the type and origin of the modulating cause: be it material, damage, or structural-related nonlinearities. It is assumed that the material and structural nonlinearities do not change over life of the structure, thus setting up a baseline MI value for undamaged structure. Damage, developed at some point, increases MI over its baseline, indicating damage presence and severity: the higher MI, the greater the damage. Therefore, in its basic form, VAM needs an established baseline value. This works well for monitoring of damage evolution (monitoring a relative change in MI), for example in Structural Health Monitoring (SHM) applications. For the non-destructive testing applications, however, the baseline value is not always available and, often, may not be determined. There are a few publications referring to “baseline-free VAM”. Examination of these papers reveals that the authors assumed that VAM is inherently baseline-free method because in the absence of the damage—there is no modulation, therefore the baseline is zero. In practice, however, it is far from zero due to material and measurements setup nonlinearities as well as structural (non-damage) nonlinearities such as structural contact interfaces. In this discussion, a physics-based baseline-free VAM testing exploiting the differences in nonlinear mechanisms at difference stages of damage evolution is proposed.

Development of nonlinear acoustic non-destructive testing such as harmonic, frequency mixing, and modulation methods stimulated active studies of related physical nonlinear mechanisms. Besides classical nonlinear elasticity, there is a variety of so-called non-classical nonlinear mechanisms: contact acoustic nonlinearities (CAN), hysteresis, thermo-elasticity, and nonlinear dissipation. All of these mechanisms contribute to acoustic nonlinear interactions. Here one particular interaction between high frequency ultrasonic waves and low frequency vibrations is emphasized, which is utilized in VAM method. Specifically, of interest is the mostly overlooked effect of MI dependence on the amplitudes of the interacting signals for different nonlinear mechanisms.

For two-wave interaction, these dependences are different: classical quadratic nonlinearity of stress-strain Hooke's law yields linear dependence of combination frequencies amplitude on interacting signal amplitudes:

A±˜A*B, (I)

where A and B are amplitudes of the high frequency (ω) ultrasound and the low frequency (Ω) vibration, respectively, A± are amplitudes of the spectral components at the combination frequencies ω±Ω. The modulation index MI, defined as

MI=(A⁻+A+)/2A (II)

is independent of the high frequency amplitude, MI(A)=constant, and linear proportional to the amplitude of the low frequency vibration: MI˜B.

Non-classical nonlinear mechanisms may manifest themselves with different amplitude dependences. Knowing these dependencies may help to identify the respective nonlinear mechanism and to develop a baseline-free testing methodology.

Some of the models yield theoretically predicted dependences, such as the above-mentioned quadratic model, while others, mathematically more complicated, do not easily reveal such dependencies. Here numerical simulations using model's strain-stress relationship in generic scalar formulation will be used, σ(ε), for high and low frequency harmonic strain inputs:

ε=A cos(ωt)+B cos(nt), (III)

and computing spectral amplitudes at the combination frequencies. This approach is not a full modelling of wave interactions, as it does not take into account many effects such as wave propagation and resonances, kinematic nonlinearity, mode conversions, vector (tensor) nature of interacting fields, etc. It provides, however, a simple way to predict the amplitude dependencies at the source of the nonlinear interaction defined by nonlinear constitutive equation, σ(ε), even for very complex models. The above-mentioned unaccounted phenomena may mask or distort these source dependencies, so additional efforts will be needed (and discussed later) to recover/unmask the source amplitude dependencies.

Below, a few examples of source nonlinear mechanisms and the resulting MI amplitude dependencies are given. The results of the modelling will be presented as a power function of Load Ratio Bi/Bj:

MIᵢ/MIⱼ˜(Bᵢ/Bⱼ)^{β} (IV)

where MIᵢ and MIⱼ are the MIs defined by the Eq. (II) for the input LF amplitudes Bi and Bj. where i≠j. For example, for amplitudes B 1, B2, B3, B4, B5: Bi/Bj=B2/B1, B3/B1, B3/B2, B4/B2, etc.

Well-studied quadratic nonlinearity is described by a quadratic term in Taylor's expansion of the Hooke's law:

σ=Lε−Nε² (V)

where L and N are the linear and nonlinear elastic coefficients, respectively. Substitution of Eq. (III) into (V) reveals the amplitude dependence of Eq. (I). This well-known result can be used to verify MatLab code to be used for more complex models. Indeed, as expected, MatLab computed dependence of normalized MI vs. A and B amplitudes (also normalized), shown in FIG. 101, demonstrate theoretically predicted amplitude dependencies with power coefficient β=1.

Bi-linear stress-strain dependence, FIG. 102a, Eq. (VI), at the contact interfaces was introduced in 1980s to model cracks in beams and disbonds/delaminations, for relatively high strains leading to the opening and closing of the interface. It is worthwhile to notice that the bi-linear model yields only even harmonics (2Ω, 4Ω, 6Ω, . . . ) so the modulation spectrum contains the side-band components at frequencies ω±Ω, ω±2Ω, ω±4Ω, . . . as shown in FIG. 102c. The bi-linear model power coefficient, determined by the Eq. (IV), β=0, that is: the normalized Modulation Index does not depend on the relative increase in LF amplitude B. With this, the modulation index, MI˜N/L.

$$σ = L ɛ - N \vert ɛ \vert = \{ \begin{matrix}( L - N ) ɛ , ɛ \geq 0 \\ ( L + N ) ɛ , ɛ < 0\end{matrix} \qquad ( VI )$$

More realistic model of the contact interfaces, especially for a lower strain, is a rough-surface contact in which the curved asperities on both sides of the interface are in contact and deformed under the dynamic stresses. The deformation could be elastic, plastic, or their combination. The deformation changes the contact area with the complex strass-strain relationships, which are dependent on the shape and size of the contacting asperities and other conditions such as slip friction, adhesiveness, etc. For non-adhesive frictionless elastic deformation, the following stress-strain equation can be used:

σ=Lε−Nε^{S}, (VII)

In this model, the input signal (III) is modified as following

ε=ε₀+A cos(ωt)+B cos(Ωt), (VIII)

where ε₀ is constant strain: ε₀>A+B. Under this condition, the total strain is always positive; therefore, there is no separation of the contacts. The power coefficient β of Eq. (IV) depends on the power S and the ratio of nonlinear/linear coefficient N/L. Assuming the spherical shape of the asperities, the power S=1.5 (Hertzian contact). In this case, FIG. 103 illustrates stress-strain and normalized MI(B) dependences for various NIL ratios.

As this example demonstrates, the power coefficient β varies within the range 0.5-0.7 depending on the ratio of line and nonlinear coefficients. In real life, β variability could be even larger, due to variability of the coefficients S, N, L and t combined effect of other nonlinear mechanisms. For example, for S=2.5 and N/L=0.1, the power coefficient β=1.65.

Nonlinear hysteretic behaviour in various solid material has been observed experimentally in numerous studies, for example. Observations of acoustic nonlinear manifestations (amplitude-dependent attenuation, resonance frequency shift on acoustic amplitude, and others) in micro-inhomogeneous solids such as rocks, “soft” metals (zinc, copper), fatigues materials, etc. are explained using hysteretic nonlinearity. Although physical mechanisms of the hysteretic behaviour are still debated, there are many phenomenological models has been proposed. To illustrate the effect of the hysteresis non-linearity on MI(B) dependence there is the model first proposed by Nazarov, et.al.:

$$σ = \{ \begin{matrix}L ɛ - {N}_{1} {ɛ}^{2} ; ɛ > 0 , \dot{ɛ} > 0 \\ L ɛ - {N}_{1} B ɛ ; ɛ > 0 , \dot{ɛ} < 0 \\ L ɛ + {N}_{2} {ɛ}^{2} ; ɛ < 0 , \dot{ɛ} < 0 \\ L ɛ - {N}_{2} Bɛ ; ɛ < 0 , \dot{ɛ} > 0\end{matrix} \qquad ( IX )$$

Here the input strain is given by Eq. (III) assuming B>>A. It is interesting to consider two scenarios: symmetrical (N1=N2) and asymmetrical (N₁≠N₂) hysteresis, FIG. 104.

Modulation spectra for the above hysteretic dependencies are shown in the FIG. 105 demonstrating that only asymmetrical hysteresis yield modulation spectral components at the frequencies ω+Ω of interest. It was emphasized that asymmetrical hysteresis is more realistic as it reflects an asymmetrical nature of the compression vs. tension processes.

The power coefficient, β, for symmetrical hysteresis depends on the combination of linear and nonlinear parameters, L, N1, and N2 and varies from 1.0 to 1.5.

It should be noted that there are wide variations of non-classical nonlinear models and their combinations, which would not be possible (and is not necessary) to discuss within the frame of the present work. The above examples confirm the hypothesis that the different nonlinear mechanisms yield different power coefficients β that may vary in range from 0 to 1.7 or more. The next question to answer is: if the power coefficient measurements could be served as a reliable and robust indication of damage condition and its evolution. Only experimental testing can answer this question.

The experimental verification of the proposed hypothesis was conducted on a number of A108 steel bars measuring 25.4 mm×2.54 mm×3.175 mm (10″×1″×⅛″) subjected to tensile fatigue 10 Hz, 20 kN cycling using 810 MTS machine. In the centre of the bar, there is 0.635 mm WO diameter hole, so the stress and respective damages were concentrated between the hole and the edges of the bar. The fatigue cycles run until the breakage of the bar, as shown in FIG. 106, which typically happened after ˜100 thousand cycles.

During the fatigue cycling, approximately after every 5000 cycles 20 kN fatigue cycling were switched to a lower range of 0.5, 1, 1.5, 2, and 2.5 kN in succession. This 10 Hz low range cycling was used as a modulating vibration with respective amplitudes Bi=0.5 to 2.5 kN. Simultaneously, the high frequency ultrasonic signal was injected into the bar and received with a pair of piezo-ceramic transducers epoxy-glued 3 inches apart with the hole in the middle. The ultrasonic signal was step-swept across a wide frequency range of 120 kHz to 200 kHz with 0.5 kHz step. At each frequency the MI was measured and recorded. The example of the recorded MI vs. frequency is shown in FIG. 107 demonstrating high variability of MI with the frequency. This variability, reported in many publications, is due to wave propagation, reflections/resonances, mode conversion, etc. within the bar and is difficult to account for, especially in real structures with complex geometry. Instead, MI averaging across the wide frequency range provides reliable estimate of the structure nonlinearity and has been well documented. FIG. 108 shows averaged MIs across the frequency range vs normalized fatigue life of one of the tested samples. MIs are measured for five LF amplitudes: Bi=0.5, 1.0, 1.5, 2.0, and 2.5 kN showing onset of the fatigue damage at app. 80%-90% of the sample fatigue life.

The top solid line in FIG. 108 is the power coefficient β (with scale on the right axis) calculated from these MIs using power trendline (regression) fitting as shown in FIG. 109. The β curve clearly correlates with MI damage curves showing the damage onset at ˜80-90%. This proves that the power coefficient is indeed follows the change in mechanisms of nonlinearity: here for the background nonlinearity (between 20% and 70% of the fatigue life, β is within the range 1.5-1.7. This pattern repeats itself for multiple samples as shown in FIG. 110. It demonstrates very tight range of 1.5-1.6 before the onset of damage with significant drop with the development of macro-cracks (above 90% of the life). Here β variation during the initial 10% of the life is likely due to setup settling (tightening the grip connections, etc).

The experimental results, demonstrated in the previous chapter (i.e., Section 4), support our hypothesis that MI vs. vibration amplitude dependence expressed as a power law can be used as in indicator of changing nonlinear mechanisms, thus damage evolution indicator. The absolute value of the power damage coefficient β should be associated with a particular nonlinear mechanism. One would expect that in the undamaged samples the main source of nonlinearity is a weak material nonlinearity described by quadratic term in the constitutive Eq. (V). This should render β=1 for the undamaged sample, while our test shows β˜1.6-1.7. This discrepancy brought our attention to effect of static component of the load used in the test. FIG. 111 shows the waveforms of the applied vibrations with amplitudes Bᵢ=0.5, 1.0, 1.5, 2.0, and 2.5 kN. It also shows that each applied waveform contains a corresponded static component force: Fi=0.75, 1.0, 1.25, 1.5, and 1.75 kN which were necessitated by the operation of the tensile stress machine.

It is well known that the static stress increases the manifestation of the nonlinear acoustic signals. This effect has been utilized to determine nonlinear parameters of solids as well as to measure residual static stresses and is known as acousto-elasticity. In the course of experimentation, the static stress is different for each vibration level and, therefore, its effect on the nonlinear measurements must be accounted and corrected for. Respectively, we modified the Eq. (IV) as follows:

MIᵢ/MIⱼ˜(BᵢFᵢ/BⱼFⱼ)^{βc}, (X)

where βc is the corrected (for effect of static load Fi) power damage coefficient. FIG. 112 shows corrected βc derived from the data of FIG. 110. Remarkably, as anticipated, βc is very close to 1 during the undamaged portion of the fatigue life for all tested samples.

FIG. 112 demonstrates the ability of the proposed VAM baseline-free approach to detect early state damage at approximately 80% of the fatigue life. It is interesting to compare this with the conventional baseline-free techniques, such as ultrasonic (UT) and eddy-current (EC). To do this, an off-the-shelf EPOCH 650 Digital Ultrasonic Flaw Detector equipment from Olympus America, Inc. was used. For eddy current (EC), a NORTEC 600 Eddy Current Flaw Detector equipment (also from Olympus America, Inc.) was employed. To achieve the highest sensitivity to incipient fatigue damage, the highest available frequency probes were utilized for these tests: 20 MHz, 0.125 inch diameter ultrasonic delay line probe and 12 MHz, 0.125 inch diameter eddy current probe. The UT and EC measurements were conducted during the fatigue test over the area of the anticipated damage accumulation along the line shown in FIG. 106. Both systems were able to detect the initial damage at 85%-88% of the fatigue life, and a crack became visible above 90% of the fatigue life. This is yet another confirmation of high sensitivity of VAM technique to incipient damage detection as was previously postulated. Comprehensive comparison of VAM and conventional acoustic emission (AE) method has been recently reported. Similarly, it showed VAM incipient damage detection at 80% versus AE damage detection at 85% of the fatigue life.

The proposed baseline-free VAM non-destructive testing approach is based on the hypothesis that nonlinear mechanisms responsible for the vibro-acoustic modulation are different before and after the damage. The modelling and simulation revealed that there are noticeably different power damage coefficients β, Eq. (IV), for various nonlinear mechanisms (NM). The expectation was that prior to the damage, the material exhibits classic nonlinear behaviour described by the quadratic non-linearity, Eq. (V). As the modelling showed, this would yield the power coefficient β=1. Indeed, the experimental results, FIG. 112, show the power coefficient very close to unity. As damage accumulates and is developed into a macro-crack, the nonlinear mechanism should change yielding different power coefficients as summarized in the Table 1. Note, that there are other NMs proposed and discussed in the literature, which are not modelled here. This theoretical prediction is corroborated by the experiment, FIG. 112, showing β falling below unity as damage became apparent through observation of the increase in MI. It appeared that for the fatigued-damaged samples, the change (reduction) of β is conducive with the contact nonlinear mechanism rather than bi-linear or hysteretic nonlinearities. Unlike Modulation Index, which is a relative measure of nonlinearity irrespective of the NM, power damage coefficient β is an absolute measure specific to a particular NM. Therefore, β-measurements, corrected for a static component of applied low frequency stress, βc, may offer baseline-free damage detection as opposite to MI measurements suitable mostly for damage evolution monitoring. Initial experimental results, summarized in FIG. 112 and corroborated with the theoretical predictions, are encouraging and support the proposed baseline-free damage detection approach. In these tests βc˜1 indicating undamaged material quadratic nonlinearity before the developed fatigue damage, and β drops to below 1 as damage is evolved into a macro-crack. These below unity βc values are conducive with a contact-type nonlinearity associated with crack interface. Comparison with the conventional baseline-free methods: ultrasonic, eddy current, and acoustic emission tests, demonstrate higher sensitivity of baseline-free VAM to incipient fatigue damage detection.

TABLE 1
Nonlinear mechanisms and corresponding power coefficients.

| Nonlinear Mechanism | Power Coefficient β |
|---|---|
| Classical Quadratic, Eq. (V) | 1 |
| Bi-Linear, Eq. (VI) | 0 |
| Contact (Herzian) Nonlinearity, Eq. | 0.5-0.7 |
| (VIII) Asymmetric Hysteretic, Eq. (IX) | 1-1.5 |

It will be understood that the embodiments described herein are merely exemplary and that a person skilled in the art may make many variations and modifications without departing from the spirit and scope of the invention. All such variations and modifications are intended to be included within the scope of the invention described and illustrated herein.

We claim:

1. The methods described and illustrated in the accompanying specification and drawings.
